(19) United States
(12) Patent Application Publication
(10) Pub. No.: US 2020/0243291 A1
(43) Pub. Date: Jul. 30, 2020

(54) CONTACT DEVICE AND ELECTROMAGNETIC RELAY EQUIPPED WITH CONTACT DEVICE

(71) Applicant: PANASONIC INTELLECTUAL PROPERTY MANAGEMENT CO., LTD., Osaka (JP)

(72) Inventor: Masahiro ITO, Hyogo (JP)

(73) Assignee: PANASONIC INTELLECTUAL PROPERTY MANAGEMENT CO., LTD., Osaka (JP)

(21) Appl. No.: 16/651,781

(22) PCT Filed: Sep. 26, 2018
(86) PCT No.: PCT/JP2018/035594

§ 371 Date: Mar. 27, 2020

(30) Foreign Application Priority Data
Sep. 28, 2017 (JP) 2017-188527

(51) Int. Cl. H01H 50/54; H01H 50/44; H01H 1/20

(52) U.S. Cl. CPC H01H 50/54; H01H 1/20; H01H 50/44

(57) ABSTRACT

The contact device includes a movable contact that comes into contact with a first fixed terminal by moving a moving body to one side in one direction, and comes away from the first fixed terminal by moving the moving body to the other side in the one direction. The movable contact includes a first contact unit that comes into contact with the first fixed terminal. The first fixed terminal also includes a first surface with which the first contact unit comes into contact from a direction intersecting with one direction. The first contact unit includes a first contact piece on the first contact unit side that comes into contact with the first surface in a stretched manner in a state of being pressed to one side in one direction by the moving body.

### TECHNICAL FIELD

The present invention relates to a contact device and an electromagnetic relay equipped with the contact device.

### BACKGROUND ART

There has heretofore been known a contact device including a first fixed terminal and a movable contact that comes into contact with and away from the first fixed terminal by moving relative to the first fixed terminal (see, for example, Patent Literature 1).

In this Patent Literature 1, the first fixed terminal and the movable contact are electrically connected to each other by a moving body relatively moving the movable contact upward to bring the upper surface of the movable contact into contact with the lower surface of the first fixed terminal.

### CITATION LIST

### Patent Literature

Patent Literature 1: Japanese Unexamined Patent Application Publication No. 2009-199893

### SUMMARY OF INVENTION

### Technical Problem

When the movable contact is electrically connected to the first fixed terminal, a current flows between the first fixed terminal and the movable contact. If a current flows between the first fixed terminal and the movable contact, such a current causes electromagnetic repulsion force between the first fixed terminal and the movable contact.

For example, when the movable contact is moved upward in a vertical direction so that the upper surface of the movable contact is brought into contact with the lower surface of the first fixed terminal as in the conventional technique described above, vertical electromagnetic repulsion force acts between the first fixed terminal and the movable contact. That is, between the first fixed terminal and the movable contact, electromagnetic repulsion force acts in a direction that coincides with the moving direction of the moving body.

In the conventional technique, as described above, relatively large electromagnetic repulsion force acting on the moving body from the movable contact may impair the reliability of contact.

The present invention has been made in view of such conventional problems.

It is an object of the present invention to provide a contact device capable of further improving the reliability of contact and an electromagnetic relay equipped with the contact device.

### Solution to Problem

A contact device according to an aspect of the present invention includes a first fixed terminal and a movable contact that comes into contact with and away from the first fixed terminal by moving relative to the first fixed terminal. The contact device further includes a drive unit provided with a moving body that moves the movable contact and configured to allow the movable contact to come into contact with the first fixed terminal by moving the moving body to one side in one direction and to allow the movable contact to come away from the first fixed terminal by moving the moving body to the other side in the one direction. The movable contact includes a first contact unit that comes into contact with the first fixed terminal when the moving body is moved to one side in the one direction, and the first fixed terminal includes a first surface with which the first contact unit comes into contact from a direction intersecting with the one direction. The first contact unit includes a first contact piece on the first contact unit side, which comes into contact with the first surface of the first fixed terminal in a stretched manner in a state where the first contact unit is pressed toward one side in the one direction by the moving body.

The contact device may further include a pressing body that presses the movable contact in a state where the moving body is moved to one side in the one direction. The first contact unit may include the first contact piece on the first contact unit side, which comes into contact with the first surface of the first fixed terminal in a stretched manner in a state where the first contact unit is pressed in a pressing direction by the pressing body.

An electromagnetic relay according to the present invention is equipped with the contact device.

### Advantageous Effects

The present invention can provide a contact device capable of further improving the reliability of contact and an electromagnetic relay equipped with the contact device.

### BRIEF DESCRIPTION OF DRAWINGS

FIG. 1 is a perspective view showing an electromagnetic relay according to an embodiment of the present invention.

FIG. 2 is an exploded perspective view showing the electromagnetic relay in an exploded state according to the embodiment of the present invention.

FIG. 3 is an exploded perspective view showing a part of a contact device in an exploded state according to the embodiment of the present invention.

FIG. 4 is a diagram showing the electromagnetic relay according to the embodiment of the present invention, (a) showing a side cross-sectional view of the electromagnetic relay in a state where the contact is turned off, while (b) showing a side cross-sectional view of the electromagnetic relay in a state where the contact is turned on.

FIG. 5 is a diagram schematically showing a state where a movable contact according to the embodiment of the present invention is attached to a peripheral wall of a base, (a) showing a partially fractured side view and (b) showing a rear view.

FIG. 6 is a partially fractured side view schematically showing a part of the contact device according to the embodiment of the present invention.

FIG. 7 is a rear view schematically showing a part of a contact device according to a first modified example.

FIG. 8 is a diagram schematically showing a part of a contact device according to a second modified example, (a) showing a partially fractured side view in a state where the contact is turned off and (b) showing a partially fractured side view in a state where the contact is turned on.

FIG. 9 is a diagram schematically showing a part of a contact device according to a modified example, wherein (a) is a side view showing a third modified example and (b) is a side view showing a fourth modified example.

FIG. 10 is a diagram schematically showing a part of a contact device according to a fifth modified example, wherein (a) is a side view showing a movable contact and a drive unit, and (b) is a rear view showing the movable contact.

FIG. 11 is a partially fractured side view schematically showing a part of a contact device according to a sixth modified example.

FIG. 12 is a partially fractured side view schematically showing a part of a contact device according to a seventh modified example.

FIG. 13 is a partially fractured side view schematically showing a part of a contact device according to an eighth modified example.

FIG. 14 is a partially fractured side view schematically showing a part of a contact device according to a ninth modified example.

FIG. 15 is a partially fractured side view schematically showing a part of a contact device according to a tenth modified example.

FIG. 16 is a diagram schematically showing a part of a contact device according to an eleventh modified example, wherein (a) is a partially fractured side view showing a state where the contact is turned off, while (b) is a partially fractured side view showing a state where the contact is turned on.

FIG. 17 is a diagram schematically showing a part of a contact device according to a twelfth modified example, wherein (a) is a partially fractured side view showing a state where the contact is turned off, while (b) is a partially fractured side view showing a state where the contact is turned on.

FIG. 18 is a diagram schematically showing a part of a contact device according to a modified example, wherein (a) is a side view showing a part of a contact device according to a thirteenth modified example, while (b) is a side view showing a part of a contact device according to a fourteenth modified example.

FIG. 19 is a diagram schematically showing a part of a contact device according to a fifteenth modified example, wherein (a) is a partially fractured side view showing a state where the contact is turned off, while (b) is a partially fractured side view showing a state where the contact is turned on.

FIG. 20 is a diagram schematically showing a leaf spring according to a modified example, wherein (a) is a side view showing a leaf spring according to the first modified example, (b) is a side view showing a leaf spring according to the second modified example, (c) is a side view showing a leaf spring according to the third modified example, (d) is a side view showing a leaf spring according to the fourth modified example, (e) is a side view showing a leaf spring according to the fifth modified example, and (f) is a side view showing a leaf spring according to the sixth modified example.

FIG. 21 is a diagram schematically showing a part of a contact device according to a sixteenth modified example, wherein (a) is a partially fractured side view showing a state where the contact is turned off, while (b) is a partially fractured side view showing a state where the contact is turned on.

FIG. 22 is a rear view showing a leaf spring and a fixed terminal in the state shown in FIG. 21(b).

FIG. 23 is a diagram schematically showing a part of a contact device according to a seventeenth modified example, wherein (a) is a partially fractured side view showing a state where the contact is turned off, while (b) is a partially fractured side view showing a state where the contact is turned on.

FIG. 24 is a diagram schematically showing a part of the contact device according to the seventeenth modified example, wherein (a) is a side view showing a fixed terminal and (b) is a rear view showing a leaf spring and the fixed terminal in the state shown in FIG. 23(b).

FIG. 25 is a partially fractured side view schematically showing a part of a contact device according to an eighteenth modified example.

FIG. 26 is a diagram schematically showing a part of a contact device according to a nineteenth modified example, wherein (a) is a partially fractured side view showing a state where a leaf spring is viewed from the width direction, and (b) is a side view showing a state where the leaf spring is viewed from the longitudinal direction.

FIG. 27 is a diagram schematically showing a part of a contact device according to a twentieth modified example, wherein (a) is a partially fractured side view showing a state where a leaf spring is viewed from the width direction, and (b) is a side view showing a state where the leaf spring is viewed from the longitudinal direction.

FIG. 28 is a diagram schematically showing a part of a contact device according to a twenty-first modified example, wherein (a) is a partially fractured side view showing a state where the contact is turned off, while (b) is a partially fractured side view showing a state where the contact is turned on.

FIG. 29 is a diagram schematically showing a part of a contact device according to a twenty-second modified example, wherein (a) is a partially fractured side view showing a state where the contact is turned off, while (b) is a partially fractured side view showing a state where the contact is turned on.

FIG. 30 is a diagram schematically showing a part of a contact device according to a twenty-third modified example, wherein (a) is a partially fractured side view showing a state where the contact is turned off, while (b) is a partially fractured side view showing a state where the contact is turned on.

FIG. 31 is a partially fractured side view schematically showing a part of a contact device according to a twenty-fourth modified example.

FIG. 32 is a partially fractured side view schematically showing a part of a contact device according to a twenty-fifth modified example.

FIG. 33 is a partially fractured side view schematically showing a part of a contact device according to a twenty-sixth modified example.

FIG. 34 is a side view schematically showing a part of a contact device according to a twenty-seventh modified example.

FIG. 35 is a partially fractured side view schematically showing a part of a contact device according to a twenty-eighth modified example.

FIG. 36 is a diagram schematically showing a part of a contact device according to a twenty-ninth modified example, (a) showing a side view and (b) showing a rear view.

FIG. 37 is a diagram schematically showing a part of a contact device according to a modified example, wherein (a) is a side view showing a part of a contact device according to a thirtieth modified example, (b) is a side view showing a part of a contact device according to a thirty-first modified example, and (c) is a side view showing a part of a contact device according to a thirty-second modified example.

FIG. 38 is a diagram schematically showing a part of a contact device according to a modified example, (a) is a side view showing a part of a contact device according to a thirty-third modified example, (b) is a side view showing a part of a contact device according to a thirty-fourth modified example, and (c) is a side view showing a part of a contact device according to a thirty-fifth modified example.

FIG. 39 is a diagram schematically showing a part of a contact device according to a thirty-sixth modified example, wherein (a) is a partially fractured side view showing a state where the contact is turned on, while (b) is a rear view showing a movable contact.

FIG. 40 is a side view schematically showing a part of a contact device according to a thirty-seventh modified example.

FIG. 41 is a diagram schematically showing a part of a contact device according to a thirty-eighth modified example, and a side view showing a state where the contacts are turned on, with a part thereof broken away.

FIG. 42 is a partially fractured side view schematically showing a part of a contact device according to a thirty-ninth modified example in a state where the contact is turned on.

FIG. 43 is a diagram schematically showing a part of a contact device according to a fortieth modified example, wherein (a) is a side view showing a state where the contact is turned off, while (b) is a side view showing a state where the contact is turned on.

FIG. 44 is a diagram schematically showing a part of a contact device according to a forty-first modified example, wherein (a) is a partially fractured side view showing a state where the contact is turned off, while (b) is a partially fractured side view showing a state where the contact is turned on.

FIG. 45 is a diagram schematically showing a part of a contact device according to a forty-second modified example, wherein (a) is a side cross-sectional view showing a state where the contact is turned off, while (b) is a side cross-sectional view showing a state where the contact is turned on.

FIG. 46 is a diagram schematically showing a part of a contact device according to a forty-third modified example, wherein (a) is a side cross-sectional view showing a state where the contact is turned off, while (b) is a side cross-sectional view showing a state where the contact is turned on.

FIG. 47 is a diagram schematically showing a part of a contact device according to a forty-fourth modified example, wherein (a) is a side cross-sectional view showing a state where the contact is turned off, while (b) is a side cross-sectional view showing a state where the contact is turned on.

FIG. 48 is a side cross-sectional view schematically showing a part of a contact device according to a forty-fifth modified example.

FIG. 49 is a side cross-sectional view schematically showing a part of a contact device according to a forty-sixth modified example.

FIG. 50 is a diagram schematically showing a part of a contact device according to a forty-seventh modified example, wherein (a) is a side cross-sectional view showing a state where the contact is turned off, while (b) is a side cross-sectional view showing a state where the contact is turned on.

FIG. 51 is a side cross-sectional view schematically showing a part of a contact device according to a forty-eighth modified example.

### DESCRIPTION OF EMBODIMENTS

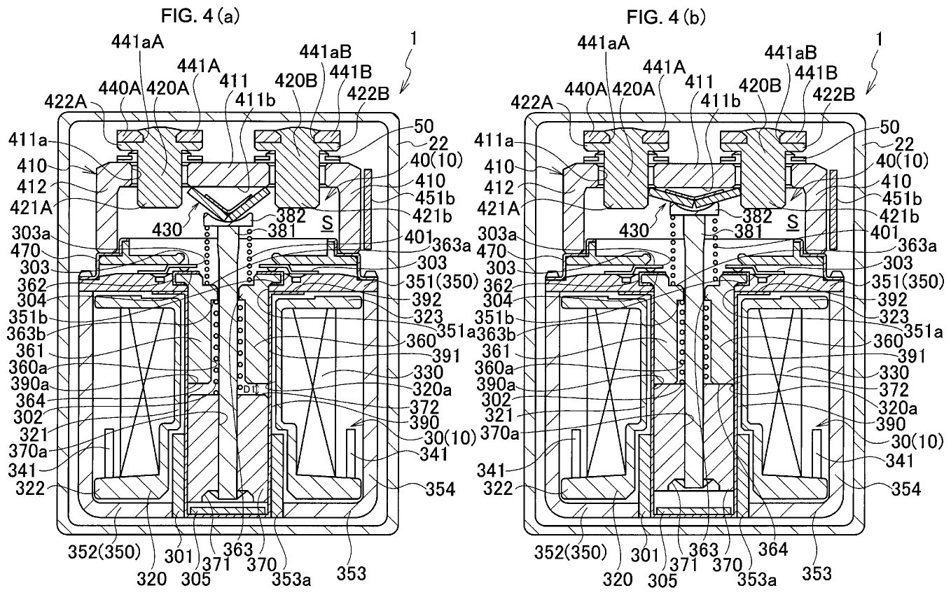

Hereinafter, embodiments of the present invention will be described in detail with reference to the drawings. Note that the following description is given assuming that up, down, left, and right in FIG. 4 indicate up, down, left, and right, and that a direction orthogonal to the page space in FIG. 4 indicates a front-rear direction.

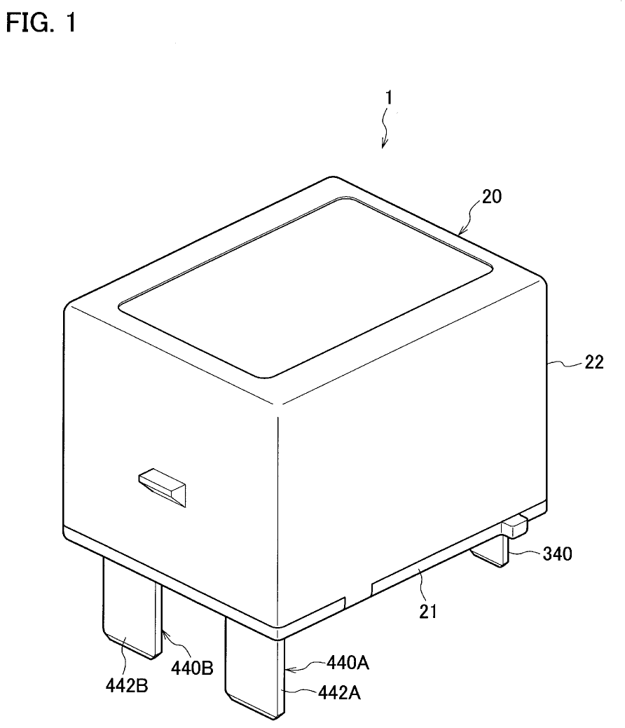

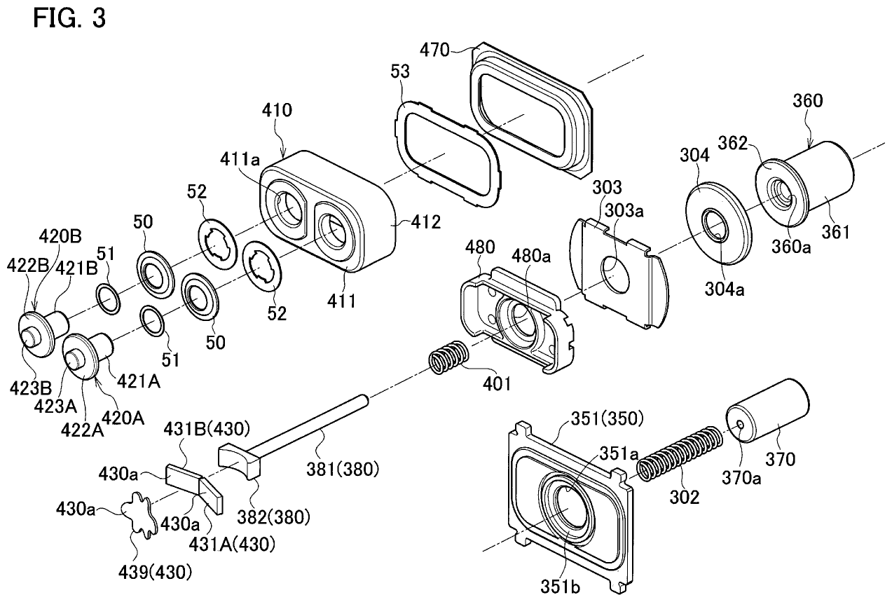

An electromagnetic relay 1 according to this embodiment is of a so-called normally-open type in which contact is turned off in an initial state. This electromagnetic relay 1 is equipped with a contact device 10 configured by integrally combining a drive block (drive unit) 30 located below and a contact block (contact unit) 40 located above, as shown in FIGS. 1 to 3. To be more specific, the electromagnetic relay 1 equipped with the contact device 10 is formed by housing the contact device 10 in a hollow box-shaped case 20 formed of a resin material into a hollow box shape. Note that it is also possible to use a so-called normally-closed electromagnetic relay in which contact is turned on in an initial state.

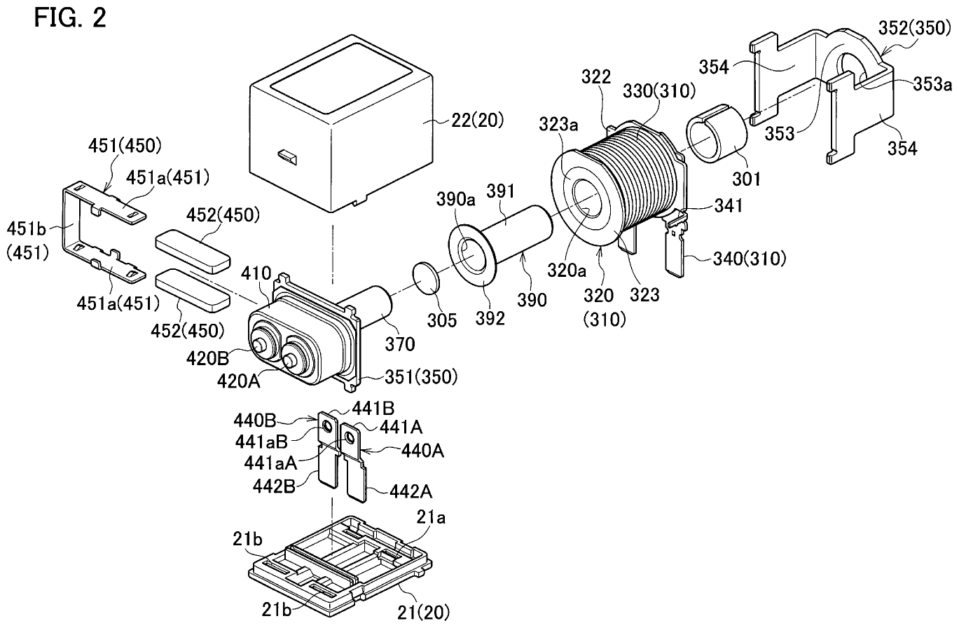

As shown in FIGS. 1 and 2, the case 20 includes an approximately rectangular case base 21 and a case cover 22 arranged to cover the case base 21. The case cover 22 is formed in a hollow box shape in which the case base 21 side is open. The mounted parts such as the drive block 30 and the contact block 40 are housed in the internal space of the case 20 formed with the case cover 22 attached to the case base 21.

A pair of slits 21a and 21a are provided on the lower side of the case base 21, into which a pair of coil terminals 340 and 340 are inserted, respectively. Meanwhile, a pair of slits 2 lb and 21b are provided on the upper side of the case base 21, into which a first terminal 442A of a first bus bar (first conductive member) 440A and a second terminal 442B of a second bus bar (second conductive member) 440B are inserted, respectively.

Note that one of the slits 21a has approximately the same shape as the cross-sectional shape of one of the coil terminals 340 inserted into the one slit 21a, and the other slit 21a has approximately the same shape as the cross-sectional shape of the other coil terminal 340 inserted into the other slit 21a. Here, in this embodiment, the coil terminals 340 having approximately the same cross-sectional shape in the portion inserted into the slits 21a are used. Therefore, the slits 21a and 21a also have approximately the same cross-sectional shape.

Likewise, one of the slits 21b has approximately the same shape as the cross-sectional shape of the first terminal 442A inserted into the one slit 21b, and the other slit 21b has approximately the same shape as the cross-sectional shape of the second terminal 442B inserted into the other slit 21b. Here, in this embodiment, the first and second terminals 442A and 442B have approximately the same cross-sectional shape in the portion inserted into the slits 21b. Therefore, the slits 21b and 21b also have approximately the same cross-sectional shape.

The drive block 30 includes a coil unit 310. This coil unit 310 includes: a coil 330 that generates a magnetic flux when energized; a hollow cylindrical coil bobbin 320 around which the coil 330 is wound; and a pair of coil terminals 340 and 340 fixed to the coil bobbin 320 and connected to both ends of the coil 330.

The coil bobbin 320 is formed of resin that is an insulating material, and has a vertically penetrating insertion hole 320a formed in the center thereof. The coil bobbin 320 includes: an approximately cylindrical winding drum part 321 having the coil 330 wound on the outer surface thereof; an approximately circular lower flange part 322 connected to the lower end of the winding drum part 321 so as to protrude radially outward of the winding drum part 321; and an approximately circular upper flange part 323 connected to the upper end of the winding drum part 321 so as to protrude radially outward of the winding drum part 321.

The coil terminal 340 can be formed in a flat plate shape using a conductive material such as copper, for example. The coil terminals 340 and 340 also have relay terminals 341 and 341 provided thereon, respectively. A lead wire at one end of the coil 330 wound around the winding drum part 321 of the coil bobbin 320 is soldered in a tangled state to the relay terminal 341 of one of the coil terminals 340. Likewise, a lead wire at the other end of the coil 330 wound around the winding drum part 321 of the coil bobbin 320 is soldered in a tangled state to the relay terminal 341 of the other coil terminal 340.

As described above, in this embodiment, the coil unit 310 is formed by electrically connecting the both ends of the coil 330 wound around the winding drum part 321 of the coil bobbin 320 to the pair of coil terminals 340 and 340 fixed to the coil bobbin 320. Thus, the drive block 30 is driven when the coil 330 is energized through the pair of coil terminals 340 and 340. When the drive block 30 is driven by energizing the coil 330, the contact of the contact block 40 to be described later is opened and closed. Note that the contact of the contact block 40 includes a portion that comes into contact with an outer surface 421aA of a first fixed terminal 420A, an outer surface 421aB of a second fixed terminal 420B, and an outer surface 421aA of a movable contact 430, and a portion that comes into contact with an outer surface 421aB of the movable contact 430. Thus, in this embodiment, conduction and non-conduction between the first fixed terminal 420A and the second fixed terminal 420B can be switched by driving the drive block 30.

The drive block 30 includes a yoke 350 disposed around the coil 330. This yoke 350 can be formed using a magnetic material, for example. In this embodiment, the yoke 350 is arranged so as to surround the coil bobbin 320, and includes a rectangular yoke upper plate 351 arranged on the upper end surface side of the coil bobbin 320 and a rectangular yoke main body 352 arranged on the lower end surface side and the side surface side of the coil bobbin 320.

The yoke main body 352 is arranged between the coil 330 and the case 20. In this embodiment, the yoke main body 352 includes a bottom wall 353 and a pair of side walls 354 and 354 that rise from left and right end edges (peripheral edges) of the bottom wall 353, respectively, which are opened in the front-rear direction. Note that the bottom wall 353 and the pair of side walls 354 and 354 can be formed in a continuous and integrated manner by bending a single plate. An annular insertion hole 353a is formed in the bottom wall 353 of the yoke main body 352, and a bush 301 is mounted in the insertion hole 353a. This bush 301 can also be formed using a magnetic material, for example.

On the tip side (upper end side) of the pair of side walls 354 and 354 of the yoke main body 352, the yoke upper plate 351 described above is formed so as to cover the upper end surface of the coil bobbin 320 and the coil 330 wound around the coil bobbin 320.

The drive block 30 includes a fixed iron core (fixed-side member) 360 that is inserted into the cylinder part (into the insertion hole 320a) of the coil bobbin 320 and is magnetized by the energized coil 330 (through which a magnetic flux passes). The drive block 30 further includes a movable iron core (movable-side member) 370 that is opposed to the fixed iron core 360 in the vertical direction (axial direction) and is disposed inside the cylinder part (in the insertion hole 320a) of the coil bobbin 320.

In this embodiment, the fixed iron core 360 includes a cylindrical part 361 inserted into the cylinder part of the coil bobbin 320 (into the insertion hole 320a) and a flange part 362 protruding radially outward from the upper end of the cylindrical part 361. The fixed iron core 360 has an insertion hole 360a formed therein, into which a shaft (drive shaft: moving body) 380 and a return spring 302 are inserted.

Note that, in this embodiment, a projection 363 projecting inward (radially inward) of the insertion hole 360a is formed across the entire lower periphery of the flange part 362. That is, the insertion hole 360a is formed such that the opening diameter above the projection 363 (on the upper surface 363a side) is larger than the opening diameter in the portion where the projection 363 is formed. The insertion hole 360a is also formed such that the opening diameter below the projection 363 (on the lower surface 363b side) is larger than the opening diameter in the portion where the projection 363 is formed. Furthermore, in this embodiment, the opening diameter above the projection 363 (on the upper surface 363a side) is slightly larger than the opening diameter below the projection 363 (on the lower surface 363b side).

Meanwhile, the movable iron core 370 is formed in an approximately cylindrical shape, and has an insertion hole 370a formed in the center thereof, into which the shaft 380 is inserted. The insertion hole 370a has an approximately constant opening diameter (opening diameter approximately the same as the diameter of a shaft main body 381), and has its lower end communicated with a recess part 371 formed in the lower center of the movable iron core 370.

The shaft 380 can be formed using a non-magnetic material, for example. In this embodiment, the shaft 380 includes: the shaft main body 381 having a round bar shape elongated in the moving direction of the movable iron core 370 (vertical direction: drive shaft direction); and an approximately plate-shaped head 382 connected to the upper end of the shaft main body 381 and is elongated in the left-right direction.

The movable iron core 370 and the shaft 380 are connected by inserting the lower end of the shaft main body 381 into the insertion hole 370a of the movable iron core 370 from above.

In this embodiment, the drive block 30 further includes a plunger cap 390 formed in a cylindrical shape with a bottom and an open top. This plunger cap 390 can also be formed using a non-magnetic material, for example. The plunger cap 390 is disposed between the fixed iron core 360 and the coil bobbin 320, and between the movable iron core 370 and the coil bobbin 320.

In this embodiment, the plunger cap 390 includes: a main body part 391 having a cylindrical shape with a bottom and an open top; and a flange part 392 that protrudes radially outward from the upper end of the main body part 391. The main body part 391 of the plunger cap 390 is arranged in the insertion hole 320a formed at the center of the coil bobbin 320. In this event, an annular seat surface 323a is formed on the upper side (upper flange part 323) of the coil bobbin 320, and the flange part 392 of the plunger cap 390 is placed on the seat surface 323a.

The cylindrical part 361 of the fixed iron core 360 and the movable iron core 370 are housed in a housing space 390a of the plunger cap 390 provided inside the cylindrical part of the coil bobbin 320 (inside the insertion hole 320a). In this embodiment, the fixed iron core 360 is arranged on the opening side of the plunger cap 390, while the movable iron core 370 is arranged below the fixed iron core 360 in the cylinder of the plunger cap 390.

Furthermore, the cylindrical part 361 of the fixed iron core 360 and the movable iron core 370 are each formed in a cylindrical shape whose outer diameter is approximately the same as the inner diameter of the plunger cap 390. The movable iron core 370 slides up and down (reciprocating direction: drive shaft direction) in the housing space 390a of the plunger cap 390.

In this embodiment, the flange part 392 formed on the opening side of the plunger cap 390 is fixed to the periphery of the insertion hole 351a on the lower surface of the yoke upper plate 351. The bottom part of the lower end of the plunger cap 390 is inserted into the bush 301 attached to the insertion hole 353a of the bottom wall 353.

Thus, the movable iron core 370 housed below the plunger cap 390 is magnetically joined to the periphery of the bush 301. That is, in this embodiment, the bush 301 forms a magnetic circuit together with the yoke 350 (the yoke upper plate 351 and the yoke main body 352), the fixed iron core 360, and the movable iron core 370.

In addition, an insertion hole 351a through which the fixed iron core 360 is inserted is formed in the center of the yoke upper plate 351. As for insertion of the fixed iron core 360, the cylindrical part 361 of the fixed iron core 360 is inserted from the upper surface side of the yoke upper plate 351. In this event, a recess part 351b having approximately the same diameter as the flange part 362 of the fixed iron core 360 is provided approximately at the center of the upper surface of the yoke upper plate 351. The flange part 362 of the fixed iron core 360 is fitted into the recess part 351b to prevent falling off.

A metal pressing plate 303 is further provided on the upper surface side of the yoke upper plate 351, and this pressing plate 303 has its left and right ends fixed to the upper surface of the yoke upper plate 351. A convex portion is provided at the center of the pressing plate 303 so as to form a space for housing the flange part 362 of the fixed iron core 360 protruding from the upper surface of the yoke upper plate 351.

In this embodiment, an iron core rubber 304 made of a material having rubber elasticity (for example, synthetic rubber) is provided between the fixed iron core 360 and the pressing plate 303 to prevent direct propagation of vibration from the fixed iron core 360 to the pressing plate 303. The iron core rubber 304 is formed in a disk shape and has an insertion hole 304a formed in its center, into which the shaft 380 is inserted. Furthermore, in this embodiment, the iron core rubber 304 is fitted to the fixed iron core 360 so as to surround the flange part 362.

The pressing plate 303 has an insertion hole 303a formed therein, into which the shaft 380 is inserted. The upper end side (head 382 side) of the shaft 380 can be extended to the contact block 40 through the insertion hole 360a of the fixed iron core 360 and the insertion hole 303a of the pressing plate 303.

When the movable iron core 370 is attracted to the fixed iron core 360 by energizing the coil 330, the shaft 380 connected and fixed to the movable iron core 370 is also moved upward together with the movable iron core 370.

Note that, in this embodiment, a range (movable range) within which the movable iron core 370 can move is set between an initial position (farthest position from the fixed iron core 360) spaced apart from the fixed iron core 360 by a gap D1 and a contact position (closest position to the fixed iron core 360) where contact is made with the fixed iron core 360.

As described above, the return spring 302 is disposed between the fixed iron core 360 and the movable iron core 370, which uses its elasticity to bias the movable iron core 370 in a direction of returning the movable iron core 370 to the initial position (direction in which the movable iron core 370 moves away from the fixed iron core 360). In this embodiment, the return spring 302 is configured using a coil spring arranged inside the insertion hole 360a of the fixed iron core 360 in a state of being wound around the shaft 380. The return spring 302 has its upper end in contact with the lower surface 363b of the projection 363 of the fixed iron core 360 and its lower end in contact with the upper surface 372 of the movable iron core 370. That is, the lower surface 363b of the projection 363 and the upper surface 372 of the movable iron core 370 serve as a spring receiving part of the return spring 302.

With the above configuration, when the coil 330 is energized, the surface (lower surface) 364 of the fixed iron core 360 facing the movable iron core 370 and the surface (upper surface) 372 of the movable iron core 370 facing the fixed iron core 360 have different polarities as a pair of magnetic pole parts, and the movable iron core 370 is attracted to the fixed iron core 360 and moved toward the contact position. Thus, in this embodiment, when the coil 330 is energized, the surface (lower surface) 364 of the fixed iron core 360 facing the movable iron core 370 and the surface (upper surface) 372 of the movable iron core 370 facing the fixed iron core 360 function as magnetic pole surfaces.

On the other hand, when the current supply to the coil 330 is stopped, the movable iron core 370 is returned to the initial position by the biasing force of the return spring 302.

As described above, the movable iron core 370 according to this embodiment is disposed opposed to the fixed iron core 360 with the gap D1 when the coil 330 is not energized, and is reciprocated so as to be attracted to the fixed iron core 360 side when the coil 330 is energized.

The shaft 380 is reciprocated in the up-down direction as the movable iron core 370 is reciprocated in the up-down direction. Furthermore, as the shaft 380 is reciprocated in the up-down direction, the movable contact 430 is moved relative to the first fixed terminal 420A and the second fixed terminal 420B. Thus, in this embodiment, the shaft 380 corresponds to the drive shaft as the moving body that moves the movable contact 430 relative to the first fixed terminal 420A and the second fixed terminal 420B by reciprocating in the up-down direction (one direction).

Note that a damper rubber 305 made of a material having rubber elasticity and formed to have approximately the same diameter as the outer diameter of the movable iron core 370 is disposed at the bottom of the plunger cap 390 in the housing space 390a.

Above the drive block 30, the contact block 40 that opens and closes the contact according to the on/off state of the current supply to the coil 330.

The contact block 40 includes a base 410 formed of a heat-resistant material such as ceramic into a box shape with an open bottom. This base 410 includes a top wall 411 and an approximately rectangular cylindrical peripheral wall 412 extending downward from a peripheral portion of the top wall 411.

The top wall 411 of the base 410 has two insertion holes 411a and 411a provided therein so as to be aligned in the left-right direction. The first fixed terminal 420A is inserted into one (on the left side in FIG. 4) of the two insertion holes 411a and 411a, while the second fixed terminal 420B is inserted into the other (on the right side in

FIG. 4) insertion hole 411a. In this embodiment, for the sake of convenience, the first fixed terminal 420A and the second fixed terminal 420B are used to distinguish between a pair of fixed terminals that are conducted to each other. However, it is not necessary that one fixed terminal (the left fixed terminal in FIG. 4) be the first fixed terminal 420A and the other fixed terminal (the right fixed terminal in FIG. 4) be the second fixed terminal 420B. That is, one fixed terminal (the left fixed terminal in FIG. 4) may be the second fixed terminal 420B and the other fixed terminal (the right fixed terminal in FIG. 4) may be the first fixed terminal 420A.

The first fixed terminal 420A is formed of a conductive material such as a copper-based material, and is arranged so as to be vertically elongated in the state shown in FIG. 4. In this embodiment, the first fixed terminal 420A includes an approximately cylindrical first fixed terminal main body 421A (vertically elongated first fixed terminal main body 421A) inserted into the insertion hole 411a from above. The first fixed terminal main body 421A has an outer surface 421aA formed so as to have a side surface 421bA extending in the vertical direction (up-down direction) and a bottom surface 421cA extending in the horizontal direction (front-rear direction and left-right direction). The first fixed terminal 420A includes an approximately disk-shaped first flange part 422A that protrudes radially outward from the upper end of the first fixed terminal main body 421A, and is fixed to the upper surface of the top wall 411 (upper surface of the peripheral portion of the insertion hole 411a).

Likewise, the second fixed terminal 420B is also formed of a conductive material such as a copper-based material, and is arranged so as to be vertically elongated in the state shown in FIG. 4. This second fixed terminal 420B includes an approximately cylindrical second fixed terminal main body 421B (vertically elongated second fixed terminal main body 421B) inserted into the insertion hole 411a from above. The second fixed terminal main body 421B has an outer surface 421aB formed so as to have a side surface 421bB extending in the vertical direction (up-down direction) and a bottom surface 421cB extending in the horizontal direction (front-rear direction and left-right direction). The second fixed terminal 420B includes an approximately disk-shaped second flange part 422B that protrudes radially outward from the upper end of the second fixed terminal main body 421B, and is fixed to the upper surface of the top wall 411 (upper surface of the peripheral portion of the insertion hole 411a).

In this embodiment, the first fixed terminal 420A and the second fixed terminal 420B are fixed to the top wall 411 via washers 50, respectively.

To be more specific, upon fixing the first fixed terminal 420A to the top wall 411, the first fixed terminal main body 421A of the first fixed terminal 420A is first inserted from above into the insertion hole of the washer 50 and one insertion hole 411a of the top wall 411 in a state where the washer 50 is arranged on the upper surface of the peripheral portion of the one insertion hole 411a in the top wall 411. Then, the upper surface of the washer 50 and the lower surface of the first flange part 422A are hermetically joined with a silver solder 51, and the lower surface of the washer 50 and the upper surface of the top wall 411 (the upper surface of the peripheral portion of the one insertion hole 411a) are hermetically joined with a silver solder 52. Thus, the first fixed terminal 420A is fixed to the top wall 411. Accordingly, the first fixed terminal 420A is fixed to the top wall 411 in a state where the insertion hole 411a is hermetically sealed. In this event, the first fixed terminal 420A is fixed to the top wall 411 in a state where the longitudinal direction approximately coincides with the vertical direction. Note that it is not necessary to make the longitudinal direction of the first fixed terminal 420A approximately coincide with the vertical direction.

Likewise, upon fixing the second fixed terminal 420B to the top wall 411, the second fixed terminal main body 421B of the second fixed terminal 420B is inserted from above into the insertion hole of the washer 50 and the other insertion hole 411a of the top wall 411 in a state where the washer 50 is arranged on the upper surface of the peripheral portion of the other insertion hole 411a in the top wall 411. Then, the upper surface of the washer 50 and the lower surface of the second flange part 422B are hermetically joined with the silver solder 51, and the lower surface of the washer 50 and the upper surface of the top wall 411 (the upper surface of the peripheral portion of the other insertion hole 411a) are hermetically joined with the silver solder 52. Thus, the second fixed terminal 420B is fixed to the top wall 411. Accordingly, the second fixed terminal 420B is also fixed to the top wall 411 in a state where the insertion hole 411a is hermetically sealed. In this event, the second fixed terminal 420B is fixed to the top wall 411 in a state where the longitudinal direction approximately coincides with the vertical direction. Note that it is not necessary to make the longitudinal direction of the second fixed terminal 420B approximately coincide with the vertical direction.

As described above, in this embodiment, the first fixed terminal 420A and the second fixed terminal 420B are fixed (arranged) on the top wall 411 so as to be spaced apart from each other. Then, the upper and lower sides of the first fixed terminal 420A are partitioned by the top wall 411 in a state where the first fixed terminal 420A is fixed to the top wall 411. Likewise, the upper and lower sides of the second fixed terminal 420B are partitioned by the top wall 411 in a state where the second fixed terminal 420B is fixed to the top wall 411.

A first bus bar (first conductive member) 440A connected to an external load or the like is attached to the first fixed terminal 420A, and a second bus bar (second conductive member) 440B connected to an external load or the like is attached to the second fixed terminal 420B.

The first bus bar 440A has a shape obtained by bending a member formed of a conductive material, and includes a first fixed part 441A fixed to the first fixed terminal 420A and a first terminal 442A inserted into one slit 21b. The first fixed part 441A has a first insertion hole 441aA formed therein, and a first projection 423A provided at the center of the first flange part 422A so as to project upward is caulked while being inserted into the first insertion hole 441aA. Thus, the first bus bar 440A is fixed to the first fixed terminal 420A.

Likewise, the second bus bar 440B also has a shape obtained by bending a member formed of a conductive material, and includes a second fixed part 441B fixed to the second fixed terminal 420B and a second terminal part 442B inserted into the other slit 21b. The second fixed part 441B has a second insertion hole 441aB formed therein, and a second projection 423B provided at the center of the second flange part 422B so as to project upward is caulked while being inserted into the second insertion hole 441aB. Thus, the second bus bar 440B is fixed to the second fixed terminal 420B.

In the base 410, the movable contact 430 having a conductive part 430a is disposed so as to be movable relative to the first and second fixed terminals 420A and 420B as the shaft 380 is moved in the up-down direction (one direction).

In this embodiment, the entire movable contact 430 serves as the conductive part 430a. When the shaft 380 is moved upward (toward one side) in the up-down direction (one direction), the movable contact 430 is moved relative to the first and second fixed terminals 420A and 420B so as to come into contact with the first and second fixed terminals 420A and 420B. On the other hand, when the shaft 380 is moved downward (toward the other side) in the up-down direction (one direction), the movable contact 430 is moved relative to the first and second fixed terminals 420A and 420B so as to come away from at least one of the first and second fixed terminals 420A and 420B. In this embodiment, the movable contact 430 is separated from both of the first and second fixed terminals 420A and 420B (see FIG. 4(a)).

To be more specific, the movable contact 430 includes a first contact unit 431A that comes into contact with the first fixed terminal 420A when the shaft 380 is moved upward (toward one side) in the up-down direction (one direction). The movable contact 430 further includes a second contact unit 431B that is electrically connected to the first contact unit 431A and comes into contact with the second fixed terminal 420B.

When the shaft 380 is moved upward (toward one side) in the up-down direction (one direction), the first contact unit 431A is moved relative to the first fixed terminal 420A so as to come into contact with the outer surface 421aA of the first fixed terminal 420A. Likewise, when the shaft 380 is moved upward (toward one side) in the up-down direction (one direction), the second contact unit 431B is moved relative to the second fixed terminal 420B so as to come into contact with the outer surface 421aB of the second fixed terminal 420B.

Thus, the first fixed terminal 420A and the second fixed terminal 420B are brought into a conductive state.

On the other hand, when the shaft 380 is moved downward (toward the other side) in the up-down direction (one direction), the first contact unit 431A is moved relative to the first fixed terminal 420A so as to be separated from the outer surface 421aA of the first fixed terminal 420A. Likewise, when the shaft 380 is moved downward (toward the other side) in the up-down direction (one direction), the second contact unit 431B is moved relative to the second fixed terminal 420B so as to be separated from the outer surface 421aB of the second fixed terminal 420B.

Thus, the first fixed terminal 420A and the second fixed terminal 420B are brought into a non-conductive state.

As described above, the drive block (drive unit) 30 according to this embodiment includes the shaft 380 that drives (moves) the movable contact 430, and the shaft 380 is moved upward (toward one side) in the up-down direction (one direction) to move the movable contact 430 relative to the first fixed terminal 420A and the second fixed terminal 420B, thus bringing the first and second fixed terminals 420A and 420B into the conductive state. On the other hand, the shaft 380 is moved downward (toward the other side) in the up-down direction (one direction) to move the movable contact 430 relative to the first fixed terminal 420A and the second fixed terminal 420B, thus bringing the first and second fixed terminals 420A and 420B in the non-conductive state.

That is, in this embodiment, the movable contact 430 is moved relative to the first and second fixed terminals 420A and 420B as the shaft 380 is moved in the up-down direction (one direction), thus making it possible to switch conduction and non-conduction between the first and second fixed terminals 420A and 420B.

Between the movable contact 430 and the pressing plate 303, an insulating plate 480 is provided, which is formed of an insulating material so as to cover the pressing plate 303, and the insulating plate 480 has an insertion hole 480a provided at its center, through which the shaft 380 is inserted.

In this embodiment, the contact pressure between the movable contact 430 and the first fixed terminal 420A and the contact pressure between the movable contact 430 and the second fixed terminal 420B are secured by a contact pressure spring 401.

The contact pressure spring 401 is formed using a coil spring, and is arranged with the axial direction coinciding with the up-down direction.

To be more specific, the contact pressure spring 401 has its upper end come into contact with the lower surface of the head 382. The contact pressure spring 401 also has its lower end inserted into a recess portion surrounded by the flange part 362 above the projection 363 of the fixed iron core 360 so as to come into contact with the upper surface 363a of the projection 363. That is, the lower surface of the head 382 and the upper surface 363a of the projection 363 serve as a spring receiving part for the contact pressure spring 401. The shaft 380 is biased upward by the contact pressure spring 401, and the head 382 of the shaft 380 presses the movable contact 430 upward. Therefore, in this embodiment, the shaft 380 as a moving body also functions as a pressing body that presses the movable contact 430 upward (toward one side) in the up-down direction (one direction).

In the contact device 10 configured as described above, the shaft 380 can be attached to the movable iron core 370 in the following manner, for example.

First, the movable iron core 370, the return spring 302, the yoke upper plate 351, the fixed iron core 360, the iron core rubber 304, the pressing plate 303, the insulating plate 480, and the contact pressure spring 401 are arranged in this order from the lower side. In this event, it is preferable that the return spring 302 is inserted into the insertion hole 360a of the fixed iron core 360.

Then, the shaft main body 381 of the shaft 380 is inserted into the respective insertion holes 480a, 303a, 304a, 360a, and 351a, the contact pressure spring 401, and the return spring 302 from above the insulating plate 480, and then inserted into the insertion hole 370a of the movable iron core 370 to be connected. Thus, the lower end of the shaft 380 is attached to the movable iron core 370.

In this embodiment, the connection of the shaft 380 to the movable iron core 370 is performed by crushing and riveting the tip in a protruding state into the recess part 371 as shown in FIG. 4. However, the shaft 380 may be connected to the movable iron core 370 using other methods. For example, the shaft 380 may be connected to the movable iron core 370 by forming a screw groove at the other end of the shaft 380 and screwing the movable iron core 370 into the screw groove. Alternatively, the shaft 380 may be connected to the movable iron core 370 by press-fitting the shaft 380 into the insertion hole 370a of the movable iron core 370.

In this embodiment, when the movable contact 430 is separated from the first fixed terminal 420A or when the movable contact 430 is separated from the second fixed terminal 420B, a gas is enclosed in the base 410 to suppress arc generated between the movable contact 430 and the first fixed terminal 420A or arc generated between the movable contact 430 and the second fixed terminal 420B. As such a gas, a mixed gas can be used, which is mainly composed of hydrogen gas having the highest heat conductivity in a temperature range where the arc is generated. In order to enclose this gas, an upper flange 470 is provided in this embodiment to cover a gap between the base 410 and the yoke upper plate 351.

To be more specific, the base 410 is formed in a hollow box shape with an open bottom (on the movable contact 430 side) as described above, including the top wall 411 in which the pair of insertion holes 411a and 411a are arranged in the left-right direction (width direction) and the rectangular cylindrical peripheral wall 412 that extends downward from the periphery of the top wall 411. The base 410 is fixed to the yoke upper plate 351 through the upper flange 470 in a state where the movable contact 430 is housed inside the peripheral wall 412 from the open bottom.

In this event, the peripheral edge of the opening in the lower surface of the base 410 and the upper surface of the upper flange 470 are hermetically joined with a silver solder 53, while the lower surface of the upper flange 470 and the upper surface of the yoke upper plate 351 are hermetically joined by arc welding or the like. Furthermore, the lower surface of the yoke upper plate 351 and the flange part 392 of the plunger cap 390 are hermetically joined by arc welding or the like. Thus, a sealed space S with gas sealed therein is formed in the base 410.

In this embodiment, arc suppression using a capsule yoke block 450 is also performed in parallel with the arc suppression method using gas. The capsule yoke block 450 includes a capsule yoke 451 and a pair of permanent magnets 452 and 452. The capsule yoke 451 is formed in an approximately U-shape using a magnetic material such as iron. The capsule yoke 451 is formed by integrating a pair of side pieces 451a and 451a facing each other and a connecting piece 45 lb connecting base ends of the both side pieces 451a and 451a.

The permanent magnets 452 and 452 are attached to the side pieces 451a and 451a of the capsule yoke 451 so as to face the side pieces 451a and 451a, respectively, to provide the base 410 with a magnetic field approximately perpendicular to the moving direction (up-down direction) of the shaft 380. As a result, the arc is elongated in a direction perpendicular to the moving direction of the shaft 380, and is cooled by the gas sealed in the base 410. Accordingly, the arc voltage rises sharply and the arc is interrupted when the arc voltage exceeds the voltage between the contacts. That is, in the electromagnetic relay 1 of this embodiment, arc measures are taken by magnetic blowing with the capsule yoke block 450 and cooling with the gas sealed in the base 410. Thus, the arc can be interrupted in a short time, making it possible to reduce the consumption of the movable contact 430 and the fixed terminals (first and second fixed terminals 420A and 420B).

When the movable contact 430 is brought into contact with the first fixed terminal 420A and the second fixed terminal 420B, a current flows between the first and second fixed terminals 420A and 420B through the movable contact 430. Such a current flowing between the first and second fixed terminals 420A and 420B through the movable contact 430 causes electromagnetic repulsion force to act between the first fixed terminal 420A and the movable contact 430 and between the second fixed terminal 420B and the movable contact 430. That is, in a state where the first fixed terminal 420A and the second fixed terminal 420B are electrically connected, a force that moves the shaft 380 downward in the up-down direction (force in a direction to set the first and second fixed terminals 420A and 420B in the non-conductive state) acts on the shaft 380.

From the viewpoint of improving the reliability of the contact, it is preferable to reduce the electromagnetic repulsion force acting on the moving body (shaft 380).

Therefore, in this embodiment, the electromagnetic repulsion force acting on the moving body (shaft 380) can be further reduced.

To be more specific, the first contact unit 431A includes the first contact piece 432A on the first contact unit side that comes into contact with the side surface 421bA of the first fixed terminal 420A. As described above, in this embodiment, the entire movable contact 430 serves as the conductive part 430a. Therefore, when the first contact piece 432A on the first contact unit side is brought into contact with the side surface 421bA of the first fixed terminal 420A, the first contact piece 432A on the first contact unit side and the side surface 421bA of the first fixed terminal 420A are electrically connected.

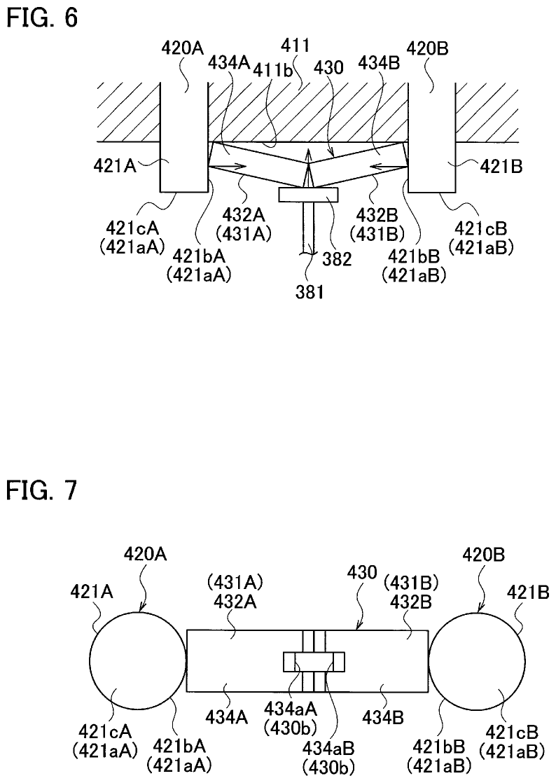

Thus, when the first contact piece 432A (a part of the conductive part 430a) on the first contact unit side is brought into contact with the side surface 421bA extending in the vertical direction (up-down direction), electromagnetic repulsion force is generated in an approximately horizontal direction (a direction different from the downward direction) between the first fixed terminal 420A and the first contact piece 432A on the first contact unit side (the first contact unit 431A of the movable contact 430) (see FIG. 6).

Therefore, in this embodiment, the side surface 421bA of the first fixed terminal 420A corresponds to a first surface (first surface of the first fixed terminal 420A) that comes into contact with the first contact unit 431A from the direction intersecting with the up-down direction (one direction). Therefore, when the conductive part 430a of the movable contact 430 come into contact with the side surface 421bA of the first fixed terminal 420A, electromagnetic repulsion force is generated in a direction different from the downward direction (the other side in one direction). The side surface 421bA (the first surface of the first fixed terminal 420A) is an intersecting surface that intersects with a plane perpendicular to the up-down direction (one direction) (horizontally extending plane in this embodiment).

Furthermore, in this embodiment, the second contact unit 431B includes the first contact piece 432B on the second contact unit side that comes into contact with the side surface 421bB of the second fixed terminal 420B. The first contact piece 432B on the second contact unit side is also a part of the conductive part 430a.

Therefore, when the first contact piece 432B on the second contact unit side is brought into contact with the side surface 421bB extending in the vertical direction (up-down direction), again, electromagnetic repulsion force is generated in an approximately horizontal direction (a direction different from the downward direction) between the second fixed terminal 420B and the first contact piece on the second contact unit side (the second contact unit 431B of the movable contact 430) (see FIG. 6).

As described above, in this embodiment, the side surface 421bB of the second fixed terminal 420B corresponds to a first surface (first surface of the second fixed terminal 420B) that comes into contact with the second contact unit 431B from the direction intersecting with the up-down direction (one direction). Therefore, when the conductive part 430a of the movable contact 430 comes into contact with the side surface 421bB of the second fixed terminal 420B, electromagnetic repulsion force is generated in a direction different from the downward direction (the other side in one direction). The side surface 421bB (the first surface of the second fixed terminal 420B) is an intersecting surface that intersects with a plane perpendicular to the up-down direction (one direction) (horizontally extending plane in this embodiment).

Here, in this embodiment, the movable contact 430 as described above is formed by connecting plate members 434A and 434B with a leaf spring (connecting member) 439, the plate members having rigidity and an approximately rectangular parallelepiped shape elongated in the left-right direction.

To be more specific, one side of the leaf spring 439 is connected to the upper surface of the plate member 434A and the other side of the leaf spring 439 is connected to the upper surface of the plate member 434B in a state where one end of the plate member 434A is brought into contact with one end of the plate member 434B, thereby forming an approximately V-shaped movable contact 430. Thus, the plate member 434A and the plate member 434B are supported so as to be relatively rotatable around the ends that come into contact with each other.

In this embodiment, since the entire movable contact 430 serves as the conductive part 430a, the plate members 434A and 434B and the leaf spring 439 are both formed using a conductive material. However, the leaf spring 439 can be formed using an insulating material. In this case, the plate members 434A and 434B serve as the conductive part 430a of the movable contact 430.

Furthermore, the connection between the plate members 434A and 434B and the leaf spring 439 can be made by using joining means or by using locking means. Examples of the joining means include welding, bonding, and the like. As the locking means, for example, there is a method including forming a pair of notch pieces in the leaf spring 439, forming a locking hole in each of the plate members 434A and 434B, and locking the notch pieces in the locking holes.

Then, when the shaft 380 is moved upward (toward one side) in the up-down direction (one direction), the other end of the plate member 434A comes into contact with (is electrically connected to) the side surface 421bA of the first fixed terminal 420A, and the other end of the plate member 434B comes into contact with (is electrically connected to) the side surface 421bB of the second fixed terminal 420B.

When the shaft 380 is moved downward (toward the other side) in the up-down direction (one direction), the other end of the plate member 434A is separated from the side surface 421bA of the first fixed terminal 420A, and the other end of the plate member 434B is separated from the side surface 421bB of the second fixed terminal 420B.

Therefore, in this embodiment, the distance between the other ends of the plate members 434A and 434B in a state where the plate members 434A and 434B are arranged horizontally with their one ends in contact with each other is set to be equal to or larger than the shortest distance between the side surface 421bA of the first fixed terminal 420A and the side surface 421bB of the second fixed terminal 420B.

Furthermore, when the leaf spring 439 is in a natural state, the distance between the other end of the plate member 434A and the other end of the plate member 434B is set shorter than the shortest distance between the side surface 421bA of the first fixed terminal 420A and the side surface 421bB of the second fixed terminal 420B.

That is, in this embodiment, the plate members 434A and 434B are relatively rotated in a direction in which the other ends are separated from each other (opening direction) against the elastic restoring force of the leaf spring 439. Thus, the other end of the plate member 434A comes into contact with the side surface 421bA of the first fixed terminal 420A and the other end of the plate member 434B comes into contact with the side surface 421bB of the second fixed terminal 420B until the distance between the other ends of the plate members 434A and 434B is maximized.

Then, the plate members 434A and 434B are relatively rotated by the elastic restoring force of the leaf spring 439 in a direction in which the other ends approach each other (closing direction). Thus, the other end of the plate member 434A is separated from the side surface 421bA of the first fixed terminal 420A and the other end of the plate member 434B is separated from the side surface 421bB of the second fixed terminal 420B.

As described above, in this embodiment, the plate member 434A functions as the first contact piece 432A on the first contact unit, while the plate member 434B functions as the first contact piece 432B on the second contact unit side. That is, the first contact piece 432A on the first contact unit side includes the plate member 434A having rigidity, and the first contact piece 432B on the second contact unit side includes the plate member 434B having rigidity.

In this embodiment, the first contact unit 431A and the second contact unit 431B are formed as separate components.

Note that the plate members 434A and 434B having rigidity come into contact with the side surface 421bA of the first fixed terminal 420A and the side surface 421bB of the second fixed terminal 420B, respectively. Therefore, the plate members 434A and 434B come into contact with the side surfaces 421bA and 421bB in a stretched state.

In this embodiment, the movable contact 430 having the configuration as described above is placed on the upper surface of the head 382 of the shaft 380, and the plate members 434A and 434B are moved relatively in conjunction with the vertical movement of the shaft 380.

In this event, the upper surface of the head 382 of the shaft 380 is curved downward to make it easier for the plate members 434A and 434B to be relatively rotated in conjunction with the vertical movement of the shaft 380.

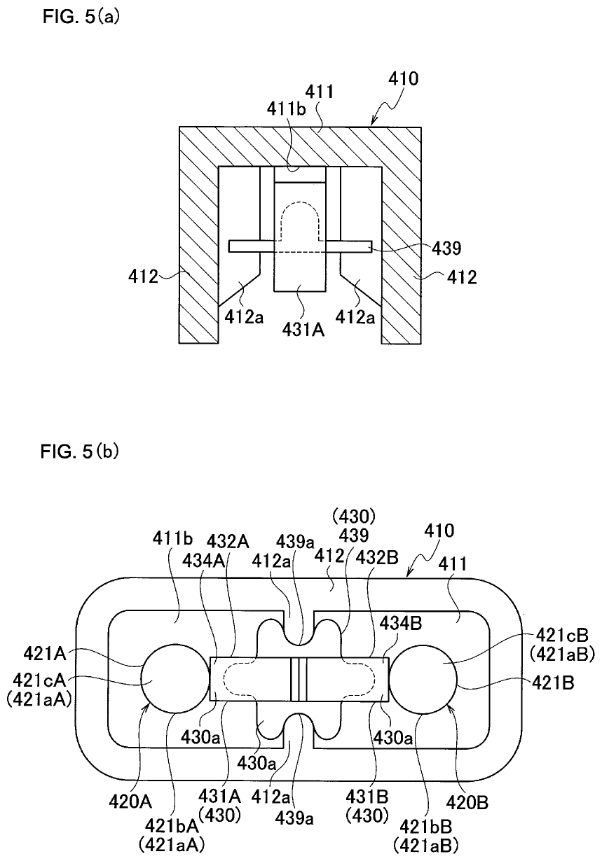

However, if the movable contact 430 is simply placed on the upper surface of the head 382 of the shaft 380 as in this embodiment, the movable contact 430 may be displaced and deviate from the head 382 of the shaft 380. There is also a possibility that the movable contact 430 is rotated and the first and second fixed terminals 420A and 420B can no longer be electrically connected. For this reason, in this embodiment, the projections 412a and 412a extending in the up-down direction are formed on the inner surfaces of the peripheral wall 412 of the base 410 facing each other, and recess parts 439a and 439a to be engaged with the projections 412a and 412a, respectively, are formed on either side of the width direction (front-rear direction) of the leaf spring 439 (see FIG. 5).

Thus, the movable contact 430 can be moved in the up-down direction in a state where the recess parts 439a and 439a of the leaf spring 439 are engaged with the projections 412a and 412a, respectively.

It is also possible to rotatably connect the movable contact 430 to the head 382 of the shaft 380 and to move the movable contact 430 integrally with the shaft 380.

Furthermore, in this embodiment, the plate members 434A and 434B are relatively rotated with the other ends of the plate members 434A and 434B (tip of the movable contact 430) sliding on the lower surface 411b of the top wall 411 of the base 410.

In this embodiment, when the movable iron core 370 is at the initial position, the other ends of the plate members 434A and 434B (tip of the movable contact 430) come into contact with the lower surface 411b of the top wall 411 of the base 410 in a state of being biased in the closing direction by the leaf spring 439 (see FIG. 4(a)). When the movable iron core 370 is at the initial position, the tip of the movable contact 430 can be brought into contact with the lower surface 411b of the top wall 411 in a state where no biasing force of the leaf spring 439 is acting (in the natural state of the leaf spring 439). When the movable iron core 370 is at the initial position, the tip of the movable contact 430 may be separated from the lower surface 411b of the top wall 411.

With the configuration of the movable contact 430 as described above, when energization of the coil 330 is started, the shaft 380 connected to the movable iron core 370 is moved upward. When the shaft 380 is moved upward, the vertex portion (one end side of each of the plate members 434A and 434B) of the approximately V-shaped movable contact 430 is pressed upward by the shaft 380.

When one end side of each of the plate members 434A and 434B is thus pressed upward, the plate members 434A and 434B have the other ends slide on the lower surface 411b of the top wall 411 of the base 410 against the elastic restoring force of the leaf spring 439, and are relatively rotated in a direction in which the other ends are separated from each other (opening direction). Such relative rotation in the direction in which the other ends are separated from each other (opening direction) causes the other end of the plate member 434A to come into contact with the side surface 421bA of the first fixed terminal 420A, and the other end of the plate member 434B to come into contact with the side surface 421bB of the second fixed terminal 420B. In this event, the tip of the approximately V-shaped movable contact 430 comes into contact with the inner side surfaces 421bA and 421bB (opposing portions of the side surfaces 421bA and 421bB) of the fixed terminals 420A and 420B.

It is preferable that the plate members 434A and 434B come into contact with the side surfaces 421bA and 421bB of the fixed terminals 420A and 420B in a state where the angle between the plate members 434A and 434B and the lower surface 411b is 45 degrees or less. In this way, when electromagnetic repulsion force is generated, the downward component force transmitted from each of the plate members 434A and 434B to the shaft 380 can be reduced. Furthermore, the direction in which the plate members 434A and 434B are stretched (extending direction of the plate members 434A and 434B) can be set closer to the direction in which the electromagnetic repulsion force is generated. Accordingly, the component force of the electromagnetic repulsion force in the extending direction of the plate members 434A and 434B is increased, and more component of the electromagnetic repulsion force can be received in the stretching direction of the plate members 434A and 434B. As a result, it is possible to more reliably suppress the movement of the plate members 434A and 434B.

Furthermore, in this embodiment, before the movable iron core 370 comes into contact with the fixed iron core 360 (before reaching the contact position), the first contact piece 432A on the first contact unit side and the first contact piece 432B on the second contact unit side come into contact with the side surface 421bA of the first fixed terminal 420A and the side surface 421bB of the second fixed terminal 420B, respectively. That is, the first contact piece 432A on the first contact unit side and the first contact piece 432B on the second contact unit side come into contact with the side surface 421bA of the first fixed terminal 420A and the side surface 421bB of the second fixed terminal 420B, respectively, in a state of being pressed upward (toward one side) in the up-down direction (one direction) by the shaft (moving body: pressing body) 380 (see FIG. 6).

Thus, in this embodiment, the first contact piece 432A on the first contact unit side comes into contact with the side surface (first surface) 421bA of the first fixed terminal 420A in a stretched state while being pressed upward (toward one side) in the up-down direction (one direction) by the shaft (moving body: pressing body) 380. Meanwhile, the first contact piece 432B on the second contact unit side comes into contact with the side surface (first surface) 421bB of the second fixed terminal 420B in a stretched state while being pressed upward (toward one side) in the up-down direction (one direction) by the shaft (moving body: pressing body) 380.

Thus, when the coil 330 is energized, the force pressing the movable contact 430 upward by the shaft (moving body: pressing body) 380, reaction force received by the plate member 434A from the first fixed terminal 420A, and reaction force received by the plate member 434B from the second fixed terminal 420B are balanced to maintain the conductive state between the first fixed terminal 420A and the second fixed terminal 420B.

In this embodiment, the plate member 434A (the first contact piece 432A on the first contact unit side) and the plate member 434B (the first contact piece 432B on the second contact unit side) come into contact with the side surfaces 421bA and 421bB of the fixed terminals 420A and 420B in a state of being biased in the closing direction by the leaf spring 439.

Therefore, when the energization of the coil 330 is stopped, the shaft 380 is moved downward to release the upward pressing by the shaft 380, and the plate member 434A (the first contact piece 432A on the first contact unit side) and the plate member 434B (the first contact piece 432B on the second contact unit side) are rotated in a direction of closing each other by the elastic restoring force of the leaf spring 439. That is, the plate member 434A (the first contact piece 432A on the first contact unit side) and the plate member 434B (the first contact piece 432B on the second contact unit side) are moved in the direction of closing each other as the shaft 380 is moved downward.

Thus, the other end of the plate member 434A is separated from the side surface 421bA of the first fixed terminal 420A, and the other end of the plate member 434B is separated from the side surface 421bB of the second fixed terminal 420B.

Next, operations of the electromagnetic relay 1 (contact device 10) will be described.

First, when the coil 330 is not energized, the elastic force of the return spring 302 and the elastic force (elastic restoring force) of the leaf spring 439 overcome the elastic force of the contact pressure spring 401, resulting in a state shown in FIG. 4(a) where the movable iron core 370 is moved in a direction of separating from the fixed iron core 360 and the movable contact 430 moves away from the first fixed terminal 420A and the second fixed terminal 420B.

When the coil 330 is energized from the off state, the movable iron core 370 is attracted to the fixed iron core 360 by the electromagnetic force against the elastic force of the return spring 302 and the elastic force (elastic restoring force) of the leaf spring 439 so as to approach the fixed iron core 360. Then, as the movable iron core 370 is moved upward (toward the fixed iron core 360), the shaft 380 is also moved upward.

Furthermore, the movable contact 430 is pressed upward by the upward movement of the shaft 380, and the tips of the plate member 434A (the first contact piece 432A on the first contact unit side) and the plate member 434B (the first contact piece 432B on the second contact unit side) of the movable contact 430 are moved so as to move away from each other while the plate members 434A and 434B sliding on the lower surface 411b of the top wall 411. That is, the tip side of the approximately V-shaped movable contact 430 is rotated in a direction of opening each other while sliding on the lower surface 411b of the top wall 411.

Then, before the movable iron core 370 comes into contact with the fixed iron core 360, the plate member 434A (the first contact piece 432A on the first contact unit side) comes into contact with the side surface 421bA of the first fixed terminal 420A in a stretched state, and the plate member 434B (the first contact piece 432B on the second contact unit side) comes into contact with the side surface 421bB of the second fixed terminal 420B in a stretched state.

Thus, the first and second contact units 431A and 431B of the movable contact 430 come into contact with the first and second fixed terminals 420A and 420B, respectively, and the first and second fixed terminals 420A and 420B are electrically connected to turn on the electromagnetic relay 1 (contact device 10) (see FIG. 4(b)).

On the other hand, when the current supply to the coil 330 is stopped, the movable iron core 370 is returned to the initial position by the biasing force of the return spring 302 and the elastic force (elastic restoring force) of the leaf spring 439. That is, the movable iron core 370 is moved downward.

Then, as the movable iron core 370 is moved downward, the shaft 380 is also moved downward.

Furthermore, as the shaft 380 is moved downward, the tips of the plate member 434A (the first contact piece 432A on the first contact unit side) and the plate member 434B of the movable contact 430 (the first contact piece 432B on the second contact unit side) are moved so as to approach each other with the plate members 434A and 434B sliding on the lower surface 411b of the top wall 411. That is, the tip side of the approximately V-shaped movable contact 430 is rotated in a direction of closing each other while sliding on the lower surface 411b of the top wall 411. Thus, the first contact piece 432A on the first contact unit side is separated from the side surface 421bA of the first fixed terminal 420A, and the first contact piece 432B on the second contact unit side is separated from the side surface 421bB of the second fixed terminal 420B.

Thus, the first fixed terminal 420A and the second fixed terminal 420B are electrically insulated to turn off the electromagnetic relay 1 (contact device 10) (see FIG. 4(a)).

As described above, in this embodiment, the contact device 10 includes the first fixed terminal 420A and the movable contact 430 that comes into contact with and away from the first fixed terminal 420A by moving relative to the first fixed terminal 420A. The contact device 10 further includes the drive block (drive unit) 40 provided with the shaft (moving body) 380 that moves the movable contact 430 and configured to allow the movable contact 430 to come into contact with the first fixed terminal 420A by moving the shaft 380 upward (to one side) in the up-down direction (one direction) and to allow the movable contact 430 to come away from the first fixed terminal 420A by moving the shaft 380 downward (to the other side) in the up-down direction (one direction).

The movable contact 430 includes the first contact unit 431A that comes into contact with the first fixed terminal 420A when the shaft 380 is moved upward in the up-down direction, and the first fixed terminal 420A includes the side surface (first surface of the first fixed terminal 420A) 421bA with which the first contact unit 431A comes into contact from a direction intersecting with the up-down direction (one direction). The first contact unit 431A includes the first contact piece 432A on the first contact unit side, which comes into contact with the side surface 421bA of the first fixed terminal 420A in a stretched manner in a state where the first contact unit is pressed upward in the up-down direction by the shaft 380.

Thus, the electromagnetic repulsion force generated when the first contact piece 432A, which is the conductive part 430a of the movable contact 430, comes into contact with the side surface 421bA of the first fixed terminal 420A is generated in a direction different from the downward direction (the other side in the one direction). Furthermore, the first contact piece 432A on the first contact unit side is supported in a stretched state between the shaft 380 and the side surface (first surface) 421bA of the first fixed terminal 420A.

With such a configuration, when electromagnetic repulsion force is generated, downward component force of the electromagnetic repulsion force is transmitted from the first contact piece 432A to the shaft 380. Thus, the downward movement of the shaft 380 can be suppressed more reliably. That is, the electromagnetic repulsion force acting on the shaft 380 can be reduced. As a result, the reliability of the contact can be further improved.

Furthermore, the electromagnetic relay 1 according to this embodiment is equipped with the contact device 10.

Thus, according to this embodiment, it is possible to realize the contact device 10 capable of further improving the reliability of the contact and the electromagnetic relay 1 equipped with the contact device 10.

In this embodiment, the conductive part 430a of the movable contact 430 includes the first contact piece 432A on the first contact unit side.

Thus, the electromagnetic repulsion force generated at the contact portion (contact) between the side surface (first surface) 421bA of the first fixed terminal 420A and the first contact piece 432A on the first contact unit side can be set in a direction different from the downward direction (the other side) of the up-down direction. With the electromagnetic repulsion force thus generated in the direction other than the downward direction, the magnitude of the downward force transmitted from the plate member 434A to the shaft 380 can be set smaller than the magnitude of the electromagnetic repulsion force upon generation thereof. As a result, the electromagnetic repulsion force acting on the shaft 380 can be reduced.

Furthermore, in this embodiment, the first contact piece 432A on the first contact unit side is pressed upward (to one side) in the up-down direction (one direction) by the shaft 380 in a contact state with the side surface (first surface) 421bA of the first fixed terminal 420A. The first contact piece 432A on the first contact unit side is configured to come into contact with the side surface (first surface) 421bA of the first fixed terminal 420A in a stretched state. That is, the first contact piece 432A on the first contact unit side is supported in a stretched state between the shaft 380 and the side surface (first surface) 421bA of the first fixed terminal 420A. Therefore, even if electromagnetic repulsion force is generated at the contact portion (contact) between the side surface (first surface) 421bA of the first fixed terminal 420A and the first contact piece 432A on the first contact unit side, the electromagnetic repulsion force can prevent the first contact piece 432A on the first contact unit side from being separated from the side surface (first surface) 421bA of the first fixed terminal 420A. As a result, the movable contact 430 can be more stably brought into contact with the first fixed terminal 420A, and the contact reliability of the contact of the contact device 10 can be further improved.

The first contact piece 432A on the first contact unit side is brought into contact with the side surface (first surface) 421bA of the first fixed terminal 420A in a stretched state while being pressed upward (to one side) in the up-down direction (one direction) by the shaft 380. Accordingly, the rotation moment generated at the contact portion (contact) between the side surface (first surface) 421bA of the first fixed terminal 420A and the first contact piece 432A on the first contact unit side by the electromagnetic repulsion force can be reduced by the pressing force of the shaft 380. Therefore, the movable contact 430 can be more stably brought into contact with the first fixed terminal 420A, and the contact reliability of the contact of the contact device 10 can be further improved.

Furthermore, in this embodiment, the side surface (first surface) 421bA of the first fixed terminal 420A is an intersecting surface that intersects with a plane perpendicular to the up-down direction (one direction).

Thus, with the first contact piece 432A on the first contact unit side brought into contact with the plane perpendicular to the up-down direction (one direction) of the first fixed terminal 420A, a fixed terminal having an existing shape can be used to reduce the electromagnetic repulsion force acting on the shaft 380. That is, the electromagnetic repulsion force acting on the shaft 380 can be reduced without complicating the configuration of the first fixed terminal 420A.

Moreover, in this embodiment, the first contact piece 432A on the first contact unit side includes the plate member 434A having rigidity. Thus, the first contact piece 432A on the first contact unit side can be formed using the plate member 434A having rigidity, and the shape of the movable contact 430 can be simplified. In addition, by using the plate member 434A having rigidity, it is possible to more reliably suppress the first contact piece 432A on the first contact unit side from being deformed by the electromagnetic repulsion force.

Moreover, in this embodiment, the contact device 10 includes the second fixed terminal 420B that is arranged in a state separated from the first fixed terminal 420A. The movable contact 430 switches conduction and non-conduction between the first and second fixed terminals 420A and 420B by moving relative to the first and second fixed terminals 420A and 420B.

Furthermore, the first and second fixed terminals 420A and 420B are set in a conductive state by moving the shaft 380 upward in the up-down direction, and the first and second fixed terminals 420A and 420B are set in a non-conductive state by moving the shaft 380 downward in the up-down direction.

The movable contact 430 includes the second contact unit 431B that is electrically connected to the first contact unit 431A and comes into contact with the second fixed terminal 420B.

With this configuration, the reliability of the contact can be further improved in the contact device 10 of a type that switches conduction and non-conduction between the first and second fixed terminals 420A and 420B.

Furthermore, the second contact unit 431B may include the first contact piece 432B on the second contact unit side that comes into contact with the side surface (first surface) 421bB of the second fixed terminal 420B in a stretched manner in a state of being pressed upward (to one side) in the up-down direction (one direction) by the shaft 380.

With this configuration, the first contact piece 432B on the second contact unit side is also supported in a stretched state between the shaft 380 and the side surface (first surface) 421bB of the second fixed terminal 420B. Thus, the electromagnetic repulsion force acting on the shaft 380 can be further reduced.

In this event, it is preferable that the first contact piece 432B on the second contact unit side is a part of the conductive part 430a together with the first contact piece 432A on the first contact unit side.

With this configuration, the electromagnetic repulsion force generated at the contact portion (contact) between the side surface (first surface) 421bA of the first fixed terminal 420A and the first contact piece 432A on the first contact unit side is diminished by the electromagnetic repulsion force generated at the contact portion (contact) between the side surface (first surface) 421bB of the second fixed terminal 420B and the first contact piece 432B on the second contact unit side. Thus, the electromagnetic repulsion force acting on the shaft 380 can be further reduced.

Furthermore, the intersecting surface that intersects with a plane perpendicular to the up-down direction (one direction) of the second fixed terminal 420B may be the first surface (side surface 421bB) of the second fixed terminal 420B. This makes it possible to further reduce the electromagnetic repulsion force acting on the shaft 380 using the fixed terminal having the existing shape. That is, the electromagnetic repulsion force acting on the shaft 380 can be further reduced without complicating the configuration of the second fixed terminal 420B.

Moreover, the first contact piece 432B on the second contact unit side may include the plate member 434B having rigidity.

With this configuration, the first contact piece 432B on the second contact unit side can be formed using the rigid plate member 434B, and the shape of the movable contact 430 can be further simplified. Moreover, the use of the rigid plate member 434B makes it possible to more reliably prevent the first contact piece 432B on the second contact unit side from being deformed by the electromagnetic repulsion force.

Note that the contact device 10 is not limited to the configuration described in the above embodiment, but may have various configurations.

For example, the contact device 10 may have a configuration shown in FIG. 7.

In FIG. 7, again, the movable contact 430 has rigidity and is formed by connecting plate members 434A and 434B, each having an approximately rectangular parallelepiped shape elongated in the left-right direction, with a leaf spring (connecting member) 439. The plate members 434A and 434B are both formed using a conductive material, and the leaf spring 439 is formed using a conductive material or an insulating material.

Then, when the shaft 380 is moved upward (to one side) in the up-down direction (one direction), the other end of the plate member 434A comes into contact with the side surface 421bA of the first fixed terminal 420A, and the other end of the plate member 434B comes into contact with the side surface 421bB of the second fixed terminal 420B.

When the shaft 380 is moved downward (to the other side) in the up-down direction (one direction), the other end of the plate member 434A is separated from the side surface 421bA of the first fixed terminal 420A, and the other end of the plate member 434B is separated from the side surface 421bB of the second fixed terminal 420B.

Thus, with the configuration shown in FIG. 7, again, the first contact unit 431A includes the first contact piece 432A on the first contact unit side that comes into contact with the side surface (first surface) 421bA of the first fixed terminal 420A in a stretched state while being pressed upward (to one side) in the up-down direction (one direction) by the shaft 380.

Moreover, the side surface (first surface) 421bA of the first fixed terminal 420A is an intersecting surface that intersects with a plane perpendicular to the up-down direction (one direction).

The first contact piece 432A on the first contact unit side includes a rigid plate member 434A.

Furthermore, the second contact unit 431B includes the first contact piece 432B on the second contact unit side that comes into contact with the side surface (first surface) 421bB of the second fixed terminal 420B in a stretched state while being pressed upward (to one side) in the up-down direction (one direction) by the shaft 380.

Moreover, an intersecting surface that intersects with a plane perpendicular to the up-down direction (one direction) of the second fixed terminal 420B is the first surface (side surface 421bB) of the second fixed terminal 420B.

The first contact piece 432B on the second contact unit side includes a rigid plate member 434B.

Furthermore, in FIG. 7, again, the first contact unit 431A and the second contact unit 431B are formed as separate components.

Here, the movable contact 430 shown in FIG. 7 is provided with a shunt part 430b for shunting the current flowing between the first contact unit 431A and the second contact unit 431B.

To be more specific, notches 434aA and 434aB are respectively formed at the center in the width direction (front-rear direction) of one end side of the plate members 434A and 434B, and the plate members 434A and 434B come into contact with (are electrically connected) at two spots at both ends in the width direction (front-back direction) on one end side.

Accordingly, the current flowing through the movable contact 430 is shunted by the notch 434aA (or the notch 434aB), and each shunt current flows to the plate member 434B (or the plate member 434A) from each end in the width direction (front-back direction) on one end side of the plate member 434A (or the plate member 434B).

That is, approximately one-half of the current flowing through the movable contact 430 flows to the end in the width direction (front-back direction) on one end side of the plate member 434A (or the plate member 434B).

It is known that the magnitude of the electromagnetic repulsion force generated when a current flows through a contact portion between two members is proportional to the square of the current flowing through the contact portion.

Therefore, the electromagnetic repulsion force generated at each end in the width direction (front-rear direction) at one end side of the plate member 434A (or the plate member 434B is one-fourth of the electromagnetic repulsion force generated at one end side of the plate member 434A (or the plate member 434B) in a state where no shunt part 430b is provided. Therefore, as shown in FIG. 7, when the current flowing through the movable contact 430 is divided into two currents, the electromagnetic repulsion force generated at one end side of the plate member 434A (or the plate member 434B) is half the electromagnetic repulsion force generated at one end side of the plate member 434A (or the plate member 434B) in a state where no shunt part 430b is provided.

When the movable contact 430 is provided with the shunt part 430b for shunting the current flowing between the first and second contact units 431A and 431B as described above, the magnitude of the electromagnetic repulsion force generated at the contact portion between the first and second contact units 431A and 431B can be reduced compared with the case where no shunt part 430b is provided. As a result, separation of the contact portion between the first and second contact units 431A and 431B is suppressed, thus making it possible to more reliably maintain the conductive state between the first and second fixed terminals 420A and 420B.

Note that the same advantageous effects as in the above embodiment can also be achieved with the contact device 10 having the configuration shown in FIG. 7.

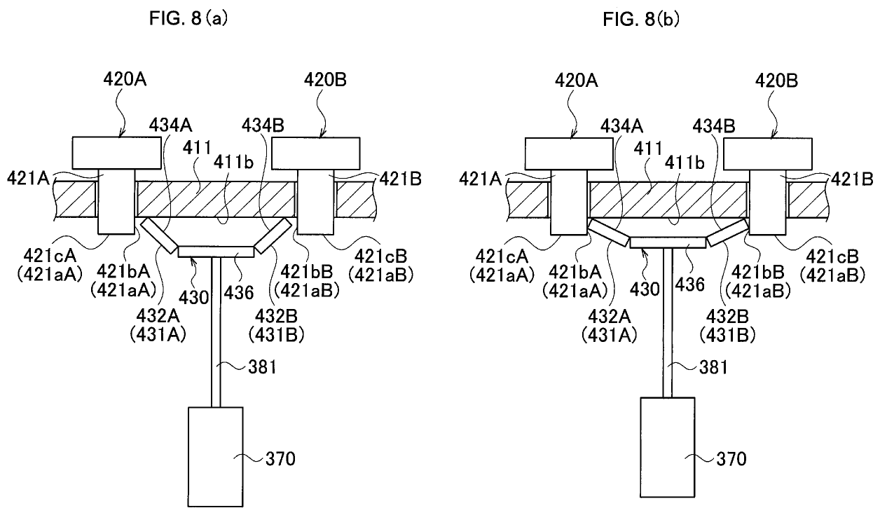

The contact device 10 may also have a configuration shown in FIG. 8.

A movable contact 430 shown in FIG. 8 has a base part 436 connected to the shaft 380 (pressed by the shaft 380). In FIG. 8, the base part 436 is formed of an approximately rectangular parallelepiped plate member having rigidity and elongated in the left-right direction. Although FIG. 8 illustrates an example where the shaft main body 381 of the shaft 380 is directly connected to the base part 436, the shaft main body 381 may also be connected to the base part 436 through the head 382.

An approximately rectangular parallelepiped plate member 434A having rigidity and elongated in the left-right direction is connected to one end of the base part 436, and an approximately rectangular parallelepiped plate member 434B having rigidity and elongated in the left-right direction is connected to the other end of the base part 436.

The plate members 434A and 434B can be connected to the base part 436 using the leaf spring 439, for example, described in the above embodiment. That is, by connecting the two members by the leaf spring 439 in a state where one end of the plate member 434A is brought into contact with one end of the base part 436, the plate member 434A can be supported on the base part 436 so as to be relatively rotatable about the ends that come into contact with each other. Likewise, by connecting the two members by the leaf spring 439 in a state where one end of the plate member 434B is brought into contact with the other end of the base part 436, the plate member 434B can be supported on the base part 436 so as to be relatively rotatable about the ends that come into contact with each other. Note that, in the configuration shown in FIG. 8, the plate member 434A, the plate member 434B, and the base part 436 are formed using a conductive material.

Then, when the shaft 380 is moved upward (to one side) in the up-down direction (one direction), the other end of the plate member 434A comes into contact with the side surface 421bA of the first fixed terminal 420A, and the other end of the plate member 434B comes into contact with the side surface 421bB of the second fixed terminal 420B (see FIG. 8(b)).

On the other hand, when the shaft 380 is moved downward (to the other side) in the up-down direction (one direction), the other end of the plate member 434A is separated from the side surface 421bA of the first fixed terminal 420A, and the other end of the plate member 434B is separated from the side surface 421bB of the second fixed terminal 420B (see FIG. 8(a)).

Thus, in the configuration shown in FIG. 8, again, the first contact unit 431A includes the first contact piece 432A on the first contact unit side that comes into contact with the side surface (first surface) 421bA of the first fixed terminal 420A in a stretched manner in a state of being pressed upward (to one side) in the up-down direction (one direction) by the shaft 380.

Further, the side surface (first surface) 421bA of the first fixed terminal 420A is an intersecting surface that intersects with a plane perpendicular to the up-down direction (one direction).

The first contact piece 432A on the first contact unit side includes a rigid plate member 434A.

Furthermore, the second contact unit 431B includes the first contact piece 432B on the second contact unit side that comes into contact with the side surface (first surface) 421bB of the second fixed terminal 420B in a stretched manner in a state of being pressed upward (to one side) in the up-down direction (one direction) by the shaft 380.

Moreover, an intersecting surface that intersects with a plane perpendicular to the up-down direction (one direction) of the second fixed terminal 420B is the first surface (side surface 421bB) of the second fixed terminal 420B.

The first contact piece 432B on the second contact unit side includes a rigid plate member 434B.

Therefore, in FIG. 8, again, the first contact unit 431A and the second contact unit 431B are formed as separate components.

Thus, the same advantageous effects as in the above embodiment can also be achieved with the contact device 10 having the configuration shown in FIG. 8.

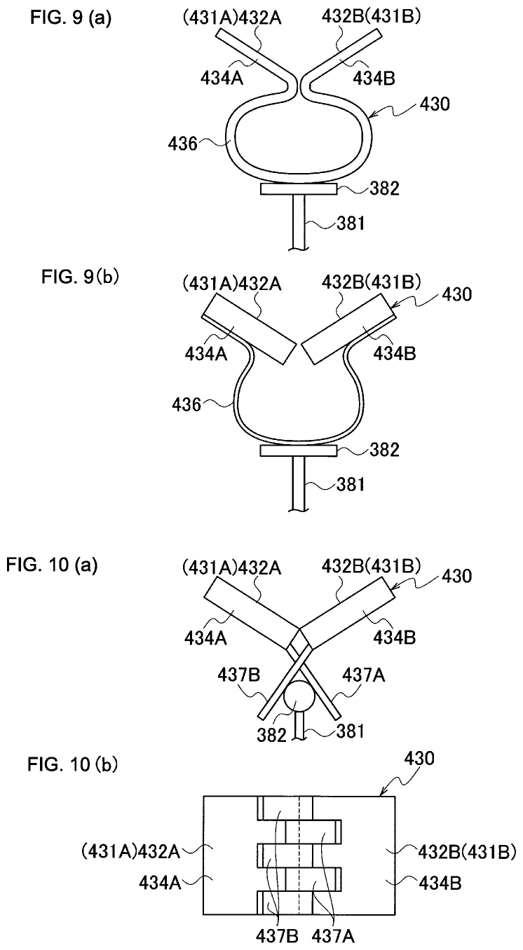

The contact device 10 may also have a configuration shown in FIG. 9.

A movable contact 430 shown in FIG. 9(a) has a shape obtained by bending a single leaf spring having conductivity. The linear portions at both ends in the left-right direction serve as a first contact piece 432A on the first contact unit side and a first contact piece 432B on the second contact unit side, respectively. The central portion serves as a base part 436 placed on or connected to the head 382 of the shaft 380 (pressed by the shaft 380).

The base part 436 that connects the first contact piece 432A on the first contact unit side to the first contact piece 432B on the second contact unit side for electrical connection is bent into a ring shape so as to have spring properties. Accordingly, by providing the base part 436 with spring properties, the base part 436 has the same function as the leaf spring 439 described in the above embodiment.

When the shaft 380 is moved upward (to one side) in the up-down direction (one direction), the base part 436 is elastically deformed, and the other end of the first contact piece 432A on the first contact unit side and the other end of the first contact piece 432B on the second contact unit side are relatively moved in a direction away from each other (opening direction).

That is, the movable contact 430 shown in FIG. 9(a) elastically deforms the base part 436 by being pressed upward by the shaft 380, so that the other end of the plate member 434A comes into contact with the side surface 421bA of the first fixed terminal 420A and the other end of the plate member 434B comes into contact with the side surface 421bB of the second fixed terminal 420B.

On the other hand, when the shaft 380 is moved downward (to the other side) in the up-down direction (one direction), the first contact piece 432A on the first contact unit side and the first contact piece 432B on the second contact unit side have their other ends relatively moved in a direction of approaching each other (closing direction) by the elastic restoring force of the base part 436. Thus, the other end of the plate member 434A is separated from the side surface 421bA of the first fixed terminal 420A, and the other end of the plate member 434B is separated from the side surface 421bB of the second fixed terminal 420B.

Note that the first contact piece 432A on the first contact unit side and the first contact piece 432B on the second contact unit side shown in FIG. 9(a) are also plate members 434A and 434B having rigidity, respectively. Therefore, the first contact piece 432A on the first contact unit side and the first contact piece 432B on the second contact unit side also come into contact with the side surfaces 421bA and 421bB in a stretched state, respectively.

As described above, in the configuration shown in FIG. 9(a), the first contact unit 431A includes the first contact piece 432A on the first contact unit side that comes into contact with the side surface (first surface) 421bA of the first fixed terminal 420A in a stretched manner in a state of being pressed upward (to one side) in the up-down direction (one direction) by the shaft 380.

The first contact piece 432A on the first contact unit side includes a rigid plate member 434A.

Furthermore, the second contact unit 431B includes the first contact piece 432B on the second contact unit side that comes into contact with the side surface (first surface) 421bB of the second fixed terminal 420B in a stretched manner in a state of being pressed upward (to one side) in the up-down direction (one direction) by the shaft 380.

The first contact piece 432B on the second contact unit side has a rigid plate member 434B.

Thus, the same advantageous effects as in the above embodiment can also be achieved with the contact device 10 having the configuration shown in FIG. 9(a).

A movable contact 430 shown in FIG. 9(b) is formed by connecting approximately rectangular parallelepiped rigid plate members 434A and 434B elongated in the left-right direction with a leaf spring constituting a base part 436 and electrically connecting the plate members 434A and 434B. That is, in the configuration shown in FIG. 9(b), the plate member 434A, the plate member 434B, and the base part 436 are formed using a conductive material.

To be more specific, the base part 436 is formed of a conductive leaf spring and has its both ends connected to the lower surfaces of the plate members 434A and 434B, respectively. The base part 436 is provided with spring properties by bending a portion not connected to the lower surfaces of the plate members 434A and 434B into a ring shape. Accordingly, by providing the base part 436 with spring properties, the base part 436 has the same function as the leaf spring 439 described in the above embodiment.

As shown in FIG. 9(b), the plate members 434A and 434B are connected to the base part 436 while being separated from each other.

The base part 436 is placed on or connected to the head 382 of the shaft 380, and is pressed by the shaft 380.

In the configuration shown in FIG. 9(b), again, when the shaft 380 is moved upward (to one side) in the up-down direction (one direction), the base part 436 is elastically deformed, and the other end of the first contact piece 432A on the first contact unit side and the other end of the first contact piece 432B on the second contact unit side are relatively moved in a direction away from each other (opening direction).

That is, the movable contact 430 shown in FIG. 9(b) also elastically deforms the base part 436 by upward pressing with the shaft 380, so that the other end of the plate member 434A comes into contact with the side surface 421bA of the first fixed terminal 420A and the other end of the plate member 434B comes into contact with the side surface 421bB of the second fixed terminal 420B.

On the other hand, when the shaft 380 is moved downward (to the other side) in the up-down direction (one direction), the elastic restoring force of the base part 436 causes the first contact piece 432A on the first contact unit side and the first contact piece 432B on the second contact unit side to relatively rotate in a direction in which the other ends thereof approach each other (closing direction). Thus, the other end of the plate member 434A is separated from the side surface 421bA of the first fixed terminal 420A, and the other end of the plate member 434B is separated from the side surface 421bB of the second fixed terminal 420B.

Note that the first contact piece 432A on the first contact unit side and the first contact piece 432B on the second contact unit side shown in FIG. 9(b) also include rigid plate members 434A and 434B, respectively. Therefore, the first contact piece 432A on the first contact unit side and the first contact piece 432B on the second contact unit side also come into contact with the side surfaces 421bA and 421bB in a stretched state, respectively.

As described above, in the configuration shown in FIG. 9(b), again, the first contact unit 431A includes the first contact piece 432A on the first contact unit side that comes into contact with the side surface (first surface) 421bA of the first fixed terminal 420A in a stretched manner in a state of being pressed upward (to one side) in the up-down direction (one direction) by the shaft 380.

The first contact piece 432A on the first contact unit side includes a rigid plate member 434A.

Furthermore, the second contact unit 431B includes the first contact piece 432B on the second contact unit side that comes into contact with the side surface (first surface) 421bB of the second fixed terminal 420B in a stretched manner in a state of being pressed upward (to one side) in the up-down direction (one direction) by the shaft 380.

The first contact piece 432B on the second contact unit side has a rigid plate member 434B.

Thus, the same advantageous effects as in the above embodiment can also be achieved with the contact device 10 having the configuration shown in FIG. 9(b).

The contact device 10 may also have a configuration shown in FIG. 10.

A movable contact 430 shown in FIG. 10 includes an approximately rectangular parallelepiped rigid plate member 434A elongated in the left-right direction and an approximately rectangular parallelepiped rigid plate member 434B elongated in the left-right direction. These plate members 434A and 434B are also formed using a conductive material.

Then, in a state where one end of the plate member 434A and one end of the plate member 434B are in contact with each other, the plate member 434A and the plate member 434B are configured to be relatively rotated about the ends that come into contact with each other.

To be more specific, a leg part 437A is formed at one end of the plate member 434A so as to extend below the plate member 434B, and a leg part 437B is formed at one end of the plate member 434B so as to extend below the plate member 434A. As shown in FIG. 10(b), a plurality of the leg parts 437A and 437B are formed in the width direction (front-back direction), and the leg parts 437B are inserted into gaps between the adjacent leg parts 437A and the leg parts 437A are inserted into gaps between the adjacent leg parts 437B. Thus, the leg parts 437A and the leg parts 437B intersect with each other when viewed from the width direction (front-back direction). Note that the leg parts 437A and 437B may be formed using a conductive material or may be formed using an insulating material.

Then, the leg parts 437A and 437B are relatively moved in a direction (opening direction) in which the tips (lower ends) are separated from each other.

Accordingly, the first contact piece 432A on the first contact unit side and the first contact piece 432B on the second contact unit side have their other ends relatively moved in a direction away from each other (opening direction). On the other hand, the leg parts 437A and 437B are relatively moved in a direction in which the tips (lower ends) approach each other (closing direction). Accordingly, the first contact piece 432A on the first contact unit side and the first contact piece 432B on the second contact unit side have their other ends relatively moved in a direction approaching each other (closing direction).

The relative rotation of the leg parts 437A and 437B is performed by the head 382 of the shaft 380 moved in the up-down direction (one direction). In FIG. 10, an approximately cylindrical head 382 whose axis is in the width direction (front-rear direction) is connected to the upper end of the shaft 380, and this approximately cylindrical head 382 is moved up and down to relatively rotate the leg parts 437A and 437B. The first contact piece 432A on the first contact unit side and the first contact piece 432B on the second contact unit side are relatively rotated in conjunction with the relative rotation of the leg parts 437A and 437B. The shape of the head 382 is not limited to the approximately cylindrical shape, but may be, for example, an approximately spherical shape, or a tapered shape that becomes narrower upward.

In the configuration shown in FIG. 10, again, when the shaft 380 is moved upward (to one direction) in the up-down direction (one direction), the other end of the plate member 434A comes into contact with the side surface 421bA of the first fixed terminal 420A, the other end of the plate member 434B comes into contact with the side surface 421bB of the second fixed terminal 420B.

On the other hand, when the shaft 380 is moved downward (to the other side) in the up-down direction (one direction), the other end of the plate member 434A is separated from the side surface 421bA of the first fixed terminal 420A, and the other end of the plate member 434B is separated from the side surface 421bB of the second fixed terminal 420B.

Thus, in the configuration shown in FIG. 10, again, the first contact unit 431A includes the first contact piece 432A on the first contact unit side that comes into contact with the side surface (first surface) 421bA of the first fixed terminal 420A in a stretched manner in a state of being pressed upward (to one side) in the up-down direction (one direction) by the shaft 380.

The first contact piece 432A on the first contact unit side includes a rigid plate member 434A.

Furthermore, the second contact unit 431B includes the first contact piece 432B on the second contact unit side that comes into contact with the side surface (first surface) 421bB of the second fixed terminal 420B in a stretched manner in a state of being pressed upward (to one side) in the up-down direction (one direction) by the shaft 380.

The first contact piece 432B on the second contact unit side has a rigid plate member 434B.

Therefore, in FIG. 10, again, the first contact unit 431A and the second contact unit 431B are formed as separate components.

Thus, the same advantageous effects as in the above embodiment can also be achieved with the contact device 10 having the configuration shown in FIG. 10.

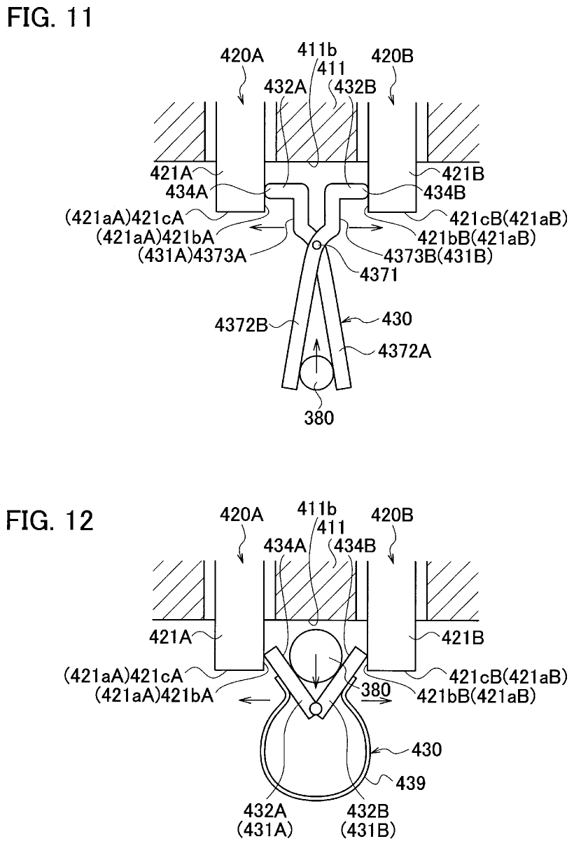

The contact device 10 may also have a configuration shown in FIG. 11.

A movable contact 430 shown in FIG. 11 has a shape like scissors, and is formed by pivotally supporting two conductive and rigid rod-shaped members in a state where the both intersect with each other so that the both are rotated relative to each other about the intersection. Note that the movable contact 430 can be formed using two conductive and rigid plate members.

In the movable contact 430 shown in FIG. 11, the intersection between the two rod-shaped members serves as a fulcrum 4371. The lower side of the fulcrum 4371 of one rod-shaped member is a first force transmission piece 4372A to which force is transmitted, while the lower side of the fulcrum 4371 of the other rod-shaped member is a second force transmission piece 4372B to which force is transmitted. Furthermore, the upper side of the fulcrum 4371 of one rod-shaped member is a first action piece 4373A that acts by the force transmitted to the first force transmission piece 4372A, while the upper side of the fulcrum 4371 of the other rod-shaped member is a second action piece 4373B that acts by the force transmitted to the second force transmission piece 4372B.

The movable contact 430 having such a shape can be disposed in the base 410 by supporting the fulcrum 4371 on a shaft attached to the peripheral wall 412 of the base 410, for example.

The first action piece 4373A has its tip bent toward the side surface 421bA of the first fixed terminal 420A, and this tip has rigidity and serves as the first contact piece 432A on the first contact unit side that comes into contact with the side surface (first surface) 421bA of the first fixed terminal 420A in a stretched state. The second action piece 4373B has its tip bent toward the side surface 421bB of the second fixed terminal 420B, and this tip has rigidity and serves as the first contact piece 432B on the second contact unit side that comes into contact with the side surface (first surface) 421bB of the second fixed terminal 420B in a stretched state.

As described above, in the movable contact 430 shown in FIG. 11, the first action piece 4373A corresponds to the first contact unit 431A, and the second action piece 4373B corresponds to the second contact unit 431B. The first contact unit 431A includes a first contact piece 432A on the first contact unit side, while the second contact unit 431B includes a first contact piece 432B on the second contact unit side.

With such a configuration, when the first force transmission piece 4372A and the second force transmission piece 4372B are relatively moved in a direction in which the tips (lower ends) are separated from each other (opening direction), the first contact piece 432A on the first contact unit side and the first contact piece 432B on the second contact unit side are relatively moved in a direction in which the tips are separated from each other. On the other hand, when the first force transmission piece 4372A and the second force transmission piece 4372B are relatively moved in a direction in which the tips (lower ends) approach each other (closing direction), the first contact piece 432A on the first contact unit side and the first contact piece 432B on the second contact unit side are relatively moved in a direction in which the tips approach each other.

The relative rotation between the first force transmission piece 4372A and the second force transmission piece 4372B is performed by the drive shaft 380 moved in the up-down direction (one direction). In FIG. 11, the first force transmission piece 4372A and the second force transmission piece 4372B are relatively rotated by moving up and down an approximately cylindrical drive shaft 380 whose axis is in the width direction (front-back direction). Then, in conjunction with the relative rotation between the first force transmission piece 4372A and the second force transmission piece 4372B, the first contact piece 432A on the first contact unit side and the first contact piece 432B on the second contact unit side are relatively moved. Note that the shape of the drive shaft 380 is not limited to the approximately cylindrical shape, but may be, for example, an approximately spherical shape or a tapered shape that becomes narrower upward.

In the configuration shown in FIG. 11, when the drive shaft 380 is moved upward (to one side) in the up-down direction (one direction), the tip of the first contact piece 432A on the first contact unit side comes into contact with the side surface 421bA of the first fixed terminal 420A, and the tip of the first contact piece 432B on the second contact unit side comes into contact with the side surface 421bB of the second fixed terminal 420B.

On the other hand, when the drive shaft 380 is moved downward (to the other side) in the up-down direction (one direction), the tip of the first contact piece 432A on the first contact unit side is separated from the side surface 421bA of the first fixed terminal 420A, and the tip of the first contact piece 432B on the second contact unit side is separated from the side surface 421bB of the second fixed terminal 420B.

Thus, in the configuration shown in FIG. 11, again, the first force transmission piece 4372A (first contact unit 431A) includes the first contact piece 432A on the first contact unit side that comes into contact with the side surface (first surface) 421bA of the first fixed terminal 420A in a stretched manner in a state of being pressed upward (to one side) in the up-down direction (one direction) by the drive shaft 380.

Furthermore, the second force transmission piece 4372B (second contact unit 431B) includes the first contact piece 432B on the second contact unit side that comes into contact with the side surface (first surface) 421bB of the second fixed terminal 420B in a stretched manner in a state of being pressed upward (to one side) in the up-down direction (one direction) by the shaft 380.

Therefore, in FIG. 11, again, the first contact unit 431A and the second contact unit 431B are formed as separate components.

Thus, the same advantageous effects as in the above embodiment can also be achieved with the contact device 10 having the configuration shown in FIG. 11.

The contact device 10 may also have a configuration shown in FIG. 12.

A movable contact 430 shown in FIG. 12 is formed by connecting approximately rectangular parallelepiped rigid plate members 434A and 434B elongated in the left-right direction with a leaf spring (connecting member) 439.

To be more specific, the plate members 434A and 434B are pivotally supported so as to be relatively rotatable about one ends that come into contact with each other. In this state, both ends of the leaf spring 439 are connected to the lower surfaces of the plate members 434A and 434B, respectively, and a portion that is not connected to the lower surfaces of the plate members 434A and 434B is curved into a ring shape, thereby forming the movable contact 430. Note that the plate members 434A and 434B are both formed using a conductive material, and the leaf spring 439 is formed using a conductive material or an insulating material.

When the leaf spring 439 is in a natural state, the distance between the other end of the plate member 434A and the other end of the plate member 434B is shorter than the shortest distance between the side surface 421bA of the first fixed terminal 420A and the side surface 421bB of the second fixed terminal 420B.

Here, in the configuration shown in FIG. 12, when the drive shaft 380 is moved downward (to one side) in the up-down direction (one direction), the first contact piece 432A on the first contact unit side and the first contact piece 432B on the second contact unit side are relatively rotated in a direction in which the other ends thereof are separated from each other (opening direction).

That is, in the movable contact 430 shown in FIG. 12, downward pressing with the drive shaft 380 causes the other end of the plate member 434A to come into contact with the side surface 421bA of the first fixed terminal 420A and the other end of the plate member 434B to come into contact with the side surface 421bB of the second fixed terminal 420B.

Note that, in the configuration shown in FIG. 12, the plate members 434A and 434B are directly pressed by the approximately cylindrical drive shaft 380, thereby causing the first contact piece 432A on the first contact unit side and the first contact piece 432B on the second contact unit side to be relatively rotated in a direction in which the other ends thereof are separated from each other (opening direction). The shape of the drive shaft 380 is not limited to the approximately cylindrical shape, but may be, for example, an approximately spherical shape or a tapered shape that becomes narrower upward.

On the other hand, when the drive shaft 380 is moved upward (to the other side) in the up-down direction (one direction), the elastic restoring force of the leaf spring 439 causes the first contact piece 432A on the first contact unit side and the first contact piece 432B on the second contact unit side to relatively rotate in a direction in which the other ends thereof approach each other (closing direction). Thus, the other end of the plate member 434A is separated from the side surface 421bA of the first fixed terminal 420A, and the other end of the plate member 434B is separated from the side surface 421bB of the second fixed terminal 420B.

The first contact piece 432A on the first contact unit side and the first contact piece 432B on the second contact unit side shown in FIG. 12 also include rigid plate members 434A and 434B, respectively. Therefore, the first contact piece 432A on the first contact unit side and the first contact piece 432B on the second contact unit side also come into contact with the side surfaces 421bA and 421bB in a stretched state.

Thus, in the configuration shown in FIG. 12, again, the first contact unit 431A includes the first contact piece 432A on the first contact unit side that comes into contact with the side surface (first surface) 421bA of the first fixed terminal 420A in a stretched manner in a state of being pressed upward (to one side) in the up-down direction (one direction) by the drive shaft 380.

The first contact piece 432A on the first contact unit side includes a rigid plate member 434A.

Furthermore, the second contact unit 431B includes the first contact piece 432B on the second contact unit side that comes into contact with the side surface (first surface) 421bB of the second fixed terminal 420B in a stretched manner in a state of being pressed upward (to one side) in the up-down direction (one direction) by the shaft 380.

The first contact piece 432B on the second contact unit side has a rigid plate member 434B.

Thus, the same advantageous effects as in the above embodiment can also be achieved with the contact device 10 having the configuration shown in FIG. 12.

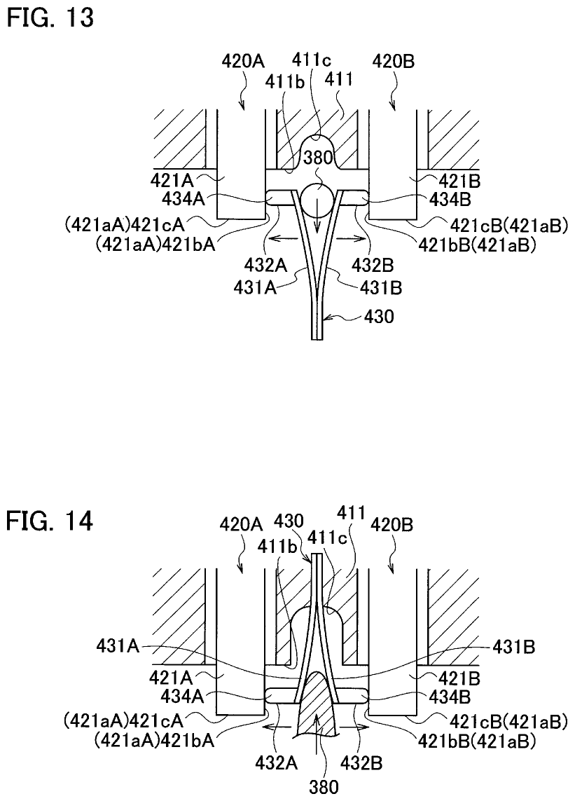

The contact device 10 may also have a configuration shown in FIG. 13.

A movable contact 430 shown in FIG. 13 is formed using two conductive leaf springs, and the upper end thereof can be closed or opened in the left-right direction in a state where the lower ends are in contact with each other. The movable contact 430 is arranged in the base 410 by fixing the lower end portions in contact with each other to the base 410 or the like, for example.

One of the leaf springs serves as a first contact unit 431A that comes into contact with the first fixed terminal 420A, while the other leaf spring serves as a second contact unit 431B that is electrically connected to the first contact unit 431A and comes into contact with the second fixed terminal 420B.

In the movable contact 430 shown in FIG. 13, the first contact unit 431A has its tip bent toward the side surface 421bA of the first fixed terminal 420A, and this tip has rigidity and serves as the first contact piece 432A on the first contact unit side that comes into contact with the side surface (first surface) 421bA of the first fixed terminal 420A in a stretched state.

Likewise, the second contact unit 431B has its tip bent toward the side surface 421bB of the second fixed terminal 420B, and this tip has rigidity and serves as the first contact piece 432B on the second contact unit side that comes into contact with the side surface (first surface) 421bB of the second fixed terminal 420B in a stretched state.

As described above, in the movable contact 430 shown in FIG. 13, the first contact unit 431A includes the first contact piece 432A on the first contact unit side, and the second contact unit 431B includes the first contact piece 432B on the second contact unit side.

In the configuration shown in FIG. 13, again, the first contact piece 432A on the first contact unit side and the first contact piece 432B on the second contact unit side are formed using rigid plate members 434A and 434B, respectively.

When the drive shaft 380 is moved downward (to one side) in the up-down direction (one direction), the first contact piece 432A on the first contact unit side and the first contact piece 432B on the second contact unit side are relatively moved in a direction away from each other (opening direction of the first contact unit 431A and the second contact unit 431B).

That is, in the movable contact 430 shown in FIG. 13, downward pressing with the drive shaft 380 causes the tip of the plate member 434A to come into contact with the side surface 421bA of the first fixed terminal 420A and the tip of the plate member 434B to come into contact with the side surface 421bB of the second fixed terminal 420B.

In the configuration shown in FIG. 13, the first contact unit 431A and the second contact unit 431B are pressed by the approximately cylindrical drive shaft 380, so that the first contact piece 432A on the first contact unit side and the first contact piece 432B on the second contact unit side are relatively moved in a direction away from each other (opening direction of the first contact unit 431A and the second contact unit 431B). The shape of the drive shaft 380 is not limited to the approximately cylindrical shape, but may be, for example, an approximately spherical shape or a tapered shape that becomes narrower upward.

On the other hand, when the drive shaft 380 is moved upward (to the other side) in the up-down direction (one direction), the elastic restoring force of the leaf springs (first and second contact units 431A and 431B) causes the first contact piece 432A on the first contact unit side and the first contact piece 432B on the second contact unit side to be relatively moved in a direction of approaching each other (closing direction of the first contact unit 431A and the second contact unit 431B). Thus, the tip of the plate member 434A is separated from the side surface 421bA of the first fixed terminal 420A, and the tip of the plate member 434B is separated from the side surface 421bB of the second fixed terminal 420B. In the configuration shown in FIG. 13, a space 411c that allows upward movement of the drive shaft 380 is formed in the top wall 411 of the base 410.

The first contact piece 432A on the first contact unit side and the first contact piece 432B on the second contact unit side shown in FIG. 13 also have rigid plate members 434A and 434B, respectively. Therefore, the first contact piece 432A on the first contact unit side and the first contact piece 432B on the second contact unit side also come into contact with the side surfaces 421bA and 421bB in a stretched state.

Thus, in the configuration shown in FIG. 13, the first contact unit 431A includes the first contact piece 432A on the first contact unit side that comes into contact with the side surface (first surface) 421bA of the first fixed terminal 420A in a stretched manner in a state of being pressed upward (to one side) in the up-down direction (one direction) by the drive shaft 380.

The first contact piece 432A on the first contact unit side includes a rigid plate member 434A.

Furthermore, the second contact unit 431B includes the first contact piece 432B on the second contact unit side that comes into contact with the side surface (first surface) 421bB of the second fixed terminal 420B in a stretched manner in a state of being pressed upward (to one side) in the up-down direction (one direction) by the shaft 380.

The first contact piece 432B on the second contact unit side has a rigid plate member 434B.

Thus, the same advantageous effects as in the above embodiment can also be achieved with the contact device 10 having the configuration shown in FIG. 13.

The contact device 10 may also have a configuration shown in FIG. 14.

A movable contact 430 shown in FIG. 14 is formed using two conductive leaf springs, and the upper end thereof can be closed or opened in the left-right direction in a state where the lower ends are in contact with each other. The movable contact 430 is arranged in the base 410 by fixing the upper end portions in contact with each other to the top wall 411 of base 410.

One of the leaf springs serves as a first contact unit 431A that comes into contact with the first fixed terminal 420A, while the other leaf spring serves as a second contact unit 431B that is electrically connected to the first contact unit 431A and comes into contact with the second fixed terminal 420B.

In the movable contact 430 shown in FIG. 14, the first contact unit 431A has its tip bent toward the side surface 421bA of the first fixed terminal 420A, and this tip has rigidity and serves as the first contact piece 432A on the first contact unit side that comes into contact with the side surface (first surface) 421bA of the first fixed terminal 420A in a stretched state.

Likewise, the second contact unit 431B has its tip bent toward the side surface 421bB of the second fixed terminal 420B, and this tip has rigidity and serves as the first contact piece 432B on the second contact unit side that comes into contact with the side surface (first surface) 421bB of the second fixed terminal 420B in a stretched state.

As described above, in the movable contact 430 shown in FIG. 14, the first contact unit 431A includes the first contact piece 432A on the first contact unit side, and the second contact unit 431B includes the first contact piece 432B on the second contact unit side.

In the configuration shown in FIG. 14, again, the first contact piece 432A on the first contact unit side and the first contact piece 432B on the second contact unit side are formed using rigid plate members 434A and 434B, respectively.

When the drive shaft 380 is moved upward (to one side) in the up-down direction (one direction), the first contact piece 432A on the first contact unit side and the first contact piece 432B on the second contact unit side are relatively moved in a direction away from each other (opening direction of the first contact unit 431A and the second contact unit 431B).

That is, in the movable contact 430 shown in FIG. 14, upward pressing with the shaft 380 causes the tip of the plate member 434A to come into contact with the side surface 421bA of the first fixed terminal 420A and the tip of the plate member 434B to come into contact with the side surface 421bB of the second fixed terminal 420B.

In the configuration shown in FIG. 14, the first contact unit 431A and the second contact unit 431B are pressed by the tip of the shaft 380 that becomes narrower upward, so that the first contact piece 432A on the first contact unit side and the first contact piece 432B on the second contact unit side are relatively moved in a direction away from each other (opening direction of the first contact unit 431A and the second contact unit 431B). The shape of the tip of the shaft 380 may be an approximately cylindrical shape or an approximately spherical shape.

On the other hand, when the drive shaft 380 is moved downward (to the other side) in the up-down direction (one direction), the elastic restoring force of the leaf springs (first and second contact units 431A and 431B) causes the first contact piece 432A on the first contact unit side and the first contact piece 432B on the second contact unit side to be relatively moved in a direction of approaching each other (closing direction of the first contact unit 431A and the second contact unit 431B). Thus, the tip of the plate member 434A is separated from the side surface 421bA of the first fixed terminal 420A, and the tip of the plate member 434B is separated from the side surface 421bB of the second fixed terminal 420B. In the configuration shown in FIG. 14, a space 411c that allows rotation of the first and second contact units 431A and 431B is formed in the top wall 411 of the base 410.

The first contact piece 432A on the first contact unit side and the first contact piece 432B on the second contact unit side shown in FIG. 14 also include rigid plate members 434A and 434B, respectively. Therefore, the first contact piece 432A on the first contact unit side and the first contact piece 432B on the second contact unit side also come into contact with the side surfaces 421bA and 421bB in a stretched state.

Thus, in the configuration shown in FIG. 14, the first contact unit 431A includes the first contact piece 432A on the first contact unit side that comes into contact with the side surface (first surface) 421bA of the first fixed terminal 420A in a stretched manner in a state of being pressed upward (to one side) in the up-down direction (one direction) by the shaft 380.

The first contact piece 432A on the first contact unit side includes a rigid plate member 434A.

Furthermore, the second contact unit 431B includes the first contact piece 432B on the second contact unit side that comes into contact with the side surface (first surface) 421bB of the second fixed terminal 420B in a stretched manner in a state of being pressed upward (to one side) in the up-down direction (one direction) by the shaft 380.

The first contact piece 432B on the second contact unit side includes a rigid plate member 434B.

Thus, the same advantageous effects as in the above embodiment can also be achieved with the contact device 10 having the configuration shown in FIG. 14.

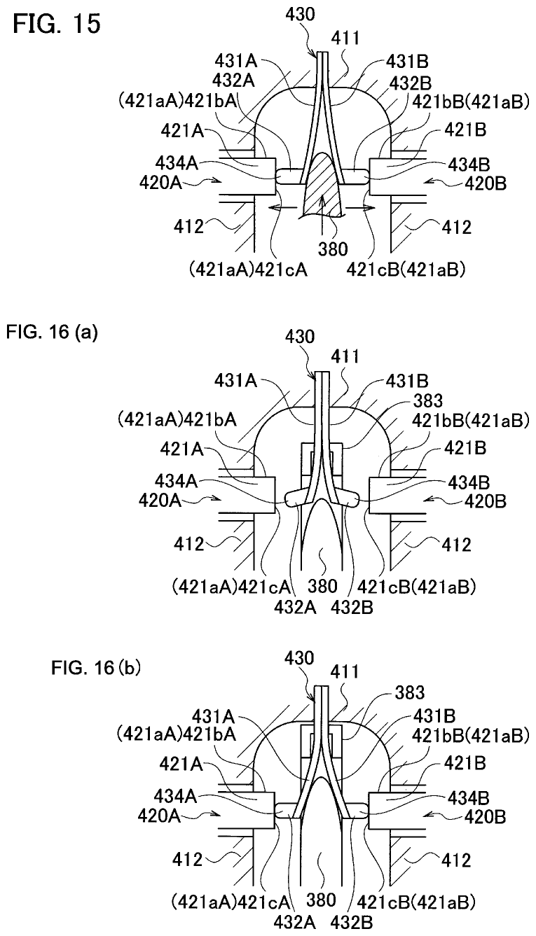

Note that, as shown in FIG. 15, the first fixed terminal 420A and the second fixed terminal 420B may be fixed to the base 410 (peripheral wall 412) in a state where the longitudinal direction is approximately aligned with the left-right direction (horizontal direction).

When the shaft 380 is moved upward (to one side) in the up-down direction (one direction), the first contact piece 432A on the first contact unit side of the movable contact 430 may be brought into contact with a tip surface 421cA of the first fixed terminal 420A in a stretched manner in a state of being pressed upward (to one side) in the up-down direction (one direction) by the shaft 380. At the same time, the first contact piece 432B on the second contact unit side may be brought into contact with a tip surface 421cB of the second fixed terminal 420B in a stretched manner in a state of being pressed upward (to one side) in the up-down direction (one direction) by the shaft 380.

As described above, in the configuration illustrated in FIG. 15, the tip surface 421cA of the first fixed terminal 420A corresponds to the first surface (first surface of the first fixed terminal 420A) with which the first contact unit 431A comes into contact from the direction intersecting with the up-down direction (one direction). Therefore, when the conductive part 430a of the movable contact 430 comes into contact with the tip surface 421cA of the first fixed terminal 420A, electromagnetic repulsion force is generated in a direction different from the downward direction (the other side in one direction). The tip surface 421cA (first surface of the first fixed terminal 420A) is an intersecting surface that intersects with a plane (horizontally extending plane) perpendicular to the up-down direction (one direction).

Furthermore, the tip surface 421cB of the second fixed terminal 420B corresponds to the first surface (first surface of the second fixed terminal 420B) with which the second contact unit 431B comes into contact from the direction intersecting with the up-down direction (one direction). Therefore, when the conductive part 430a of the movable contact 430 comes into contact with the tip surface 421cB of the second fixed terminal 420B, electromagnetic repulsion force is generated in a direction different from the downward direction (the other side in one direction). The tip surface 421cB (first surface of the second fixed terminal 420B) is an intersecting surface that intersects with a plane (horizontally extending plane) perpendicular to the up-down direction (one direction).

Thus, the same advantageous effects as those achieved with the configuration shown in FIG. 14 can also be achieved with the contact device 10 having the configuration shown in FIG. 15.

Furthermore, as shown in FIG. 16, the shaft 380 may be provided with an opening/closing assisting member 383 for assisting opening/closing of the first contact unit 431A and the second contact unit 431B.

In FIG. 16, the opening/closing assisting member 383 is provided integrally with the shaft 380 in a state of protruding above the tip of the shaft 380, and the tip of the first contact unit 431A (the first contact piece 432A on the first contact unit side) and the tip of the second contact unit 431B (the first contact piece 432B on the second contact unit side) are arranged between the opening/closing assisting member 383 and the tip of the shaft 380. The first contact unit 431A and the second contact unit 431B are closed so as to come into contact with each other by the opening/closing assisting member 383 at the portion where the opening/closing assisting member 383 is located, and the tips thereof can be opened in a direction away from each other below the portion where the opening/closing assisting member 383 is located.

With this configuration, when the shaft 380 is moved upward (to one direction) in the up-down direction (one direction), the opening/closing assisting member 383 is also moved upward in conjunction with the upward movement of the shaft 380. When the opening/closing assisting member 383 is moved upward as described above, the closed portion of the first and second contact units 431A and 431B is reduced. That is, the first contact piece 432A on the first contact unit side and the first contact piece 432B on the second contact unit side can be further relatively moved in a direction away from each other (opening direction of the first and second contact units 431A and 431B).

Therefore, when the shaft 380 is moved upward (to one side) in the up-down direction (one direction), the first contact unit 431A and the second contact unit 431B are spread by the tip of the shaft 380, and the tip of the first contact piece 432A on the first contact unit side comes into contact with the tip surface 421cA of the first fixed terminal 420A, and the tip of the first contact piece 432B on the second contact unit side comes into contact with the tip surface 421cB of the second fixed terminal 420B.

On the other hand, when the shaft 380 is moved downward (to the other direction) in the up-down direction (one direction), the opening/closing assisting member 383 is also moved downward in conjunction with the downward movement of the shaft 380. When the opening/closing assisting member 383 is moved downward as described above, the closed portion of the first and second contact units 431A and 431B is increased. That is, the opening/closing assisting member 383 prevents the first contact piece 432A on the first contact unit side and the first contact piece 432B on the second contact unit side from being relatively moved in a direction away from each other (opening direction of the first and second contact units 431A and 431B).

Therefore, when the shaft 380 is moved downward (to the other side) in the up-down direction (one direction), the first contact unit 431A and the second contact unit 431B are closed by the opening/closing assisting member 383, and the tip of the first contact piece 432A on the first contact unit side is separated from the tip surface 421cA of the first fixed terminal 420A, and the tip of the first contact piece 432B on the second contact unit side is separated from the tip surface 421cB of the second fixed terminal 420B.

Thus, the same advantageous effects as those achieved with the configuration shown in FIG. 15 can also be achieved with the contact device 10 having the configuration shown in FIG. 16.

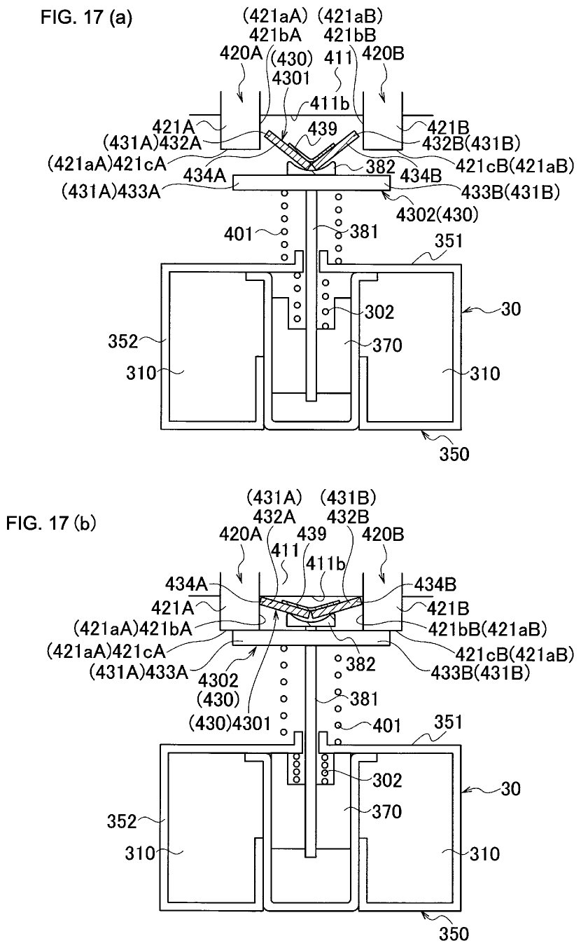

The contact device 10 may also have a configuration shown in FIG. 17.

In FIG. 17, a drive block 30 is configured without using a fixed iron core. That is, a yoke upper plate 351 is used as a fixed-side member instead of the fixed iron core, and the movable iron core 370 is attracted to the yoke upper plate 351. A range (movable range) within which the movable iron core 370 can move is set between an initial position spaced apart from and below the yoke upper plate 351 and a contact position where contact is made with the yoke upper plate 351. Between the yoke upper plate 351 and the movable iron core 370, a return spring 302 is disposed, which uses its elasticity to bias the movable iron core 370 in a direction of returning the movable iron core 370 to the initial position (direction in which the movable iron core 370 moves away from the yoke upper plate 351).

The movable contact 430 shown in FIG. 17 includes a first movable contact main body 4301 and a second movable contact main body 4302 provided separately from the first movable contact main body 4301.

In FIG. 17, the first movable contact main body 4301 is configured using an approximately V-shaped member (member corresponding to the entire movable contact described in the above embodiment) which is formed by connecting rigid approximately rectangular parallelepiped plate members 434A and 434B elongated in the left-right direction with a leaf spring (connecting member) 439. The plate members 434A and 434B, which are members constituting the first movable contact main body 4301, are both formed using a conductive material, and the leaf spring 439 is formed using a conductive material or an insulating material.

On the other hand, the second movable contact main body 4302 is configured using an approximately plate-shaped rigid member that extends in an approximately horizontal direction. The approximately plate-shaped member constituting the second movable contact main body 4302 is also formed using a conductive material.

In FIG. 17, the second movable contact main body 4302 is arranged below the first fixed terminal 420A and the second fixed terminal 420B. In this event, the upper surface of the second movable contact main body 4302 faces the bottom surface 421cA of the first fixed terminal 420A and the bottom surface 421cB of the second fixed terminal 420B.

In FIG. 17, the first movable contact main body 4301 is placed on the upper surface of the head 382 of the shaft 380. On the other hand, the second movable contact main body 4302 is attached to the shaft 380 so as to be relatively movable by inserting the shaft 380 into an insertion hole formed in the center thereof. Thus, in FIG. 17, the second movable contact main body 4302 is attached to the shaft 380 so as to be movable relative to the first movable contact main body 4301. Further, in the configuration shown in FIG. 17, the second movable contact main body 4302 is pressed upward by a contact pressure spring 401.

When the shaft 380 is moved upward (to one side) in the up-down direction (one direction), the other end of the plate member 434A comes into contact with the side surface 421bA of the first fixed terminal 420A, and the other end of the plate member 434B comes into contact with the side surface 421bB of the second fixed terminal 420B. Furthermore, the upper surface on one side of the second movable contact main body 4302 comes into contact with the bottom surface 421cA of the first fixed terminal 420A, and the upper surface on the other side comes into contact with the bottom surface 421cB of the second fixed terminal 420B.

On the other hand, when the shaft 380 is moved downward (to the other side) in the up-down direction (one direction), the other end of the plate member 434A is separated from the side surface 421bA of the first fixed terminal 420A, and the other end of the plate member 434B is separated from the side surface 421bB of the second fixed terminal 420B. Furthermore, the upper surface on one side of the second movable contact main body 4302 is separated from the bottom surface 421cA of the first fixed terminal 420A, and the upper surface on the other side is separated from the bottom surface 421cB of the second fixed terminal 420B.

As described above, in the configuration shown in FIG. 17, the side surface (first surface) 421bA of the first fixed terminal 420A is an intersecting surface that intersects with a plane perpendicular to the up-down direction (one direction). The bottom surface 421cA of the first fixed terminal 420A is a second surface that intersects with the side surface (first surface) 421bA of the first fixed terminal 420A.

Likewise, the side surface (first surface) 421bB of the second fixed terminal 420B is an intersecting surface that intersects with a plane perpendicular to the up-down direction (one direction). The bottom surface 421cB of the second fixed terminal 420B is a second surface that intersects with the side surface (first surface) 421bB of the second fixed terminal 420B.

In the configuration shown in FIG. 17, one side of the plate member 434A and the second movable contact main body 4302 serves as the first contact unit 431A that comes into contact with the first fixed terminal 420A when the shaft 380 is moved upward (to one side) in the up-down direction (one direction). Meanwhile, the other side of the plate member 434B and the second movable contact main body 4302 serves as the second contact unit 431B that is electrically connected to the first contact unit 431A and comes into contact with the second fixed terminal 420B.

The first contact unit 431A includes a first contact piece 432A on the first contact unit side that comes into contact with the side surface (first surface) 421bA of the first fixed terminal 420A in a stretched manner in a state of being pressed upward (to one side) in the up-down direction (one direction) by the shaft 380. The first contact unit 431A further includes a second contact piece on the first contact unit side (one side of the second movable contact main body 4302) 433A that comes into contact with the bottom surface (second surface) 421cA intersecting with the side surface (first surface) 421bA of the first fixed terminal 420A.

On the other hand, the second contact unit 431B includes a first contact piece 432B on the second contact unit side that comes into contact with the side surface (first surface) 421bB of the second fixed terminal 420B in a stretched manner in a state of being pressed upward (to one side) in the up-down direction (one direction) by the shaft 380. The second contact unit 431B further includes a second contact piece on the second contact unit side (the other side of the second movable contact main body 4302) 433B that comes into contact with the bottom surface (second surface) 421cB intersecting with the side surface (first surface) 421bB of the second fixed terminal 420B.

In FIG. 17, again, the first contact piece 432A on the first contact unit side includes a rigid plate member 434A, and the first contact piece 432B on the second contact unit side includes a rigid plate member 434B.

Thus, the same advantageous effects as in the above embodiment can also be achieved with the contact device 10 having the configuration shown in FIG. 17.

In the configuration shown in FIG. 17, the first contact unit 431A includes the second contact piece (one side of the second movable contact main body 4302) 433A on the first contact unit side that comes into contact with the bottom surface (second surface) 421cA intersecting with the side surface (first surface) 421bA of the first fixed terminal 420A.

Accordingly, since the movable contact 430 can be brought into contact with the two spots on the outer surface 421aA of the first fixed terminal 420A, the current flowing from the first fixed terminal 420A to the movable contact 430 can be divided. As a result, the magnitude of the electromagnetic repulsion force generated in each of the contact pieces (the first contact piece 432A on the first contact unit side and the second contact piece 433A on the first contact unit side) can be reduced. Moreover, the magnitude of the electromagnetic repulsion force generated in the movable contact 430 can also be reduced.

Therefore, the contact pieces (the first contact piece 432A on the first contact unit side and the second contact piece 433A on the first contact unit side) of the movable contact 430 can be prevented from being separated from the first fixed terminal 420A. Furthermore, even when any one of the contact pieces is separated from the first fixed terminal 420A, the conductive state between the first and second fixed terminals 420A and 420B can be maintained as long as the other contact piece is in contact with the first fixed terminal 420A. With the configuration shown in FIG. 17, the conductive state between the first and second fixed terminals 420A and 420B can be maintained more reliably.

In the configuration shown in FIG. 17, the first contact piece 432A on the first contact unit side and the second contact piece 433A on the first contact unit side are formed as separate components.

Thus, the electromagnetic repulsion force generated by one of the contact pieces can be suppressed from affecting the other contact piece. Therefore, the conductive state between the first and second fixed terminals 420A and 420B can be maintained more reliably.

In the configuration shown in FIG. 17, the second contact unit 431B includes the second contact piece (the other side of the second movable contact main body 4302) 433B on the second contact unit side that comes into contact with the bottom surface (second surface) 421cB intersecting with the side surface (first surface) 421bB of the second fixed terminal 420B.

The first contact piece 432B on the second contact unit side and the second contact piece 433B on the second contact unit side are formed as separate components.

Thus, the same advantageous effects achieved on the first fixed terminal 420A side can also be achieved on the second fixed terminal 420B side.

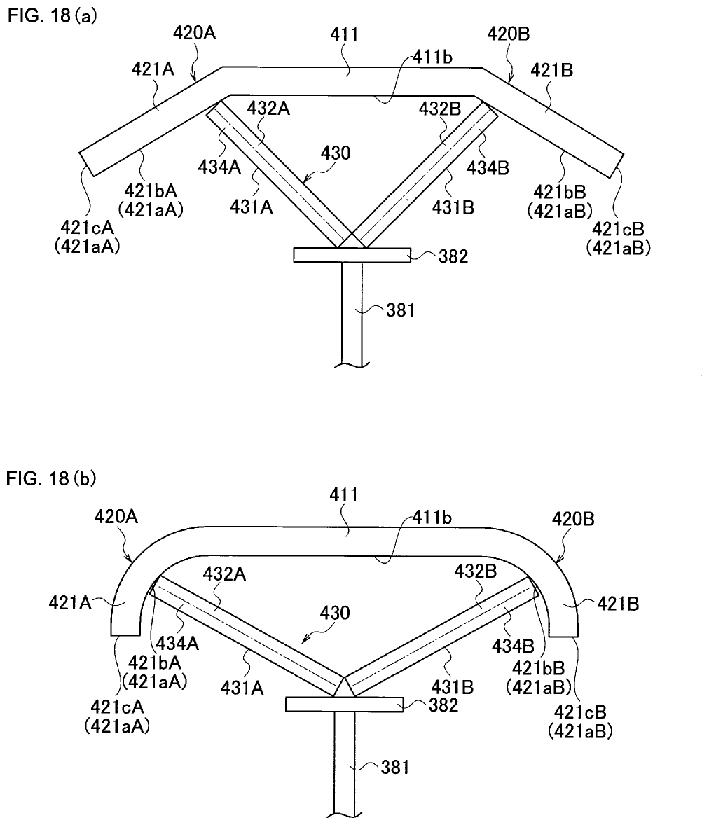

The contact device 10 may also have a configuration shown in FIG. 18.

In a contact device 10 shown in FIG. 18(a), a first fixed terminal 420A is fixed to a top wall 411 in a state where the longitudinal direction intersects with the up-down direction. A second fixed terminal 420B is also fixed to the top wall 411 in a state where the longitudinal direction intersects with the up-down direction.

That is, in the contact device 10 shown in FIG. 18(a), the first and second fixed terminals 420A and 420B are fixed in an inclined state to the top wall 411.

In the contact device 10 shown in FIG. 18(a), the first and second fixed terminals 420A and 420B are fixed to the top wall 411 such that the distance therebetween is increased toward the lower side.

The first contact piece 432A on the first contact unit side of the movable contact 430 comes into contact, in a stretched state, with the side surface (first surface) 421bA of the first fixed terminal 420A fixed in the inclined state in a state of being pressed upward (to one side) in the up-down direction (one direction) by the shaft 380.

Likewise, the first contact piece 432B on the second contact unit side of the movable contact 430 comes into contact, in a stretched state, with the side surface (first surface) 421bB of the second fixed terminal 420B fixed in the inclined state in a state of being pressed upward (to one side) in the up-down direction (one direction) by the shaft 380.

Thus, the same advantageous effects as in the above embodiment can also be achieved with the contact device 10 having the configuration shown in FIG. 18(a).

With the contact device 10 having the configuration shown in FIG. 18(a), the shortest distance between the side surface 421bA of the first fixed terminal 420A and the side surface 421bB of the second fixed terminal 420B is increased toward the lower side.

Therefore, when the shaft 380 is moved downward (to the other side) in the up-down direction (one direction), the movable contact 430 can be separated from the fixed terminals 420A and 420B at a relatively early stage.

In the contact device 10 shown in FIG. 18(b), the first fixed terminal 420A having a curved shape is fixed to the top wall 411, and the second fixed terminal 420B having a curved shape is fixed to the top wall 411.

In this event, the first and second fixed terminals 420A and 420B are fixed to the top wall 411 such that the concave surfaces that are the surfaces forming the side surfaces 421bA and 421bB face each other. In other words, the first and second fixed terminals 420A and 420B are fixed to the top wall 411 so as to be convex upward and outward in the left-right direction. The concave surfaces of the fixed terminals 420A and 420B are configured such that the inclination becomes steeper (approach the vertical direction) from the upper side to the lower side.

The first contact piece 432A on the first contact unit side of the movable contact 430 is brought into contact with the concave surface (side surface (first surface) 421bA) of the first fixed terminal 420A in a stretched manner in a state of being pressed upward (to one side) in the up-down direction (one direction) by the shaft 380.

At the same time, the first contact piece 432B on the second contact unit side of the movable contact 430 is brought into contact with the concave surface (side surface (first surface) 421bB) of the second fixed terminal 420B in a stretched manner in a state of being pressed upward (to one side) in the up-down direction (one direction) by the shaft 380.

Thus, the same advantageous effects as those achieved with the configuration shown in FIG. 18(a) can also be achieved with the contact device 10 having the configuration shown in FIG. 18(b).

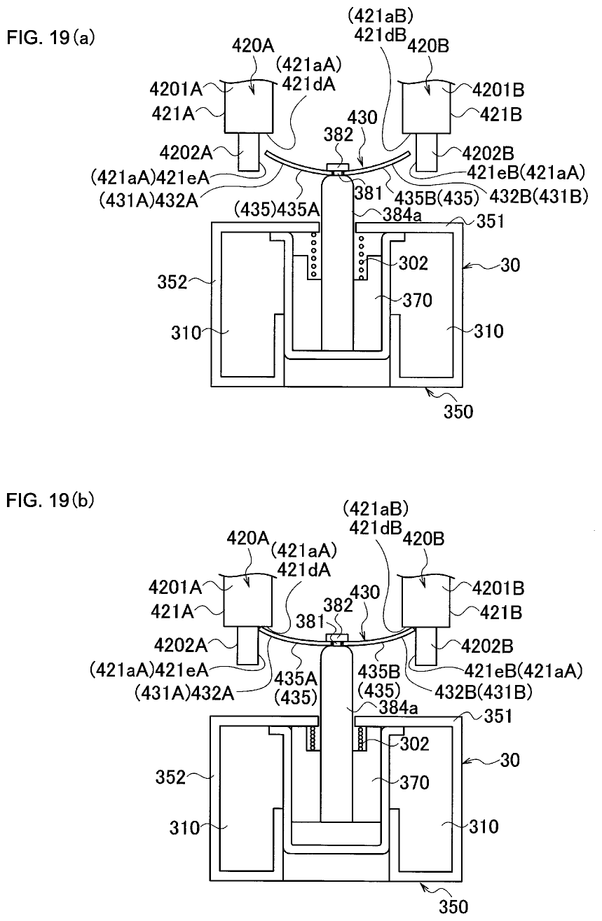

The contact device 10 may also have a configuration shown in FIG. 19.

In the contact device 10 shown in FIG. 19, as in the case of FIG. 17, a drive block 30 is configured without using a fixed iron core. That is, a yoke upper plate 351 is used as a fixed-side member instead of the fixed iron core, and the movable iron core 370 is attracted to the yoke upper plate 351. A range (movable range) within which the movable iron core 370 can move is set between an initial position spaced apart from and below the yoke upper plate 351 and a contact position where contact is made with the yoke upper plate 351. Between the yoke upper plate 351 and the movable iron core 370, a return spring 302 is disposed, which uses its elasticity to bias the movable iron core 370 in a direction of returning the movable iron core 370 to the initial position (direction in which the movable iron core 370 moves away from the yoke upper plate 351).

The movable contact 430 shown in FIG. 19 also includes a first contact piece 432A on the first contact unit side and a first contact piece 432B on the second contact unit side.

Here, the first contact piece 432A on the first contact unit side includes a first leaf spring 435A that is set in a flexed state when the movable contact 430 is separated from the first fixed terminal 420A, and is set in a stretched state when the movable contact 430 comes into contact with the first fixed terminal 420A.

Likewise, the first contact piece 432B on the second contact unit side includes a second leaf spring 435B that is set in a flexed state when the first and second fixed terminals 420A and 420B are in a non-conductive state, and is set in a stretched state when the first and second fixed terminals 420A and 420B are in a conductive state.

Furthermore, in FIG. 19, the first and second leaf springs 435A and 435B are integrally formed. That is, the movable contact 430 includes one leaf spring 435 having one side serve as the first leaf spring 435A and the other side serve as the second leaf spring 435B. The leaf spring 435 is conductive and is attached to the shaft 380 in a state of being bent downward.

To be more specific, the shaft 380 is inserted into an insertion hole formed at the center of the leaf spring 435, and thus the leaf spring 435 is attached to the shaft 380. The shaft 380 shown in FIG. 19 is also provided with a support member 384a attached around the shaft main body 381 to support the leaf spring 435 from below.

Therefore, the leaf spring 435 is attached to the shaft 380 while being sandwiched between the head 382 and the support member 384a by attaching the support member 384a around the shaft main body 381 of the shaft 380 after inserting the shaft main body 381 into the insertion hole formed at the center.

In the configuration shown in FIG. 19, the first and second fixed terminals 420A and 420B are formed in a stepped shape having a large diameter on the upper side and a small diameter on the lower side.

That is, each of the fixed terminals 420A and 420B is provided with large-diameter portions 4201A and 4201B located on the upper side and small-diameter portions 4202A and 4202B concentrically provided below the large-diameter portions 4201A and 4201B.

When the coil 330 is not energized, the leaf spring 435 has its tip on one side facing a lower surface 421dA of the large-diameter portion 4201A of the first fixed terminal 420A in a separated state from the first fixed terminal 420A, and has its tip on the other side facing a lower surface 421dB of the large-diameter portion 4201B of the second fixed terminal 420B in a separated state from the second fixed terminal 420B.

Therefore, when the shaft 380 is moved upward (to one side) in the up-down direction (one direction), the leaf spring 435 is first moved upward, and the tip on one side comes into contact with the lower surface 421dA of the large-diameter portion 4201A of the first fixed terminal 420A, and the tip on the other side comes into contact with the lower surface 421dB of the large-diameter portion 4201B of the second fixed terminal 420B.

Furthermore, in the configuration shown in FIG. 19, the leaf spring 435 is further pressed upward by the shaft 380 in a state where the tip on one side comes into contact with the lower surface 421dA of the large-diameter portion 4201A of the first fixed terminal 420A and the tip on the other side comes into contact with the lower surface 421dB of the large-diameter portion 4201B of the second fixed terminal 420B.

Therefore, the leaf spring 435 is elastically deformed by being pressed upward in a state where the both tips thereof are brought into contact with the lower surfaces 421dA and 421dB of the fixed terminals 420A and 420B. The tip on one side comes into contact with a side surface 421eA of the small-diameter portion 4202A of the first fixed terminal 420A while sliding on the lower surface 421dA, and the tip on the other side comes into contact with a side surface 421eB of the small-diameter portion 4202B of the second fixed terminal 420B while sliding on the lower surface 421dB. Note that the side surface 421eA of the small-diameter portion 4202A of the first fixed terminal 420A corresponds to the first surface of the first fixed terminal 420A, while the side surface 421eB of the small-diameter portion 4202B of the second fixed terminal 420B corresponds to the first surface of the second fixed terminal 420B.

Furthermore, in the configuration shown in FIG. 19, the leaf spring 435 is further pressed upward by the shaft 380 even in a state where the tip on one side comes into contact with the side surface 421eA of the small-diameter portion 4202A of the first fixed terminal 420A and the tip on the other side comes into contact with the side surface 421eB of the small-diameter portion 4202B of the second fixed terminal 420B.

In this event, one side of the leaf spring 435 is supported in a stretched state between the shaft 380 and the side surface (first surface) 421eA of the first fixed terminal 420A in a state where the tip of the leaf spring 435 on one side comes into contact with the side surface 421eA of the small-diameter portion 4202A of the first fixed terminal 420A. Meanwhile, the other side of the leaf spring 435 is supported in a stretched state between the shaft 380 and the side surface (first surface) 421eB of the second fixed terminal 420B in a state where the tip of the leaf spring 435 on the other side comes into contact with the side surface 421eB of the small-diameter portion 4202B of the second fixed terminal 420B.

As described above, in the configuration illustrated in FIG. 19, one side of the leaf spring 435 serves as a first contact piece 432A on the first contact unit side that comes into contact with the side surface (first surface) 421eA of the first fixed terminal 420A in a stretched state. Likewise, the other side of the leaf spring 435 serves as a first contact piece 432B on the second contact unit side that comes into contact with the side surface (first surface) 421eB of the second fixed terminal 420B in a stretched state.

That is, the movable contact 430 shown in FIG. 19 includes the leaf spring 435 that is set in a flexed state when the coil 330 is not energized (in a non-conductive state), and has one end serve as the first contact piece 432A on the first contact unit side and the other end serve as the first contact piece 432B on the second contact unit side when the coil 330 is energized (in a conductive state).

Thus, the same advantageous effects as in the above embodiment can also be achieved with the contact device 10 having the configuration shown in FIG. 19.

In the configuration shown in FIG. 19, the movable contact 430 includes the leaf spring 435 that is set in a flexed state when the coil 330 is not energized (in a non-conductive state), and has one end serve as the first contact piece 432A on the first contact unit side and the other end serve as the first contact piece 432B on the second contact unit side when the coil 330 is energized (in a conductive state).

Thus, the configuration can be simplified.

Note that, in the configuration shown in FIG. 19, the description is given of an example where the first contact piece 432A on the first contact unit side and the first contact piece 432B on the second contact unit side are formed in one leaf spring 435. However, only one of the first contact piece 432A on the first contact unit side and the first contact piece 432B on the second contact unit side may be formed using a leaf spring.

That is, the first contact piece 432A on the first contact unit side may include a first leaf spring 435A that is set in a flexed state when the coil 330 is not energized (in a non-conductive state), and is set in a stretched state when the coil 330 is energized (in a conductive state).

Likewise, the first contact piece 432B on the second contact unit side may include a second leaf spring 435B that is set in a flexed state when the coil 330 is not energized (in a non-conductive state), and is set in a stretched state when the coil 330 is energized (in a conductive state).

Alternatively, the first contact piece 432A on the first contact unit side is formed of one first leaf spring 435A, and the first contact piece 432B on the second contact unit side may be formed of a second leaf spring 435B that is a separate component from the first leaf spring 435A constituting the first contact piece 432A on the first contact unit side.

Thus, the same advantageous effects as those achieved with the configuration shown in FIG. 19 can also be achieved.

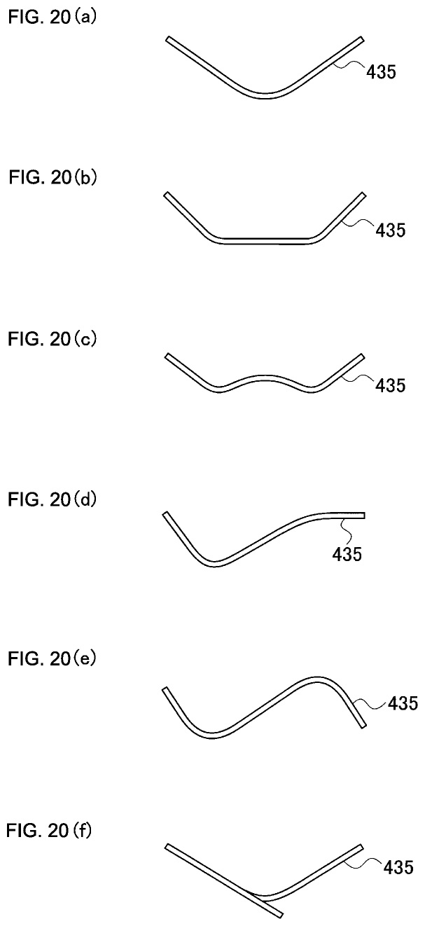

Alternatively, the leaf spring 435 may also have shapes shown in FIGS. 20(a) to 20(f).

A leaf spring 435 shown in FIG. 20(a) is formed by bending a single conductive leaf spring into a V-shape that is convex downward.

A leaf spring 435 shown in FIG. 20(b) is formed by bending a single conductive leaf spring upward at both ends.

A leaf spring 435 shown in FIG. 20(c) is formed by bending a single conductive leaf spring upward at both ends and bending the leaf spring to be convex upward in its center.

A leaf spring 435 shown in FIG. 20(d) is formed by bending a single conductive leaf spring so as to form a V-shape biased to one side and bending the end on the other side downward so as to be approximately horizontal.

A leaf spring 435 shown in FIG. 20(e) is formed by bending a single conductive leaf spring into a V-shape biased to one side and bending the end on the other side so as to have its tip face downward.

A leaf spring 435 shown in FIG. 20(f) is formed by cutting and raising a part of a single conductive leaf spring to form a V-shape.

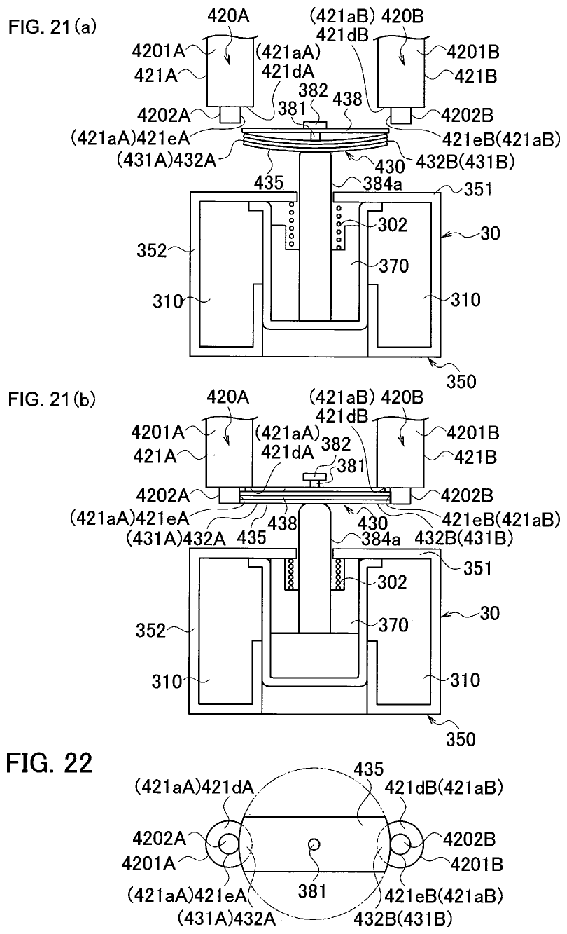

The contact device 10 may also have a configuration shown in FIGS. 21 and 22.

In a contact device 10 shown in FIGS. 21 and 22, as in the case of FIG. 17, a drive block 30 is configured without using a fixed iron core. That is, a yoke upper plate 351 is used as a fixed-side member instead of the fixed iron core, and the movable iron core 370 is attracted to the yoke upper plate 351. A range (movable range) within which the movable iron core 370 can move is set between an initial position spaced apart from and below the yoke upper plate 351 and a contact position where contact is made with the yoke upper plate 351. Between the yoke upper plate 351 and the movable iron core 370, a return spring 302 is disposed, which uses its elasticity to bias the movable iron core 370 in a direction of returning the movable iron core 370 to the initial position (direction in which the movable iron core 370 moves away from the yoke upper plate 351).

The movable contact 430 shown in FIGS. 21 and 22 includes a plurality of (three) leaf springs 435 each having one side serving as a first leaf spring 435A and the other side serving as a second leaf spring 435B. The plurality of (three) leaf springs 435 are also conductive, and in FIGS. 21 and 22, these leaf springs 435 are vertically stacked on the shaft 380 in a state of being bent downward.

Furthermore, the movable contact 430 shown in FIGS. 21 and 22 includes a rigid plate member 438 which extends approximately in the horizontal direction and is disposed above the leaf spring 435. This plate member 438 can be formed using a conductive material or an insulating material.

Further, the shaft 380 shown in FIGS. 21 and 22 is provided with a support member 384a that is attached around the shaft main body 381 and supports each leaf spring 435 from below.

The plate member 438 and the leaf spring 435 are attached to the shaft 380 while being sandwiched between the head 382 and the support member 384a by attaching the support member 384a around the shaft main body 381 of the shaft 380 after inserting the shaft main body 381 into the insertion hole formed at the center.

In the configuration shown in FIGS. 21 and 22, the first and second fixed terminals 420A and 420B are formed in a stepped shape having a large diameter on the upper side and a small diameter on the lower side.

That is, each of the fixed terminals 420A and 420B is provided with large-diameter portions 4201A and 4201B located on the upper side and small-diameter portions 4202A and 4202B concentrically provided below the large-diameter portions 4201A and 4201B.

When the coil 330 is not energized, the plate member 438 has its tip on one side facing a lower surface 421dA of the large-diameter portion 4201A of the first fixed terminal 420A in a separated state from the first fixed terminal 420A, and has its tip on the other side facing a lower surface 421dB of the large-diameter portion 4201B of the second fixed terminal 420B in a separated state from the second fixed terminal 420B.

Furthermore, in the configuration shown in FIGS. 21 and 22, when the coil 330 is not energized, the distance from one end to the other end of each leaf spring 435 is shorter than the length of the plate member 438 in the left-right direction (distance from the tip on one side to the tip on the other side).

When the coil 330 is energized, the leaf spring 435 is moved relative to the plate member 438, and the tip on one side of each leaf spring 435 protrudes from the tip on one side of the plate member 438, while the tip on the other side of each leaf spring 435 protrudes from the tip on the other side of the plate member 438.

Therefore, when the shaft 380 is moved upward (to one side) in the up-down direction (one direction), the movable contact 430 (the plate member 438 and each leaf spring 435) is first moved upward, the tip of the plate member 438 on one side comes into contact with the lower surface 421dA of the large-diameter portion 4201A of the first fixed terminal 420A, and the tip on the other side comes into contact with the lower surface 421dB of the large-diameter portion 4201B of the second fixed terminal 420B. In this way, the both tips thereof come into contact with the lower surface 421dA of the large-diameter portion 4201A of the first fixed terminal 420A and the lower surface 421dB of the large-diameter portion 4201B of the second fixed terminal 420B. Thus, upward movement of the plate member 438 is restricted.

Furthermore, in the configuration shown in FIGS. 21 and 22, the leaf springs 435 are further pressed upward by the shaft 380 in a state where the upward movement of the plate member 438 is restricted (state where the tip on one side of the plate member 438 comes into contact with the lower surface 421dA of the large-diameter portion 4201A of the first fixed terminal 420A, while the tip on the other side comes into contact with the lower surface 421dB of the large-diameter portion 4201B of the second fixed terminal 420B).

Therefore, each leaf spring 435 is pressed upward and elastically deformed in a state where both tips thereof are in contact with the plate member 438 and the lower surfaces of the leaf springs 435 located immediately above. The leaf spring 435 comes into contact with the side surface 421eA of the small-diameter portion 4202A of the first fixed terminal 420A while having its tip on one side sliding on the lower surface on one side of the plate member 438 and the leaf spring 435 located immediately above, and comes into contact with the side surface 421eB of the small-diameter portion 4202B of the second fixed terminal 420B while having its tip on the other side sliding on the lower surface on the other side of the plate member 438 and the leaf spring 435 located immediately above. Note that, in the configuration shown in FIGS. 21 and 22, the tip of each leaf spring 435 is curved so as to become a part of an arc centered on the shaft 380 in a plan view (a state viewed from the up-down direction). Thus, by setting the contour shape of the tip of each leaf spring 435 to be a part of the arc centered on the shaft 380, the tip can be brought into contact with the side surface 421eA and the side surface 421eB even when each leaf spring 435 is rotated about the shaft 380.

In the configuration shown in FIGS. 21 and 22, the side surface 421eA of the small-diameter portion 4202A of the first fixed terminal 420A corresponds to the first surface of the first fixed terminal 420A, and the side surface 421eB of the small-diameter portion 4202B of the second fixed terminal 420B corresponds to the first surface of the second fixed terminal 420B.

Furthermore, in the configuration shown in FIGS. 21 and 22, each leaf spring 435 is further pressed upward by the shaft 380 even in a state where the tip of each leaf spring 435 on one side is brought into contact with the side surface 421eA of the small-diameter portion 4202A of the first fixed terminal 420A, and the tip on the other side is brought into contact with the side surface 421eB of the small-diameter portion 4202B of the second fixed terminal 420B.

In this event, one side of the leaf spring 435 is supported in a stretched state between the shaft 380 and the side surface (first surface) 421eA of the first fixed terminal 420A in a state where the tip of the leaf spring 435 on one side comes into contact with the side surface 421eA of the small-diameter portion 4202A of the first fixed terminal 420A. Meanwhile, the other side of the leaf spring 435 is supported in a stretched state between the shaft 380 and the side surface (first surface) 421eB of the second fixed terminal 420B in a state where the tip of the leaf spring 435 on the other side comes into contact with the side surface 421eB of the small-diameter portion 4202B of the second fixed terminal 420B.

As described above, in the configuration illustrated in FIGS. 21 and 22, one side of the leaf spring 435 serves as a first contact piece 432A on the first contact unit side that comes into contact with the side surface (first surface) 421eA of the first fixed terminal 420A in a stretched state. Likewise, the other side of the leaf spring 435 serves as a first contact piece 432B on the second contact unit side that comes into contact with the side surface (first surface) 421eB of the second fixed terminal 420B in a stretched state.

That is, the movable contact 430 shown in FIGS. 21 and 22 includes a leaf spring 435 that is set in a flexed state when the coil 330 is not energized (in a non-conductive state), and has one end serve as the first contact piece 432A on the first contact unit side and the other end serve as the first contact piece 432B on the second contact unit side when the coil 330 is energized (in a conductive state).

A plurality of such leaf springs 435 are stacked in the up-down direction (one direction).

Thus, the same advantageous effects as those achieved with the configuration shown in FIG. 19 can also be achieved with the contact device 10 having the configuration shown in FIGS. 21 and 22.

In the configuration shown in FIGS. 21 and 22, a plurality of leaf springs 435 are stacked in the up-down direction (one direction).

This makes it possible to further increase the stretch strength of the first contact piece 432A on the first contact unit side and the first contact piece 432B on the second contact unit side.

Furthermore, when a current in the same direction is applied to the stacked leaf springs 435, force acts on the stacked leaf springs 435 to attract each other.

Therefore, when the coil 330 is energized (in a conductive state), all of the three leaf springs 435 constituting the first contact piece 432A on the first contact unit side and the first contact piece 432B on the second contact unit side act as a single leaf spring, making it possible to further increase the stretch strength of the first contact piece 432A on the first contact unit side and the first contact piece 432B on the second contact unit side.

Since the movable contact 430 can be brought into contact with a plurality of spots on the outer surface 421aA of the first fixed terminal 420A, the magnitude of the electromagnetic repulsion force generated on the movable contact 430 can be reduced.

Furthermore, since the movable contact 430 can be brought into contact with a plurality of spots on the outer surface 421aB of the second fixed terminal 420B, the magnitude of the electromagnetic repulsion force generated on the movable contact 430 can be further reduced.

Note that, in the configuration shown in FIGS. 21 and 22, the description is given of an example where the first contact piece 432A on the first contact unit side and the first contact piece 432B on the second contact unit side are formed in the plurality of leaf springs 435, respectively. However, only one of the first contact piece 432A on the first contact unit side and the first contact piece 432B on the second contact unit side may be formed using a plurality of leaf springs (first leaf spring 435A or second leaf spring 435B).

That is, the first contact piece 432A on the first contact unit side may be formed by stacking a plurality of first leaf springs 435A that are set in a flexed state when the coil 330 is not energized (in a non-conductive state) and set in a stretched state when the coil 330 is energized (in a conductive state).

Likewise, the first contact piece 432B on the second contact unit side may be formed by stacking a plurality of second leaf springs 435B that are set in a flexed state when the coil 330 is not energized (in a non-conductive state) and set in a stretched state when the coil 330 is energized (in a conductive state).

Further, the first contact piece 432A on the first contact unit side is formed by stacking a plurality of first leaf springs 435A, and the first contact piece 432B on the second contact unit side may be formed by stacking a plurality of second leaf springs 435B that are separate from the first leaf springs 435A constituting the first contact piece 432A on the first contact unit side.

Thus, the same advantageous effects as those achieved with the configuration shown in FIGS. 21 and 22 can also be achieved.

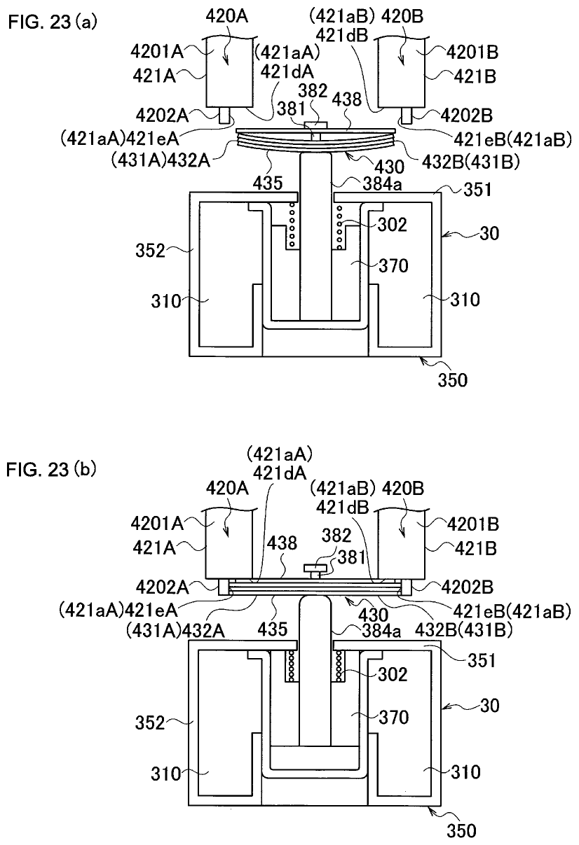

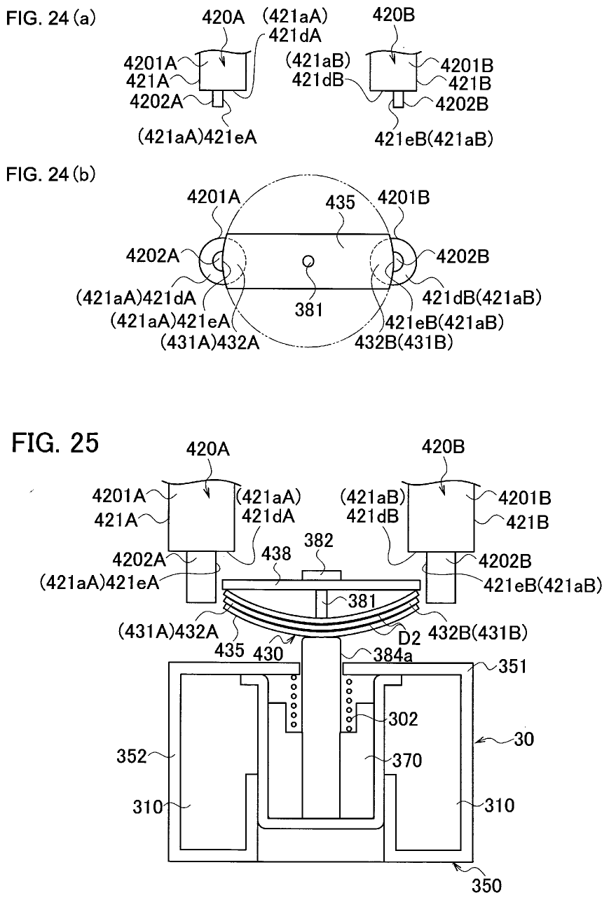

Note that, as shown in FIGS. 23 and 24, the side surface 421eA of the small-diameter portion 4202A of the first fixed terminal 420A and the side surface 421eB of the small-diameter portion 4202B of the second fixed terminal 420B may be concave surfaces corresponding to the arc portion at the tip of each leaf spring 435, and the leaf spring 435 may come into line contact (or surface contact) with the side surfaces 421eA and 421eB.

The movable contact 430 shown in FIGS. 23 and 24 also includes a rigid plate member 438 that extends approximately in the horizontal direction and is disposed above the leaf spring 435. This plate member 438 is formed using a conductive material or an insulating material.

With this configuration, the same advantageous effects as those achieved with the configuration shown in FIGS. 21 and 22 can be achieved, and each leaf spring 435 can be more reliably brought into contact with the side surfaces 421eA and 421eB.

As shown in FIG. 25, a gap D2 may be formed between leaf springs 435 adjacent to each other in the up-down direction (one direction).

In the configuration shown in FIG. 25, again, each leaf spring 435 is conductive. The movable contact 430 shown in FIG. 25 also includes a rigid plate member 438 that extends approximately in the horizontal direction and is disposed above the leaf spring 435. This plate member 438 is also formed using a conductive material or an insulating material.

Note that, in the configuration shown in FIG. 25, again, the tip of each leaf spring 435 can be curved so as to be a part of an arc centered on the shaft 380 in a plan view (a state viewed from the up-down direction).

Thus, the same advantageous effects as those achieved with the configuration shown in FIGS. 21 and 22 can also be achieved with the contact device 10 having the configuration shown in FIG. 25.

As shown in FIG. 25, the gap D2 formed between the leaf springs 435 adjacent to each other in the up-down direction (one direction) makes it easier for each leaf spring 435 to slide on the lower surfaces of the plate member 438 and the leaf spring 435 positioned directly above. Thus, each leaf spring 435 can be more easily elastically deformed.

When any one of the leaf springs 435 is supported in a stretched state, it is possible to suppress that the elastic deformation of another leaf spring 435 is hindered by the stretching of the leaf spring 435.

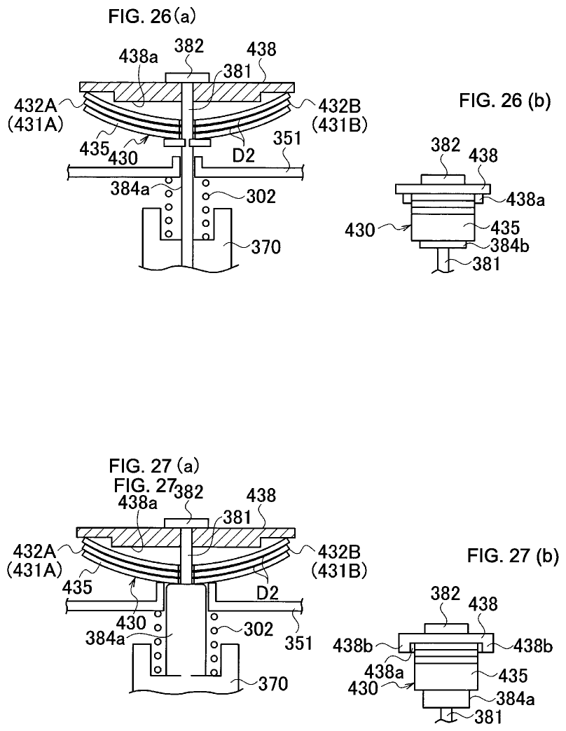

As shown in FIG. 26, each leaf spring 435 may be supported from below by attaching an E-ring 384b to the shaft main body 381 of the shaft 380.

In the configuration shown in FIG. 26, again, each leaf spring 435 is conductive. The movable contact 430 shown in FIG. 26 also includes a rigid plate member 438 that extends approximately in the horizontal direction and is disposed above the leaf spring 435. This plate member 438 is also formed using a conductive material or an insulating material.

Note that, in the configuration shown in FIG. 26, again, the tip of each leaf spring 435 can be curved so as to be a part of an arc centered on the shaft 380 in a plan view (a state viewed from the up-down direction).

Thus, the same advantageous effects as those achieved with the configuration shown in FIG. 25 can also be achieved with the contact device 10 having the configuration shown in FIG. 26.

In FIG. 26, a step portion 438a projecting downward (toward the leaf spring 435) is formed at the center of the plate member 438. When each of the leaf springs 435 is pressed upward by the shaft 380 and is elastically deformed, the leaf spring 435 located at the uppermost position comes into contact with the lower end of the step portion 438a during the elastic deformation. That is, each leaf spring 435 is elastically deformed in a state where the leaf spring 435 located at the uppermost portion is in contact with the lower end of the step portion 438a.

Therefore, in the configuration shown in FIG. 26, each leaf spring 435 is elastically deformed in the latter half of elastic deformation while being pressed upward by the shaft 380 and pressed downward by the step portion 438a. That is, each leaf spring 435 is elastically deformed by being compressed by the shaft 380 and the step portion 438a.

This makes it possible to more reliably elastically deform the leaf spring 435, and to further improve the stretching force of each leaf spring 435 in a state where the first and second fixed terminals 420A and 420B are conducted.

As shown in FIG. 27, a side wall portion 438b may be formed downward from both ends in the width direction (front-back direction) of the plate member 438.

In the configuration shown in FIG. 27, again, each leaf spring 435 is conductive. The movable contact 430 shown in FIG. 27 also includes a rigid plate member 438 that extends approximately in the horizontal direction and is disposed above the leaf spring 435. This plate member 438 is also formed using a conductive material or an insulating material.

In FIG. 27, again, a step portion 438a projecting downward (toward the leaf spring 435) is formed at the center of the plate member 438.

Note that, in the configuration shown in FIG. 27, again, the tip of each leaf spring 435 can be curved so as to be a part of an arc centered on the shaft 380 in a plan view (a state viewed from the vertical direction).

Thus, the same advantageous effects as those achieved with the configurations shown in FIGS. 25 and 26 can also be achieved with the contact device 10 having the configuration shown in FIG. 27.

The side wall portion 438b formed at both ends in the width direction (front-rear direction) of the plate member 438 as shown in FIG. 27 makes it possible to prevent each leaf spring 435 from being rotated about the shaft 380.

Note that, although FIG. 27 illustrates an example where the support member 384a is attached to the shaft main body 381 of the shaft 380, an E-ring 384b may be attached to the shaft main body 381 as shown in FIG. 26.

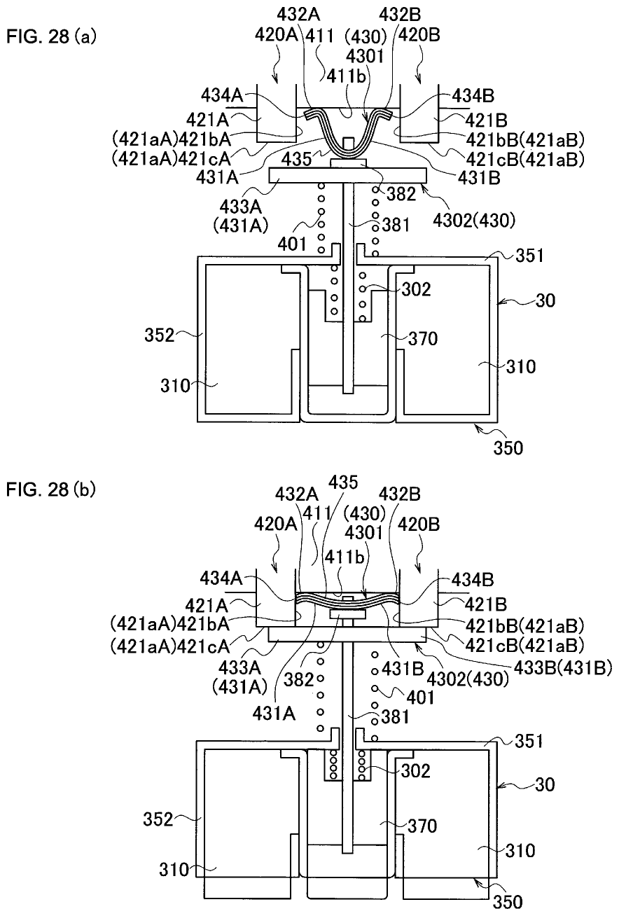

The contact device 10 may also have a configuration shown in FIG. 28.

In a contact device 10 shown in FIG. 28, as in the case of FIG. 17, a drive block 30 is configured without using a fixed iron core. That is, a yoke upper plate 351 is used as a fixed-side member instead of the fixed iron core, and a movable iron core 370 is attracted to the yoke upper plate 351. A range (movable range) within which the movable iron core 370 can move is set between an initial position spaced apart from and below the yoke upper plate 351 and a contact position where contact is made with the yoke upper plate 351. Between the yoke upper plate 351 and the movable iron core 370, a return spring 302 is disposed, which uses its elasticity to bias the movable iron core 370 in a direction of returning the movable iron core 370 to the initial position (direction in which the movable iron core 370 moves away from the yoke upper plate 351).

The movable contact 430 shown in FIG. 28 includes a first movable contact main body 4301 and a second movable contact main body 4302 provided separately from the first movable contact main body 4301.

In FIG. 28, the first movable contact main body 4301 includes a plurality of (three) leaf springs 435 each having one side serving as a first leaf spring 435A and the other side serving as a second leaf spring 435B. The plurality of (three) leaf springs 435 are also conductive, and these leaf springs 435 have an approximately U-shape curved downward.

The shaft 380 shown in FIG. 28 has a shape in which a head 382 is formed in the middle of the shaft main body 381.

The plurality of (three) leaf springs 435 are attached to the shaft 380 while being stacked in the up-down direction by inserting a portion located above the head 382 of the shaft main body 381 into an insertion hole formed at the center of each leaf spring 435.

As described above, in FIG. 28, the first movable contact main body 4301 is formed by vertically stacking the plurality of (three) leaf springs 435 bent approximately into a U-shape.

On the other hand, the second movable contact main body 4302 is formed of a rigid, approximately plate-shaped member that extends in an approximately horizontal direction. The approximately plate-shaped member constituting the second movable contact main body 4302 is also formed using a conductive material.

In FIG. 28, the second movable contact main body 4302 is arranged below the first and second fixed terminals 420A and 420B. In this event, the upper surface of the second movable contact main body 4302 faces the bottom surface 421cA of the first fixed terminal 420A and the bottom surface 421cB of the second fixed terminal 420B.

The second movable contact main body 4302 is attached to the shaft 380 so as to be relatively movable by inserting a portion located below the head 382 of the shaft main body 381 into an insertion hole formed at the center. Thus, in FIG. 28, the second movable contact main body 4302 is attached to the shaft 380 so as to be movable relative to the first movable contact main body 4301. In the configuration shown in FIG. 28, the second movable contact main body 4302 is pressed upward by the contact pressure spring 401.

In the configuration shown in FIG. 28, one side of the first movable contact main body 4301 and one side of the second movable contact main body 4302 serve as a first contact unit 431A that comes into contact with the first fixed terminal 420A when the shaft 380 is moved upward (to one side) in the up-down direction (one direction). Meanwhile, the other side of the first movable contact main body 4301 and the other side of the second movable contact main body 4302 serve as a second contact unit 431B that is electrically connected to the first contact unit 431A and comes into contact with the second fixed terminal 420B.

Here, in FIG. 28, one side of the first movable contact main body 4301 that forms a part of the first contact unit 431A has a tip bent downward and toward the side surface 421bA of the first fixed terminal 420A. This tip serves as a first contact piece 432A on the first contact unit side that comes into contact with the side surface (first surface) 421bA of the first fixed terminal 420A in a stretched state.

Note that, in FIG. 28, a tip on one side of each leaf spring 435 functions as a rigid plate member 434A. Therefore, the first contact piece 432A on the first contact unit side shown in FIG. 28 also includes a rigid plate member 434A.

On the other hand, the other side of the first movable contact main body 4301 that forms a part of the second contact unit 431B has a tip bent downward and toward the side surface 421bB of the second fixed terminal 420B. This tip serves as a first contact piece 432B on the second contact unit side that comes into contact with the side surface (first surface) 421bB of the second fixed terminal 420B in a stretched state.

Likewise, in FIG. 28, a tip on the other side of each leaf spring 435 also functions as a rigid plate member 434B. Therefore, the first contact piece 432B on the second contact unit side shown in FIG. 28 also includes a rigid plate member 434B.

By elastically deforming the approximately U-shaped first movable contact main body 4301 while making the tip side (a bending point on one side and a bending point on the other side) of the first movable contact main body 4301 slide on the lower surface 411b of the top wall 411, the first contact piece 432A on the first contact unit side and the first contact piece 432B on the second contact unit side are brought into contact with and away from the side surface 421bA of the first fixed terminal 420A and the side surface 421bB of the second fixed terminal 420B.

In FIG. 28, even when the movable iron core 370 is at the initial position, the other ends of the first movable contact main body 4301 are biased in a direction of approaching each other (closing direction). That is, even when the movable iron core 370 is at the initial position, downward pressing force of the first movable contact main body 4301 acts on the movable iron core 370.

With such a configuration, when energization of the coil 330 is started, the shaft 380 connected to the movable iron core 370 is moved upward, and the vertex portion (lower end: connecting portion with the shaft 380) of the approximately U-shaped first movable contact main body 4301 is pressed upward by the shaft 380.

As described above, when the vertex portion of the first movable contact main body 4301 is pressed upward by the shaft 380, the tip side of the first movable contact main body 4301 (the bending point on one side and the bending point on the other side) slides on the lower surface 411b of the top wall 411 against the elastic restoring force of the first movable contact main body 4301, and the bending points are rotated in a direction away from each other. Then, the first contact piece 432A on the first contact unit side of the first movable contact main body 4301 comes into contact with the side surface 421bA of the first fixed terminal 420A, and the first contact piece 432B on the second contact unit side of the first movable contact main body 4301 comes into contact with the side surface 421bB of the second fixed terminal 420B.

In this event, the first contact piece 432A on the first contact unit side comes into contact with the side surface (first surface) 421bA of the first fixed terminal 420A in a stretched manner in a state of being pressed upward (to one side) in the up-down direction (one direction) by the shaft 380. At the same time, the first contact piece 432B on the second contact unit side comes into contact with the side surface (first surface) 421bB of the second fixed terminal 420B in a stretched manner in a state of being pressed upward (to one side) in the up-down direction (one direction) by the shaft 380.

When the shaft 380 is moved upward, the second movable contact main body 4302 is pressed by the contact pressure spring 401 and moved upward. Then, the upper surface on one side of the second movable contact main body 4302 comes into contact with the bottom surface 421cA of the first fixed terminal 420A, and the upper surface on the other side comes into contact with the bottom surface 421cB of the second fixed terminal 420B.

On the other hand, when the energization of the coil 330 is stopped and the shaft 380 is moved downward (to the other side) in the up-down direction (one direction), the elastic restoring force of the first movable contact main body 4301 causes the tip side (the bending point on one side and the bending point on the other side) of the first movable contact main body 4301 to slide on the lower surface 411b of the top wall 411, and the bending points are rotated in a direction of approaching each other. Then, the first contact piece 432A on the first contact unit side of the first movable contact main body 4301 is separated from the side surface 421bA of the first fixed terminal 420A, and the first contact piece 432B on the second contact unit side of the first movable contact main body 4301 is separated from the side surface 421bB of the second fixed terminal 420B.

When the shaft 380 is moved downward, the second movable contact main body 4302 is pressed downward by the head 382 and moved downward. Then, the upper surface on one side of the second movable contact main body 4302 is separated from the bottom surface 421cA of the first fixed terminal 420A, and the upper surface on the other side is separated from the bottom surface 421cB of the second fixed terminal 420B.

As described above, in the configuration shown in FIG. 28, the side surface (first surface) 421bA of the first fixed terminal 420A is an intersecting surface that intersects with a plane perpendicular to the up-down direction (one direction). The bottom surface 421cA of the first fixed terminal 420A is a second surface that intersects with the side surface (first surface) 421bA of the first fixed terminal 420A.

Likewise, the side surface (first surface) 421bB of the second fixed terminal 420B is an intersecting surface that intersects with a plane perpendicular to the up-down direction (one direction). The bottom surface 421cB of the second fixed terminal 420B is a second surface that intersects with the side surface (first surface) 421bB of the second fixed terminal 420B.

Furthermore, in the configuration shown in FIG. 28, one side of the plate member 434A and the second movable contact main body 4302 serves as a first contact unit 431A that comes into contact with the first fixed terminal 420A when the shaft 380 is moved upward (to one side) in the up-down direction (one direction). Meanwhile, the other side of the plate member 434B and the second movable contact main body 4302 serves as a second contact unit 431B that is electrically connected to the first contact unit 431A and comes into contact with the second fixed terminal 420B.

The first contact unit 431A includes a first contact piece 432A on the first contact unit side that comes into contact with the side surface (first surface) 421bA of the first fixed terminal 420A in a stretched manner in a state of being pressed upward (to one side) in the up-down direction (one direction) by the shaft 380. The first contact unit 431A further includes a second contact piece (one side of the second movable contact main body 4302) 433A on the first contact unit side that comes into contact with the bottom surface (second surface) 421cA intersecting with the side surface (first surface) 421bA of the first fixed terminal 420A.

On the other hand, the second contact unit 431B includes a first contact piece 432B on the second contact unit side that comes into contact with the side surface (first surface) 421bB of the second fixed terminal 420B in a stretched manner in a state of being pressed upward (to one side) in the up-down direction (one direction) by the shaft 380. The second contact unit 431B further includes a second contact piece (one side of the second movable contact main body 4302) 433B on the second contact unit side that comes into contact with the bottom surface (second surface) 421cB intersecting with the side surface (first surface) 421bB of the second fixed terminal 420B.

In the configuration shown in FIG. 28, the first contact piece 432A on the first contact unit side includes a rigid plate member 434A, and the first contact piece 432B on the second contact unit side also includes a rigid plate member 434B.

In the configuration shown in FIG. 28, the first contact piece 432A on the first contact unit side and the second contact piece 433A on the first contact unit side are formed separately, while the first contact piece 432B on the second contact unit side and the second contact piece 433B on the second contact unit side are formed separately.

Thus, the same advantageous effects as those achieved with the configurations shown in FIGS. 17, 21, and 22 can also be achieved with the contact device 10 having the configuration shown in FIG. 28.

Note that, in the configuration illustrated in FIG. 28, the plurality of leaf springs 435 have rigid plate members 434A and 434B formed at both ends, respectively. Alternatively, only one of the first contact piece 432A on the first contact unit side and the first contact piece 432B on the second contact unit side may be formed of a plurality of leaf springs (first leaf spring 435A or second leaf spring 435B).

Furthermore, the first contact piece 432A on the first contact unit side may be formed by stacking a plurality of first leaf springs 435A, and the first contact piece 432B on the second contact unit side may be formed by stacking a plurality of second leaf springs 435B that are separate from the first leaf springs 435A that constitute the first contact piece 432A on the first contact unit side.

Thus, the same advantageous effects as those achieved with the configuration shown in FIG. 28 can be achieved.

With the downward pressing force of the first movable contact main body 4301 acting on the movable iron core 370 even when the movable iron core 370 is at the initial position, the movable iron core 370 can be returned to the initial position, without the return spring 302, when power supply to the coil 330 is stopped.

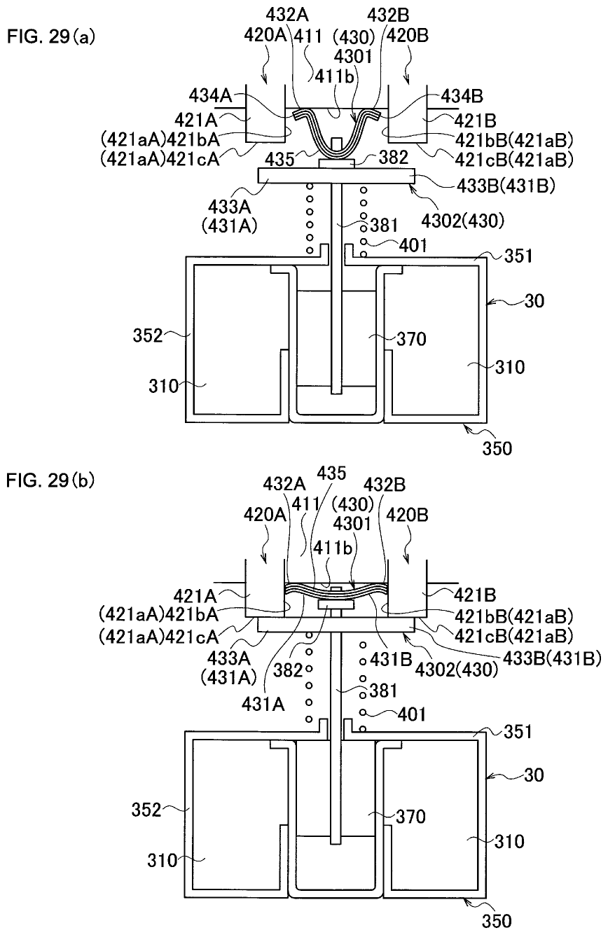

Therefore, as shown in FIG. 29, a contact device 10 can be configured using a drive block (drive unit) 30 with no return spring 302.

Note that, in the configuration shown in FIG. 29, again, each leaf spring 435 is conductive. An approximately plate-shaped member constituting the second movable contact main body 4302 is also formed using a conductive material.

Thus, the same advantageous effects as those achieved with the configuration shown in FIG. 28 can also be achieved with the contact device 10 having the configuration shown in FIG. 29.

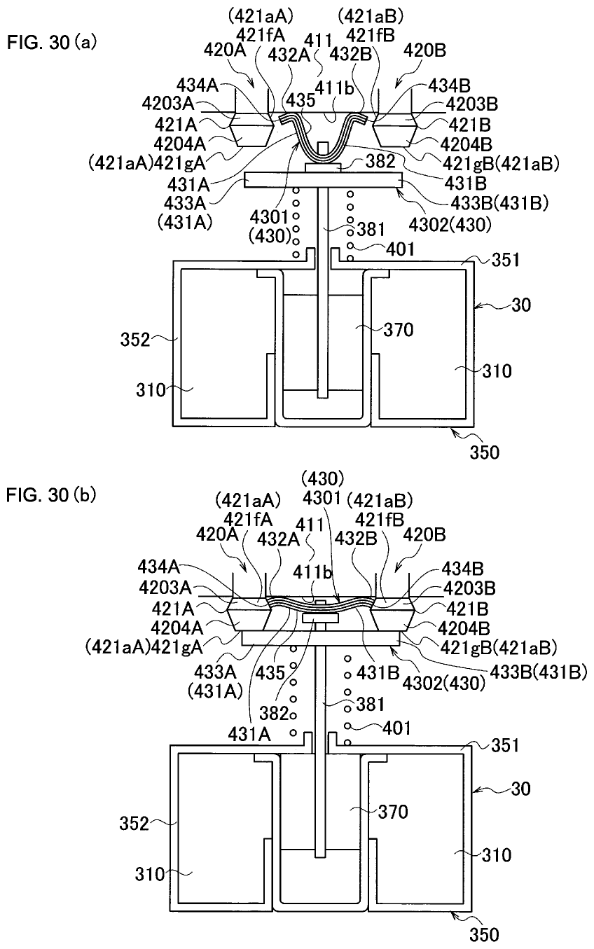

As shown in FIG. 30, the first and second fixed terminals 420A and 420B can also have tapered lower ends.

In the configuration shown in FIG. 30, again, each leaf spring 435 is conductive. An approximately plate-shaped member constituting the second movable contact main body 4302 is also formed using a conductive material.

Here, in FIG. 30, an upper tapered portion 4203A having a larger diameter toward the lower side and a lower tapered portion 4204A that is connected to the upper tapered portion 4203A and has a smaller diameter toward the lower side are formed below the first fixed terminal 420A. Likewise, an upper tapered portion 4203B having a larger diameter toward the lower side and a lower tapered portion 4204B that is connected to the upper tapered portion 4203B and has a smaller diameter toward the lower side are formed below the second fixed terminal 420B.

When the shaft 380 is moved upward (to one side) in the up-down direction (one direction), the first contact piece 432A on the first contact unit side is brought into contact with the side surface (inclined surface: first surface) 421fA of the upper tapered portion 4203A of the first fixed terminal 420A. At the same time, the first contact piece 432B on the second contact unit side is brought into contact with the side surface (inclined surface: first surface) 421fB of the upper tapered portion 4203B of the second fixed terminal 420B.

In this event, the second movable contact main body 4302 has its one upper surface coming into contact with the bottom surface 421gA of the first fixed terminal 420A and the other upper surface coming into contact with the bottom surface 421gB of the second fixed terminal 420B.

Therefore, in the configuration shown in FIG. 30, the side surface (inclined surface: first surface) 421fA of the upper tapered portion 4203A of the first fixed terminal 420A is an intersection surface that intersects with a plane perpendicular to the up-down direction (one direction). Meanwhile, the bottom surface 421gA of the first fixed terminal 420A is a second surface that intersects with the side surface (first surface) 421fA of the first fixed terminal 420A.

Likewise, the side surface (inclined surface: first surface) 421fB of the upper tapered portion 4203B of the second fixed terminal 420B is an intersecting surface that intersects with a plane perpendicular to the up-down direction (one direction). Meanwhile, the bottom surface 421gB of the second fixed terminal 420B is a second surface that intersects with the side surface (first surface) 421fB of the second fixed terminal 420B.

Thus, the same advantageous effects as those achieved with the configuration shown in FIG. 28 can also be achieved with the contact device 10 having the configuration shown in FIG. 30.

In the configuration shown in FIG. 30, the first contact piece 432A on the first contact unit side is brought into contact with the side surface (inclined surface: first surface) 421fA of the upper tapered portion 4203A of the first fixed terminal 420A. Therefore, obliquely upward electromagnetic repulsion force (in a direction different from the downward direction) is generated between the first fixed terminal 420A and the first contact piece 432A on the first contact unit side.

In the configuration shown in FIG. 30, the first contact piece 432B on the second contact unit side is brought into contact with the side surface (inclined surface: first surface) 421fB of the upper tapered portion 4203B of the second fixed terminal 420B. Therefore, obliquely upward electromagnetic repulsion force (in a direction different from the downward direction) is generated between the second fixed terminal 420B and the first contact piece 432B on the second contact unit side.

Therefore, force moving the shaft 380 upward (force in a direction of setting the first and second fixed terminals 420A and 420B in a conductive state) acts on the shaft 380.

Accordingly, with the configuration shown in FIG. 30, the electromagnetic repulsion force acting on shaft 380 (force in a direction of setting the first and second fixed terminals 420A and 420B in a non-conductive state) can be further reduced.

Note that the lower ends of the first and second fixed terminals 420A and 420B may be formed in a cylindrical shape having a diameter larger than that of the upper part, and the first contact piece 432A on the first contact unit side and the first contact piece 432B on the second contact unit side may be brought into contact with the large-diameter cylindrical upper surface. Thus, electromagnetic repulsion force in a direction different from the downward direction (upward) can be generated between the fixed terminal 420A and the first contact piece 432A on the first contact unit side or between the fixed terminal 420B and the first contact piece 432B on the second contact unit side.

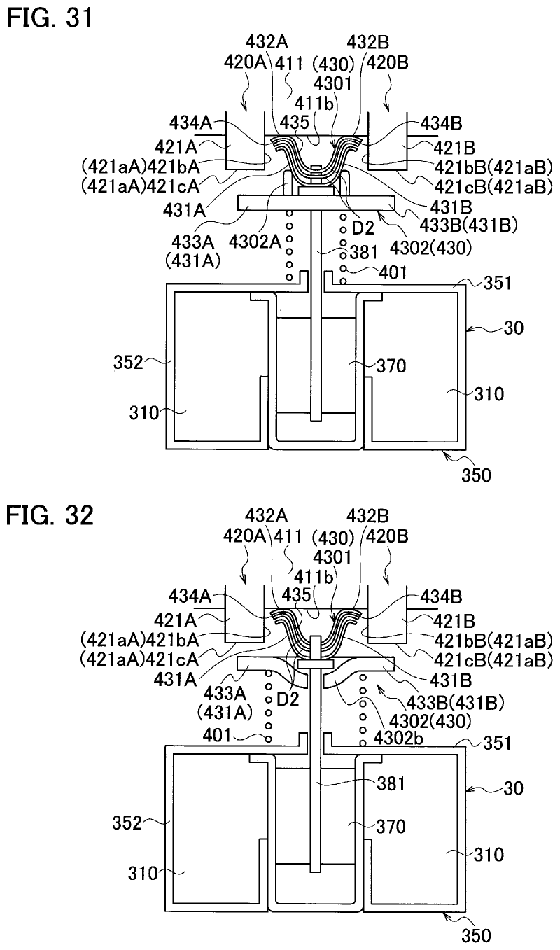

As shown in FIGS. 31 to 33, a gap D2 may be formed between a plurality of (three) leaf springs 435 bent into an approximately U-shape to form the first movable contact main body 4301. That is, the gap D2 may be formed between the leaf springs 435 adjacent to each other in the up-down direction (one direction).

In this configuration shown in FIGS. 31 to 33, again, each leaf spring 435 is conductive. An approximately plate-shaped member constituting the second movable contact main body 4302 is also formed using a conductive material.

Thus, the same advantageous effects as those achieved with the configuration shown in FIG. 28 can also be achieved with the contact device 10 having the configuration shown in FIGS. 31 to 33.

As shown in FIGS. 31 to 33, the gap D2 formed between the leaf springs 435 adjacent to each other in the up-down direction (one direction) makes it easier for each leaf spring 435 to slide on the lower surface of the leaf spring 435 positioned directly above. Thus, the respective leaf springs 435 can be more easily elastically deformed.

Moreover, when any one of the leaf springs 435 is supported in a stretched state, it is possible to suppress that the elastic deformation of another leaf spring 435 is hindered by the stretching of the leaf spring 435.

In the configuration shown in FIG. 31, a cylindrical positioning wall portion 4302a is formed on the upper surface of the second movable contact main body 4302 so as to surround the head 382.

Then, when the power supply to the coil 330 is stopped and the shaft 380 is moved downward (to the other side) in the up-down direction (one direction), the vertex portion (lower end: connecting portion with the shaft 380) of the approximately U-shaped first movable contact main body 4301 is housed in the cylinder of the positioning wall portion 4302a.

With this configuration, it is possible to suppress a plurality of (three) leaf springs 435 bent into an approximately U-shape from being displaced.

The positioning wall portion 4302a provided on the upper surface of the second movable contact main body 4302 facilitates rotation of the other ends of the first movable contact main body 4301 in a direction of approaching each other (closing direction) when the shaft 380 is moved downward (to the other side) in the up-down direction (one direction). Therefore, the first movable contact main body 4301 can be more quickly separated from the fixed terminals 420A and 420B.

In the configuration shown in FIG. 32, a positioning protrusion 4302b for positioning the contact pressure spring 401 is formed by recessing downward the periphery of the shaft 380 of the second movable contact main body 4302. [0490]

401 from being displaced, and to more stably press the second movable contact main body 4302 upward. It is also possible to prevent the left and right contact pressures of the second movable contact main body 4302 from being biased.

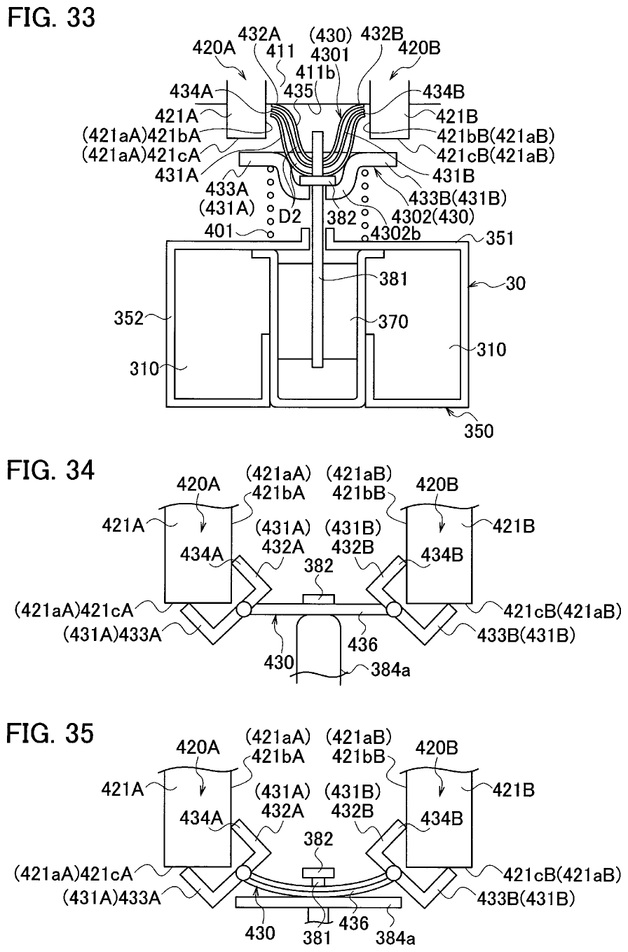

In the configuration shown in FIG. 33, as in the case of the configuration shown in FIG. 32, the positioning protrusion 4302b for positioning the contact pressure spring 401 is formed by recessing downward the periphery of the shaft 380 of the second movable contact main body 4302.

Furthermore, in the configuration shown in FIG. 33, the positioning protrusion 4302b is formed by further recessing the periphery of the shaft 380 of the second movable contact main body 4302 compared with the configuration shown in FIG. 32. Thus, the positioning protrusion 4302b also serves as a housing part that houses the vertex portion (lower end: connecting portion with the shaft 380) of the approximately U-shaped first movable contact main body 4301.

Thus, it is possible to suppress the displacement of the contact pressure spring 401 while suppressing the displacement of the plurality of (three) leaf springs 435 bent into an approximately U-shape.

The contact device 10 may also have a configuration shown in FIG. 34.

A movable contact 430 shown in FIG. 34 has a base part 436 connected to the shaft 380 (pressed by the shaft 380). In FIG. 34, the base part 436 is formed of a rigid approximately rectangular parallelepiped plate member elongated in the left-right direction. The base part 436 is formed using a conductive material.

The base part 436 is attached to the shaft 380 while being sandwiched between the head 382 and the support member 384a by attaching the support member 384a around the shaft main body 381 of the shaft 380 after inserting the shaft main body 381 into the insertion hole formed at the center.

A first contact unit 431A that comes into contact with the first fixed terminal 420A when the shaft 380 is moved upward (to one direction) in the up-down direction (one direction) is connected to one end of the base part 436.

A second contact unit 431B that comes into contact with the second fixed terminal 420B when the shaft 380 is moved upward (to one direction) in the up-down direction (one direction) is connected to the other end of the base part 436.

Here, in FIG. 34, the first contact unit 431A includes a first contact piece 432A on the first contact unit side that comes into contact with the side (first surface) 421bA of the first fixed terminal 420A in a stretched manner in a state of being pressed upward (to one side) in the up-down direction (one direction) by the shaft 380. The first contact unit 431A further includes a second contact piece 433A on the first contact unit side that comes into contact with a bottom surface (second surface) 421cA intersecting with the side surface (first surface) 421bA of the first fixed terminal 420A.

The first contact piece 432A on the first contact unit side and the second contact piece 433A on the first contact unit side are integrally formed.

To be more specific, the first contact unit 431A has a shape obtained by bending a rigid plate member into an approximately U-shape, and the first contact unit 431A is formed using a conductive material. One side of the first contact unit 431A serves as the first contact piece 432A on the first contact unit side, while the other side serves as the second contact piece 433A on the first contact unit side.

Furthermore, in FIG. 34, the first contact unit 431A in which the first contact piece 432A on the first contact unit side and the second contact piece 433A on the first contact unit side are integrally formed is connected to one side end of the base part 436 so as to be rotatable relative to the base part 436 about the width direction (front-back direction).

Likewise, the second contact unit 431B includes a first contact piece 432B on the second contact unit side that comes into contact with the side (first surface) 421bB of the second fixed terminal 420B in a stretched manner in a state of being pressed upward (to one side) in the up-down direction (one direction) by the shaft 380. The second contact unit 431B further includes a second contact piece 433B on the second contact unit side that comes into contact with a bottom surface (second surface) 421cB intersecting with the side surface (first surface) 421bB of the second fixed terminal 420B.

The first contact piece 432B on the second contact unit side and the second contact piece 433B on the second contact unit side are integrally formed.

To be more specific, the second contact unit 431B has a shape obtained by bending a rigid plate member into an approximately U-shape, and the second contact unit 431B is formed using a conductive material. One side of the second contact unit 431B serves as the first contact piece 432B on the second contact unit side, while the other side serves as the second contact piece 433B on the second contact unit side.

Furthermore, the second contact unit 431B in which the first contact piece 432B on the second contact unit side and the second contact piece 433B on the second contact unit side are integrally formed is connected to the other side end of the base part 436 so as to be rotatable relative to the base part 436 about the width direction (front-back direction).

When the shaft 380 is moved upward (to one direction) in the up-down direction (one direction), one side of the first contact unit 431A (the first contact piece 432A on the first contact unit side) comes into contact with the side surface 421bA of the first fixed terminal 420A, and the other side of the first contact unit 431A (the second contact piece 433A on the first contact unit side) comes into contact with the bottom surface 421cA of the first fixed terminal 420A. That is, the first contact unit 431A is brought into contact with the first fixed terminal 420A by sandwiching the first fixed terminal 420A between the first contact piece 432A on the first contact unit side and the second contact piece 433A on the first contact unit side, which are integrally formed.

In this event, the first contact piece 432A on the first contact unit side is brought into contact with the side surface (the first surface) 421bA of the first fixed terminal 420A in a stretched manner in a state of being pressed upward (to one side) in the up-down direction (one direction) by the shaft 380. At the same time, the second contact piece 433A on the first contact unit side is brought into contact with the bottom surface (second surface) 421cA of the first fixed terminal 420A in a stretched manner in a state of being pressed upward (to one side) in the up-down direction (one direction) by the shaft 380.

Likewise, when the shaft 380 is moved upward (to one side) in the up-down direction (one direction), one side of the second contact unit 431B (the first contact piece 432B on the second contact unit side) comes into contact with the side surface 421bB of the second fixed terminal 420B, and the other side of the second contact unit 431B (the second contact piece 433B on the second contact unit side) comes into contact with the bottom surface 421cB of the second fixed terminal 420B.

That is, the second contact unit 431B is brought into contact with the second fixed terminal 420B by sandwiching the second fixed terminal 420B between the first contact piece 432B on the second contact unit side and the second contact piece 433B on the second contact unit side, which are integrally formed.

In this event, the first contact piece 432B on the second contact unit side is brought into contact with the side surface (the first surface) 421bB of the second fixed terminal 420B in a stretched manner in a state of being pressed upward (to one side) in the up-down direction (one direction) by the shaft 380. At the same time, the second contact piece 433B on the second contact unit side is brought into contact with the bottom surface (second surface) 421cB of the second fixed terminal 420B in a stretched manner in a state of being pressed upward (to one side) in the up-down direction (one direction) by the shaft 380.

On the other hand, when the shaft 380 is moved downward (to the other side) in the up-down direction (one direction), one side of the first contact unit 431A (the first contact piece 432A on the first contact unit side) is separated from the side surface 421bA of the first fixed terminal 420A, and the other side of the first contact unit 431A (the second contact piece 433A on the first contact unit side) is separated from the bottom surface 421cA of the first fixed terminal 420A.

Likewise, when the shaft 380 is moved downward (to the other side) in the up-down direction (one direction), one side of the second contact unit 431B (the first contact piece 432B on the second contact unit side) is separated from the side surface 421bB of the second fixed terminal 420B, and the other side of the second contact unit 431B (the second contact piece 433B on the second contact unit side) is separated from the bottom surface 421cB of the second fixed terminal 420B.

As described above, in the configuration shown in FIG. 34, the side surface (first surface) 421bA of the first fixed terminal 420A is an intersecting surface that intersects with a plane perpendicular to the up-down direction (one direction). Meanwhile, the bottom surface 421cA of the first fixed terminal 420A is a second surface that intersects with the side surface (first surface) 421bA of the first fixed terminal 420A.

Likewise, the side surface (first surface) 421bB of the second fixed terminal 420B is an intersecting surface that intersects with a plane perpendicular to the up-down direction (one direction). Meanwhile, the bottom surface 421cB of the second fixed terminal 420B is a second surface that intersects with the side surface (first surface) 421bB of the second fixed terminal 420B.

In FIG. 34, again, the first contact piece 432A on the first contact unit side includes a rigid plate member 434A, and the first contact piece 432B on the second contact unit side includes a rigid plate member 434B.

Thus, the same advantageous effects as those achieved with the configuration shown in FIG. 17 can also be achieved with the contact device 10 having the configuration shown in FIG. 34.

In the configuration shown in FIG. 34, the first contact piece 432A on the first contact unit side and the second contact piece 433A on the first contact unit side are integrally formed.

With this configuration, when the first contact unit 431A is brought into contact with the first fixed terminal 420A, the first fixed terminal 420A can be sandwiched between the first contact piece 432A on the first contact unit side and the second contact piece 433A on the first contact unit side form. The first contact unit 431A can be more reliably brought into contact with the first fixed terminal 420A.

The movable contact 430 has a base part 436 connected to the shaft 380 (pressed by the shaft 380).

The first contact unit 431A, in which the first contact piece 432A on the first contact unit side and the second contact piece 433A on the first contact unit side are integrally formed, is connected to one side end of the base part 436 so as to be rotatable relative to the base part 436 about the width direction (front-back direction).

Thus, when the first contact piece 432A on the first contact unit is rotated by electromagnetic repulsion force in a direction away from the first fixed terminal 420A, the second contact piece 433A on the first contact unit side can be rotated in a direction of coming into contact with the first fixed terminal 420A. Likewise, when the second contact piece 433A on the first contact unit side is rotated by electromagnetic repulsion force in a direction away from the first fixed terminal 420A, the first contact piece 432A on the first contact unit can be rotated in a direction of coming into contact with the first fixed terminal 420A.

Therefore, when the first contact unit 431A is brought into contact with the first fixed terminal 420A, at least one of the contact pieces can be brought into contact with the first fixed terminal 420A. Thus, the conductive state between the first and second fixed terminals 420A and 420B can be more reliably maintained.

In the configuration shown in FIG. 34, the first contact piece 432B on the second contact unit side and the second contact piece 433B on the second contact unit side are integrally formed.

Furthermore, the second contact unit 431B in which the first contact piece 432B on the second contact unit side and the second contact piece 433B on the second contact unit side are integrally formed is connected to the other side end of the base part 436 so as to be rotatable relative to the base part 436 about the width direction (front-back direction).

Therefore, the same advantageous effects as those achieved on the first fixed terminal 420A side can also be achieved on the second fixed terminal 420B side.

Note that at least one of the first contact unit 431A and the second contact unit 431B may be fixed to the base part 436.

As shown in FIG. 35, the base part 436 may be configured using a leaf spring 435 that is set in a flexed state in a non-conductive state and is set in a stretched state in a conductive state. FIG. 35 illustrates an example where the base part 436 is configured by stacking two conductive leaf springs 435 in the up-down direction.

The base part 436 can be attached to the shaft 380 while being sandwiched between the head 382 and the support member 384a by attaching the support member 384a to the shaft main body 381 of the shaft 380 after inserting the shaft main body 381 into an insertion hole formed in the center.

The conductive first contact unit 431A, in which the first contact piece 432A on the first contact unit side and the second contact piece 433A on the first contact unit side are integrally formed, may be connected to one side end of the base part 436 formed of the leaf spring 435 so as to be rotatable relative to the base part 436 about the width direction (front-rear direction). At the same time, the conductive second contact unit 431B, in which the first contact piece 432B on the second contact unit side and the second contact piece 433B on the second contact unit side are integrally formed, may be connected to the other side end of the base part 436 formed of the leaf spring so as to be rotatable relative to the base part 436 about the width direction (front-rear direction).

Thus, the same advantageous effects as those achieved with the configuration shown in FIG. 34 can also be achieved with the contact device 10 having the configuration shown in FIG. 35.

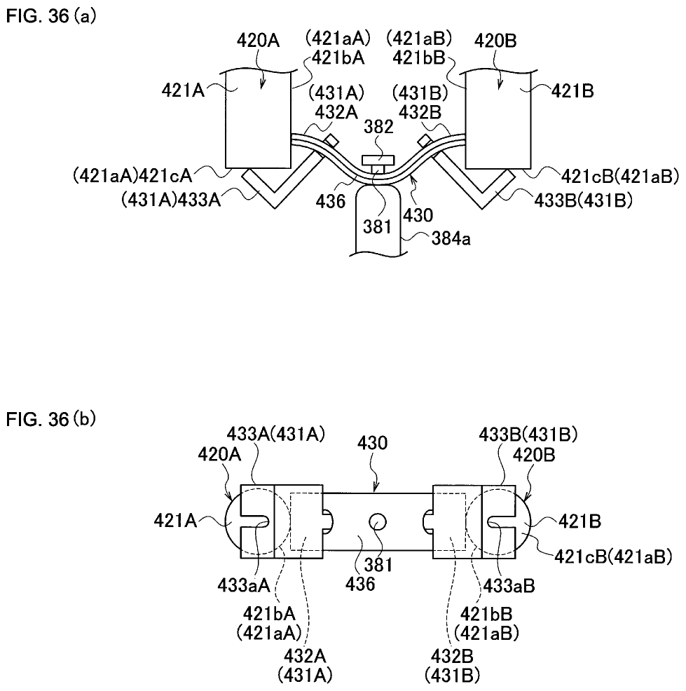

As shown in FIG. 36, both ends of the base part 436 formed of the leaf spring 435 which is set in a flexed state in the non-conductive state and is set in a stretched state in the conductive state may function as the first contact piece 432A on the first contact unit side and the first contact piece 433B on the second contact unit side, respectively. FIG. 36 illustrates an example where the first contact piece 432A on the first contact unit side, the first contact piece 433B on the second contact unit side, and the base part 436 are integrally formed by stacking two conductive leaf springs 435 in the up-down direction.

The leaf spring 435 can be attached to the shaft 380 while being sandwiched between the head 382 and the support member 384a by attaching the support member 384a to the shaft main body 381 of the shaft 380 after inserting the shaft main body 381 into an insertion hole formed in the center.

The first contact piece 432A on the first contact unit side and the second contact piece 433A on the first contact unit side may be integrally formed and the first contact piece 432B on the second contact unit side and the second contact piece 433B on the second contact unit side may be integrally formed by fixing the second contact piece 433A on the first contact unit side to the central portion on one side of the leaf spring 435 and fixing the second contact piece 433B on the second contact unit side to the central portion on the other side.

In FIG. 36, the second contact piece 433A on the first contact unit side and the second contact piece 433B on the second contact unit side have a shape obtained by bending a conductive and rigid plate member into an approximately L-shape. The second contact piece 433A on the first contact unit side and the second contact piece 433B on the second contact unit side have notches 433aA and 433aB formed at the center in the width direction (front-rear direction) of their tips, and the portion that comes into contact with the bottom surfaces 421cA and 421cB is branched into two sections. That is, the second contact piece 433A on the first contact unit side and the second contact piece 433B on the second contact unit side are brought into contact with the bottom surfaces 421cA and 421cB of the fixed terminals 420A and 420B at two spots.

Thus, the same advantageous effects as those achieved with the configuration shown in FIG. 34 can also be achieved with the contact device 10 having the configuration shown in FIG. 36.

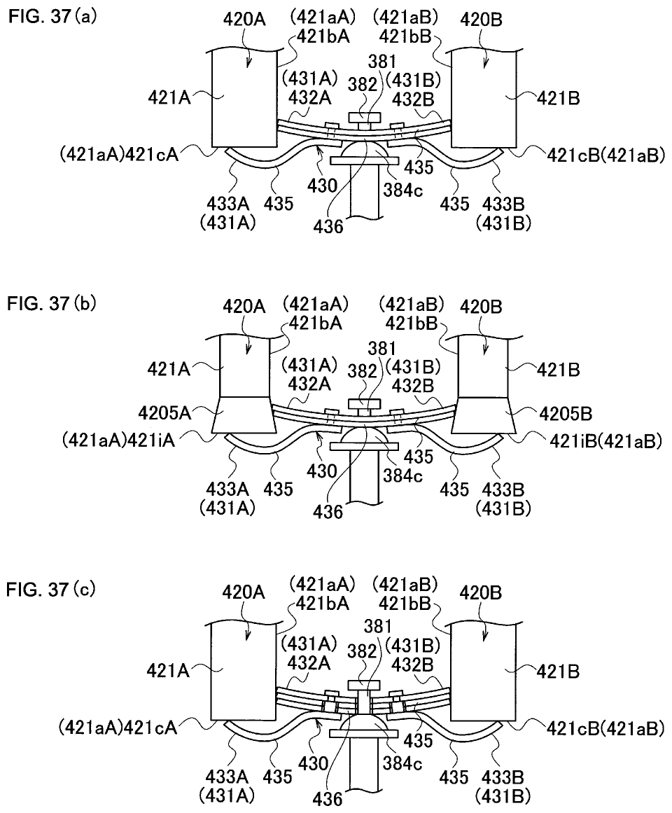

Further, as shown in FIG. 37(a), the second contact piece 433A on the first contact unit side and the second contact piece 433B on the second contact unit side may be formed of a leaf spring 435 instead of a rigid plate member.

FIG. 37(a) illustrates an example where a first contact piece 432A on the first contact unit side, a first contact piece 433B on the second contact unit side, and a base part 436 are integrally formed by stacking two conductive leaf springs 435 in the up-down direction.

The leaf spring 435 can be attached to the shaft 380 while being sandwiched between the head 382 and the support member 384c by attaching the support member 384a to the shaft main body 381 of the shaft 380 after inserting the shaft main body 381 into an insertion hole formed in the center.

The first contact piece 432A on the first contact unit side and the second contact piece 433A on the first contact unit side are integrally formed and the first contact piece 432B on the second contact unit side and the second contact piece 433B on the second contact unit side are integrally formed by fixing the second contact piece 433A on the first contact unit side formed of a single conductive leaf spring 435 to the lower surface on one side of the member in which the first contact piece 432A on the first contact unit side, the first contact piece 433B on the second contact unit side, and the base part 436 are integrally formed, and fixing the second contact piece 433B on the second contact unit side formed of a single conductive leaf spring 435 to the lower surface on the other side thereof.

Note that FIG. 37(a) shows an example where all the leaf springs 435 are fixed by caulking.

Thus, the same advantageous effects as those achieved with the configuration shown in FIG. 36 can also be achieved with the contact device 10 having the configuration shown in FIG. 37(a).

In FIG. 37(a), the first contact piece 432A on the first contact unit side and the second contact piece 433A on the first contact unit side are each formed of a flexibly deformable leaf spring 435.

Then, when a current in the same direction is applied to the juxtaposed members, force attracting each other acts on the juxtaposed members.

Therefore, when the first contact unit 431A is brought into contact with the first fixed terminal 420A, the first contact piece 432A on the first contact unit side and the second contact piece 433A on the first contact unit side sandwiching the first fixed terminal 420A is flexibly deformed in a direction of attracting each other. Thus, the force sandwiching the first fixed terminal 420A can be increased.

As a result, the conductive state between the first fixed terminal 420A and the second fixed terminal 420B can be more reliably maintained.

In FIG. 37(a), the first contact piece 432B on the second contact unit side and the second contact piece 433B on the second contact unit side are also formed of a flexibly deformable leaf spring 435.

Therefore, the same advantageous effects as those achieved on the first fixed terminal 420A side can also be achieved on the second fixed terminal 420B side.

Moreover, as shown in FIG. 37(b), the first fixed terminal 420A and the second fixed terminal 420B can also have tapered lower ends.

In FIG. 37(b), a tapered portion 4205A having a larger diameter toward the lower side is formed below the first fixed terminal 420A, and a tapered portion 4205B having a larger diameter toward the lower side is formed below the second fixed terminal 420B.

When the shaft 380 is moved upward (to one direction) in the up-down direction (one direction), the first contact piece 432A on the first contact unit side is brought into contact with a side surface (inclined surface: first surface) 421hA of the tapered portion 4205A of the first fixed terminal 420A. At the same time, the first contact piece 432B on the second contact unit side is brought into contact with a side surface (inclined surface: first surface) 421hB of the tapered portion 4205B of the second fixed terminal 420B.

The second contact piece 433A on the first contact unit side and the second contact piece 433B on the second contact unit side are brought into contact with bottom surfaces 421iA and 421iB of the tapered portions 4205A and 4205B of the fixed terminals 420A and 420B, respectively.

Thus, the same advantageous effects as those achieved with the configuration shown in FIG. 37(a) can also be achieved with the contact device 10 having the configuration shown in FIG. 37(b).

In FIG. 37(b), the first contact piece 432A on the first contact unit side and the first contact piece 432B on the second contact unit side are brought into contact with the side surfaces (inclined surfaces) 421hA and 421hB of the tapered portions 4205A and 4205B, each having a larger diameter toward the lower side. Therefore, force moving the shaft 380 upward (force in a direction of setting the first fixed terminal 420A and the second fixed terminal 420B in a conductive state) acts on the shaft 380. This makes it possible to further reduce the electromagnetic repulsion force (force in a direction of setting the first fixed terminal 420A and the second fixed terminal 420B in a non-conductive state) acting on the shaft 380.

As shown in FIG. 37(c), rather than fixing all the leaf springs 435 by caulking, at least one leaf spring 435 positioned between the leaf springs 435 located at the uppermost position and the lowermost position (the leaf spring 435 forming the second contact piece 433A on the first contact unit side and the leaf spring 435 forming the second contact piece 433B on the second contact unit side) may not be fixed by caulking. That is, the first contact piece 432A on the first contact unit side and the second contact piece 433A on the first contact unit side may be fixed and the first contact piece 432fB on the second contact unit side and the second contact piece 433B on the second contact unit side may be fixed in a state where the leaf spring 435 positioned in the middle can be moved relative to the other leaf springs 435.

In FIG. 37(c), the first contact piece 432A on the first contact unit side, the first contact piece 433B on the second contact unit side, and the base part 436 are integrally formed by stacking three leaf springs 435 in the up-down direction.

The second contact piece 433A on the first contact unit side is formed by fixing one leaf spring 435 to the lower surface of the first contact piece 432A on the first contact unit side, while the second contact piece 433B on the second contact unit side is formed by fixing one leaf spring 435 to the lower surface of the first contact piece 432B on the second contact unit side.

In this event, the first contact piece 432A on the first contact unit side and the second contact piece 433A on the first contact unit side are fixed and the first contact piece 432B on the second contact unit side and the second contact piece 433B on the second contact unit side are fixed in a state where two leaf springs 435 positioned in the middle (lower two leaf springs 435 among the leaf springs 435 forming the first contact piece 432A on the first contact unit side and the first contact piece 433B on the second contact unit side) are not fixed by caulking.

Thus, the same advantageous effects as those achieved with the configuration shown in FIG. 37(a) can also be achieved with the contact device 10 having the configuration shown in FIG. 37(c).

As shown in FIG. 37(c), by not fixing the two leaf springs 435 in the middle are not fixed by caulking, it is possible to prevent the elastic deformation of the other leaf spring 435 from being hindered by stretching of the leaf spring 435 when any of the leaf springs 435 is supported in a stretched state.

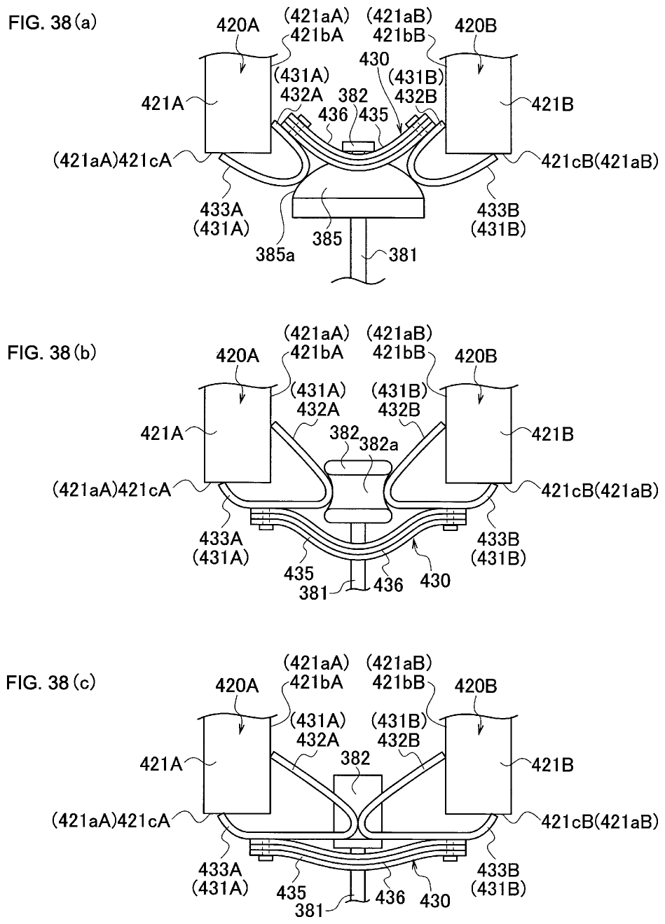

As shown in FIGS. 38(a) to 38(c), the base part 436 may be formed of a leaf spring 435 which is set in a flexed state in a non-conductive state and is set in a stretched state in a conductive state. FIGS. 38(a) to 38(c) illustrate an example where the base part 436 is formed by stacking three conductive leaf springs in the up-down direction.

Furthermore, the first contact unit 431A formed by bending a single conductive leaf spring is fixed to one side of the base part 436, and the second contact unit 431B formed by bending a single conductive leaf spring is fixed to the other side of the base part 436.

Thus, the first contact unit 431A and the second contact unit 431B are rotated when the base part 436 is elastically deformed.

Note that one side of the curved first contact unit 431A serves as a first contact piece 432A on the first contact unit side, while the other side thereof serves as a second contact piece 433A on the first contact unit side. Likewise, one side of the curved second contact unit 431B serves as a first contact piece 432B on the second contact unit side, while the other side thereof serves as a second contact piece 433B on the second contact unit side.

Here, in FIG. 38(a), the vertices of the curved first and second contact units 431A and 431B slide on a convex surface 385a formed on the support member 385 that supports the base part 436 of the shaft 380. The first contact unit 431A and the second contact unit 431B are rotated while sliding on the convex surface 385a.

In FIG. 38(b), the vertices of the curved first and second contact units 431A and 431B slide on a concave surface 382a formed on the head 382 of the shaft 380. The first contact unit 431A and the second contact unit 431B are rotated while sliding on the concave surface 382a.

In FIG. 38(c), the vertices of the curved first contact unit 431A and the curved second contact unit 431B slide in contact with each other on the head 382 of the shaft 380. The first contact unit 431A and the second contact unit 431B are rotated by sliding of the vertices of the first and second contact units 431A and 431B.

Thus, the same advantageous effects as those achieved with the configuration shown in FIG. 34 can also be achieved with the contact device 10 having the configuration shown in FIGS. 38(a) to 38(c).

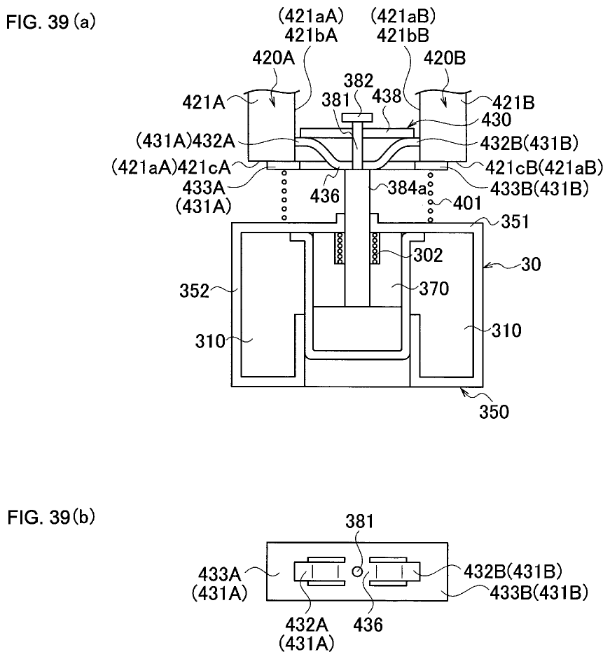

As shown in FIG. 39, a first contact unit 431A having a first contact piece 432A on the first contact unit side and a second contact piece 433A on the first contact unit side, a second contact unit 431B having a first contact piece 432B on the second contact unit side and a second contact piece 433B on the second contact unit side, and a base part 436 in which the first contact unit 431A and the second contact unit 431B may be integrally formed using a single plate member.

In FIG. 39, cut-and-raised pieces are formed by cutting and raising two central portions of a single conductive plate member, and those cut-and-raised pieces are used as the first contact piece 432A on the first contact unit side and the first contact piece 432B of the second contact unit side.

The base portion of the two cut-and-raised pieces serves as the base part 436 connected to the shaft 380 (pressed by the shaft 380).

The uncut portions at both ends in the left-right direction (longitudinal direction) of the single plate member serve as the second contact piece 433A on the first contact unit side and the second contact piece 433B on the second contact unit side.

The movable contact 430 shown in FIG. 39 includes a rigid plate member 438 that extends approximately in the horizontal direction and is disposed above the first contact piece 432A on the first contact unit side and the first contact piece 432B on the second contact unit side. The first contact piece 432A on the first contact unit side and the first contact piece 432B on the second contact unit side slide on the lower surface of the plate member 438.

Thus, the same advantageous effects as those achieved with the configuration shown in FIG. 34 can also be achieved with the contact device 10 having the configuration shown in FIG. 39.

A movable contact 430 can be manufactured more easily by using a single plate member to integrally form a first contact unit 431A having a first contact piece 432A on the first contact unit side and a second contact piece 433A on the first contact unit side, a second contact unit 431B having a first contact piece 432B on the second contact unit side and a second contact piece 433B on the second contact unit side, and a base part 436 in which the first contact unit 431A and the second contact unit 431B are connected.

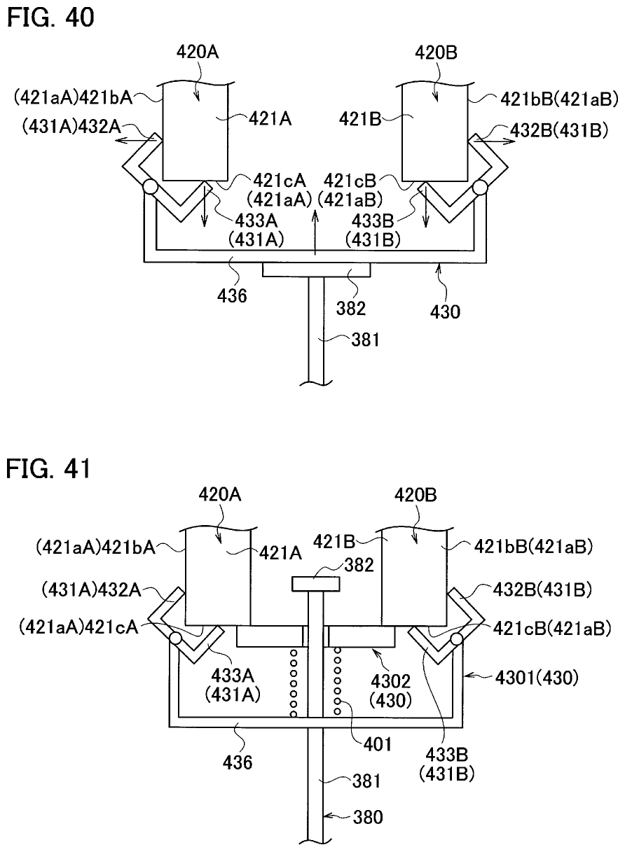

The contact device 10 may also have a configuration shown in FIG. 40.

A movable contact 430 shown in FIG. 40 has a base part 436 connected to the shaft 380 (pressed by the shaft 380). In FIG. 40, the base part 436 is formed of a conductive and rigid plate member, and has a shape bent into an approximately U-shape. The base part 436 is placed on the head 382 of the shaft 380.

A first contact unit 431A is rotatably connected to one side end of the base part 436, and a second contact unit 431B is rotatably connected to the other side end thereof.

In FIG. 40, again, the first contact unit 431A has a shape obtained by bending a rigid plate member into an approximately U-shape, and this first contact unit 431A is also formed using a conductive material. One side of the first contact unit 431A serves as a first contact piece 432A on the first contact unit side, while the other side thereof serves as a second contact piece 433A on the first contact unit side.

Likewise, the second contact unit 431B has a shape obtained by bending a rigid plate member into an approximately U-shape, and this second contact unit 431B is also formed using a conductive material. One side of the second contact unit 431B serves as a first contact piece 432B on the second contact unit side, while the other side thereof serves as a second contact piece 433B on the second contact unit side.

When the shaft 380 is moved upward (to one side) in the up-down direction (one direction), the first contact piece 432A on the first contact unit side and the first contact piece 432B on the second contact unit side come into contact with outer side surfaces 421bA and 421bA of the fixed terminals 420A, 420B, while the second contact piece 433A on the first contact unit side and the second contact piece 433B on the second contact unit side come into contact with lower surfaces 421cA and 421cB of the fixed terminals 420A and 420B.

That is, the first contact unit 431A is brought into contact with the first fixed terminal 420A while sandwiching the first fixed terminal 420A between the first contact piece 432A on the first contact unit side and the second contact piece 433A on the first contact unit side, which are integrally formed.

In this event, the first contact piece 432A on the first contact unit side is brought into contact with the outer side surface (first surface) 421bA of the first fixed terminal 420A in a stretched manner in a state of being pressed upward (to one side) in the up-down direction (one direction) by the shaft 380. Meanwhile, the second contact piece 433A on the first contact unit side is brought into contact with the bottom surface (second surface) 421cA of the first fixed terminal 420A in a stretched manner in a state of being pressed upward (to one side) in the up-down direction (one direction) by the shaft 380.

The second contact unit 431B is brought into contact with the second fixed terminal 420B while sandwiching the second fixed terminal 420B between the first contact piece 432B on the second contact unit side and the second contact piece 433B on the second contact unit side, which are integrally formed.

In this event, the first contact piece 432B on the second contact unit side is brought into contact with the outer side surface (first surface) 421bB of the second fixed terminal 420B in a stretched manner in a state of being pressed upward (to one side) in the up-down direction (one direction) by the shaft 380. Meanwhile, the second contact piece 433B on the second contact unit side is brought into contact with the bottom surface (second surface) 421cB of the second fixed terminal 420B in a stretched manner in a state of being pressed upward (to one side) in the up-down direction (one direction) by the shaft 380.

On the other hand, when the shaft 380 is moved downward (to the other side) in the up-down direction (one direction), one side of the first contact unit 431A (the first contact piece 432A on the first contact unit side) is separated from the outer side surface 421bA of the first fixed terminal 420A, and the other side of the first contact unit 431A (the second contact piece 433A on the first contact unit side) is separated from the bottom surface 421cA of the first fixed terminal 420A.

Likewise, when the shaft 380 is moved downward (to the other side) in the up-down direction (one direction), one side of the second contact unit 431B (the first contact piece 432B on the second contact unit side) is separated from the outer side surface 421bB of the second fixed terminal 420B, and the other side of the second contact unit 431B (the second contact piece 433B on the second contact unit side) is separated from the bottom surface 421cB of the second fixed terminal 420B.

As described above, in the configuration shown in FIG. 40, the outer side surface (first surface) 421bA of the first fixed terminal 420A is an intersecting surface that intersects with a plane perpendicular to the up-down direction (one direction). The bottom surface 421cA of the first fixed terminal 420A is a second surface that intersects with the side surface (first surface) 421bA of the first fixed terminal 420A.

Moreover, the outer side surface (first surface) 421bB of the second fixed terminal 420B is an intersecting surface that intersects with a plane perpendicular to the up-down direction (one direction). The bottom surface 421cB of the second fixed terminal 420B is a second surface that intersects with the side surface (first surface) 421bB of the second fixed terminal 420B.

In FIG. 40, again, the first contact piece 432A on the first contact unit side includes a rigid plate member 434A, and the first contact piece 432B on the second contact unit side includes a rigid plate member 434B.

Thus, the same advantageous effects as those achieved with the configuration shown in FIG. 34 can also be achieved with the contact device 10 having the configuration shown in FIG. 40.

The contact device 10 may also have a configuration shown in FIG. 41.

A movable contact 430 shown in FIG. 41 includes a first movable contact main body 4301 having the configuration shown in FIG. 40 and a second movable contact main body 4302 provided separately from the first movable contact main body 4301.

That is, the first movable contact main body 4301 shown in FIG. 41 also has an approximately U-shaped first contact unit 431A rotatably connected to one side tip of a base part 436 having an approximately U-shaped plate shape, and has an approximately U-shaped second contact unit 431B rotatably connected to the other side tip thereof. Note that, in FIG. 41, a shaft main body 381 of a shaft 380 is fixed to the base part 436.

In the configuration shown in FIG. 41, again, the base part 436, the first contact unit 431A, and the second contact unit 431B are formed of a conductive and rigid plate member.

On the other hand, the second movable contact main body 4302 has approximately the same configuration as the second movable contact main body 4302 shown in FIG. 17. That is, the second movable contact main body 4302 shown in FIG. 41 also extends approximately in the horizontal direction, and is formed of an approximately plate-shaped rigid member. This approximately plate-shaped member constituting the second movable contact main body 4302 is also formed using a conductive material.

In FIG. 41, again, the second movable contact main body 4302 is arranged below the first fixed terminal 420A and the second fixed terminal 420B. In this event, the upper surface of the second movable contact main body 4302 faces the bottom surface 421cA of the first fixed terminal 420A and the bottom surface 421cB of the second fixed terminal 420B.

The second movable contact main body 4302 is attached to the shaft 380 so as to be relatively movable by inserting the shaft 380 into an insertion hole formed at the center. Thus, in FIG. 41, again, the second movable contact main body 4302 is attached to the shaft 380 so as to be movable relative to the first movable contact main body 4301. In the configuration shown in FIG. 41, a contact pressure spring 401 is disposed between the base part 436 and the second movable contact main body 4302, and the second movable contact main body 4302 is moved upward by the contact pressure spring 401.

When the shaft 380 is moved upward (to one side) in the up-down direction (one direction), the first contact piece 432A on the first contact unit side and the first contact piece 432B on the second contact unit side come into contact with outer side surfaces 421bA and 421bA of the fixed terminals 420A, 420B, and the second contact piece 433A on the first contact unit side and the second contact piece 433B on the second contact unit side come into contact with lower surfaces 421cA and 421cB of the fixed terminals 420A and 420B. Furthermore, the upper surface on one side of the second movable contact main body 4302 comes into contact with the bottom surface 421cA of the first fixed terminal 420A, and the upper surface on the other side comes into contact with the bottom surface 421cB of the second fixed terminal 420B.

On the other hand, when the shaft 380 is moved downward (to the other side) in the up-down direction (one direction), the first contact piece 432A on the first contact unit side and the first contact piece 432B on the second contact unit side are separated from the outer side surfaces 421bA and 421bA of the fixed terminals 420A and 420B, and the second contact piece 433A on the first contact unit side and the second contact piece 433B on the second contact unit side are separated from the lower surfaces 421cA and 421cB of the fixed terminals 420A and 420B. Furthermore, the upper surface on one side of the second movable contact main body 4302 is separated from the bottom surface 421cA of the first fixed terminal 420A, and the upper surface on the other side is separated from the bottom surface 421cB of the second fixed terminal 420B.

Thus, the same advantageous effects as those achieved with the configurations shown in FIGS. 17 and 40 can also be achieved with the contact device 10 having the configuration shown in FIG. 41.

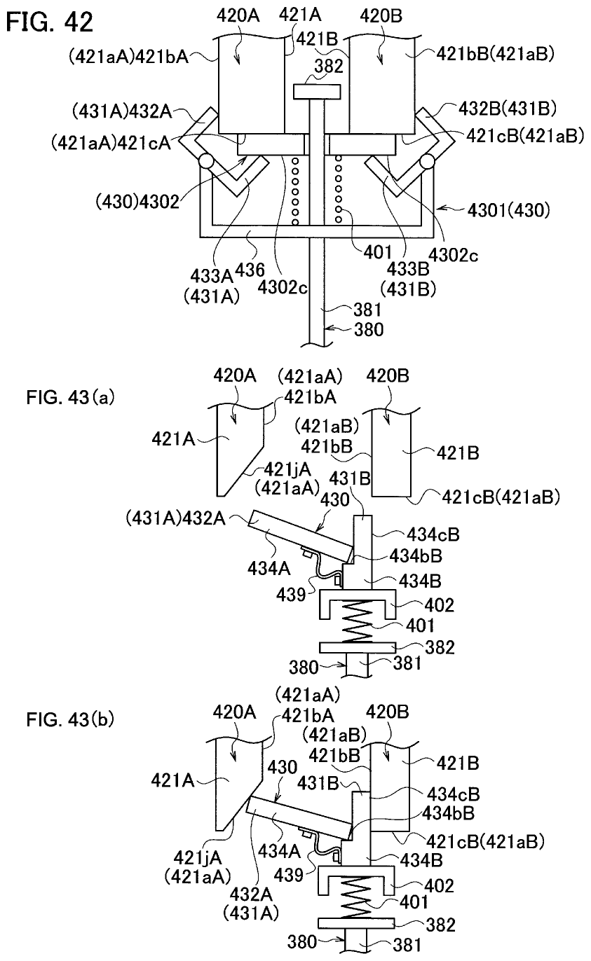

When the first movable contact main body 4301 having the shape shown in FIG. 41 and the second movable contact main body 4302 having the shape shown in FIG. 41 are provided, a configuration shown in FIG. 42 may be employed.

In FIG. 42, when the shaft 380 is moved upward (to one side) in the up-down direction (one direction), the first contact piece 432A on the first contact unit side and the first contact piece 432B on the second contact unit side come into contact with the outer side surfaces 421bA and 421bA of the fixed terminals 420A and 420B, and the second contact piece 433A on the first contact unit side and the second contact piece 433B on the second contact unit side come into contact with the lower surface 4302c of the second movable contact main body 4302.

In the configuration shown in FIG. 42, again, the first movable contact main body 4301 and the second movable contact main body 4302 are formed of conductive and rigid plate members.

Thus, the same advantageous effects as those achieved with the configuration shown in FIG. 41 can also be achieved with the contact device 10 having the configuration shown in FIG. 42.

In FIG. 42, the first contact piece 432A on the first contact unit side and the first contact piece 432B on the second contact unit side are brought into contact with the outer side surfaces 421bA and 421bA of the fixed terminals 420A and 420B, while the second contact piece 433A on the first contact portion side and the second contact piece 433B on the second contact unit side are brought into contact with the lower surface 4302c of the second movable contact main body 4302. That is, the second movable contact main body 4302 is locked by the first movable contact main body 4301 in a contact state with each fixed terminal. Thus, not only the separation of the first movable contact main body 4301 from each fixed terminal but also the separation of the second movable contact main body 4302 from each fixed terminal can be suppressed. Therefore, the reliability of the contact can be more reliably improved.

Note that, in the case of the shape shown in FIG. 42, it is also possible to use a lock member 4301 formed to have approximately the same shape as the first movable contact main body 4301 shown in FIG. 42 with an insulating material (for example, a heat-resistant and rigid resin) instead of the first movable contact main body 4301. In this case, the second movable contact main body 4302 serves as the conductive part 430a of the movable contact 430, and the first contact piece 432A on the first contact unit side and the first contact piece 432B on the second contact unit side of the lock member 4301 are no longer included in the conductive part 430a. However, with such a configuration, the separation from each fixed terminal due to electromagnetic repulsion force of the second movable contact main body 4302 is suppressed by the insulating lock member 4301. This makes it possible to improve the reliability of the contact more reliably.

The contact device 10 may also have a configuration shown in FIG. 43.

FIG. 43 shows a configuration in which a movable contact 430 is supported in a stretched state only on the first fixed terminal 420A side in a contact device 10 including a first fixed terminal 420A and a second fixed terminal 420B.

In FIG. 43, the movable contact 430 is formed by connecting rigid plate members 434A and 434B with a leaf spring (connecting member) 439. To be more specific, the plate member 434B is disposed so as to extend in the up-down direction, and a step portion 434bB is formed in the plate member 434B. The movable contact 430 is formed by connecting the plate member 434A and the plate member 434B with the leaf spring (connecting member) 439 in a state where the end of the plate member 434A is placed on the step portion 434bB of the plate member 434B. In this event, the plate member 434A is connected to the plate member 434B such that the plate member 434A can be rotated relative to the plate member 434B while maintaining a state of being electrically connected to the plate member 434B. Furthermore, in the configuration shown in FIG. 43, a contact pressure spring 401 is disposed between the spring receiver 402 and the head 382 of the shaft (moving body) 380, and the plate member 434B of the movable contact 430 is pressed upward by the contact pressure spring 401 through the spring receiver 402. Thus, in FIG. 43, the contact pressure spring 401 and the spring receiver 402 arranged on the shaft 380 correspond to the pressing body.

Note that an inclined surface 421jA that is inclined so that the second fixed terminal 420B side is set as the upper side is formed at the lower end of the first fixed terminal 420A.

When the shaft 380 is moved upward (to one side) in the up-down direction (one direction), the side surface 434cB of the plate member 434B slides on the side surface 421bB of the second fixed terminal 420B, and the plate member 434A has its tip (the first contact piece 432A on the first contact unit side) come into contact with the inclined surface 421jA of the first fixed terminal 420A. In this event, the tip of the plate member 434A (the first contact piece 432A on the first contact unit side) comes into contact with the inclined surface 421jA of the first fixed terminal 420A while being biased upward by the contact pressure spring 401 and the leaf spring (connecting member) 439.

Note that, in FIG. 43, the inclined surface 421jA of the first fixed terminal 420A corresponds to the first surface (first surface of the first fixed terminal 420A) with which the first contact unit 431A comes into contact from a direction intersecting with the up-down direction (one direction). Therefore, when the conductive part 430a of the movable contact 430 comes into contact with the inclined surface 421jA of the first fixed terminal 420A, electromagnetic repulsion force is generated in a direction different from the downward direction (the other side in one direction). The inclined surface 421jA (the first surface of the first fixed terminal 420A) is an intersecting surface that intersects with a plane (horizontally extending plane) perpendicular to the up-down direction (one direction). Furthermore, in the configuration shown in FIG. 43, again, the plate member 434A is in contact with the inclined surface 421jA of first fixed terminal 420A in a stretched state.

On the other hand, when the shaft 380 is moved downward (to the other side) in the up-down direction (one direction), the side surface 434cB of the plate member 434B is separated from the side surface 421bB of the second fixed terminal 420B, and the plate member 434A has its tip (the first contact piece 432A on the first contact unit side) separated from the inclined surface 421jA of the first fixed terminal 420A.

Thus, the same advantageous effects as in the above embodiment can also be achieved with the contact device 10 having the configuration shown in FIG. 43.

Note that FIG. 43 illustrates an example where the movable contact 430 is separated from the first fixed terminal 420A and the second fixed terminal 420B during a non-conductive state. However, the movable contact 430 may also be separated only from the first fixed terminal 420A during the non-conductive state. That is, it is also possible to adopt a configuration in which, during the non-conductive state, the tip of the plate member 434A (the first contact piece 432A on the first contact unit side) is separated from the inclined surface 421jA of the first fixed terminal 420A in a state where the side surface 434cB of the plate member 434B is in contact with the side surface 421bB of the second fixed terminal 420B.

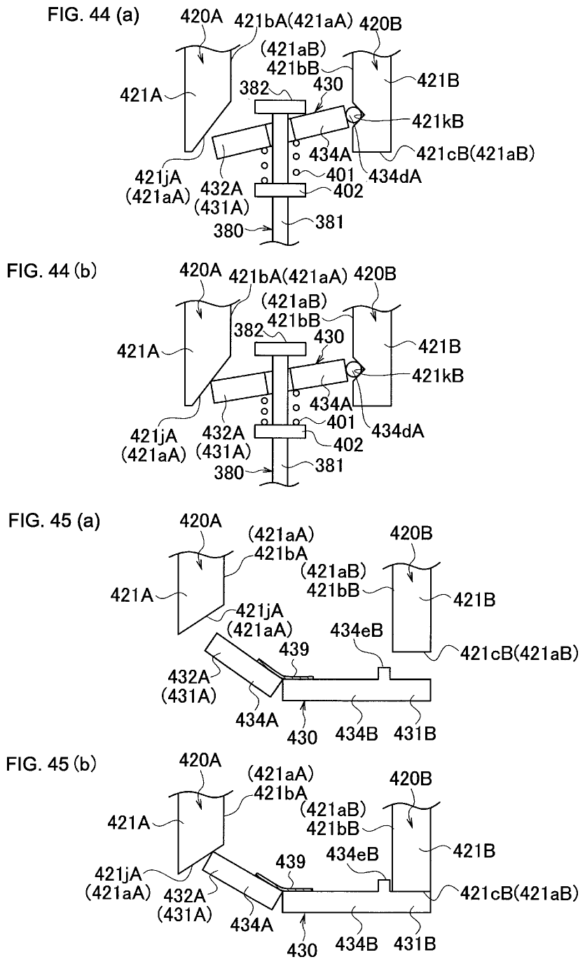

The contact device 10 may also have a configuration shown in FIG. 44.

In FIG. 44, a movable contact 430 is formed of a rigid plate member 434A, and the plate member 434A has its end always in contact with the second fixed terminal 420B. To be more specific, a rotating shaft part 434dA is provided at an end of the plate member 434A, and a bearing recess part 421kB is provided in the second fixed terminal main body 421B of the second fixed terminal 420B. Then, the rotating shaft part 434dA of the plate member 434A is attached to the bearing recess part 421kB of the second fixed terminal main body 421B. Thus, the plate member 434A can be rotated relative to the second fixed terminal 420B in a state where the rotating shaft part 434dA of the plate member 434A is always in contact with the bearing recess part 421kB of the second fixed terminal main body 421B.

In FIG. 44, the plate member 434A (movable contact 430) is attached to the shaft 380 so as to be relatively movable by inserting the shaft (moving body) 380 into an insertion hole formed at the center. Furthermore, in the configuration shown in FIG. 44, a spring receiver 402 is formed below the movable contact 430 of the shaft 380, and the movable contact 430 is pressed upward by a contact pressure spring 401 disposed between the spring receiver 402 and the movable contact 430. Thus, in FIG. 44, the contact pressure spring 401 disposed on the spring receiver 402 corresponds to the pressing body.

Note that, in FIG. 44, again, an inclined surface 421jA that is inclined so that the second fixed terminal 420B side is set as the upper side is formed at the lower end of the first fixed terminal 420A.

When the shaft 380 is moved upward (to one side) in the up-down direction (one direction), the tip of the plate member 434A (the first contact piece 432A on the first contact unit side) comes into contact with the inclined surface 421jA of the first fixed terminal 420A in a state where the rotating shaft part 434dA of the plate member 434A is in contact with the bearing recess part 421kB of the second fixed terminal main body 421B. In this event, the tip of the plate member 434A (the first contact piece 432A on the first contact unit side) is in contact with the inclined surface 421jA of the first fixed terminal 420A while being biased upward by the contact pressure spring 401.

Note that, in FIG. 44, again, the inclined surface 421jA of the first fixed terminal 420A corresponds to the first surface (first surface of the first fixed terminal 420A) with which the first contact unit 431A comes into contact from a direction intersecting with the up-down direction (one direction). Therefore, when the conductive part 430a of the movable contact 430 comes into contact with the inclined surface 421jA of the first fixed terminal 420A, electromagnetic repulsion force is generated in a direction different from the downward direction (the other side in one direction). The inclined surface 421jA (the first surface of the first fixed terminal 420A) is an intersecting surface that intersects with a plane (horizontally extending plane) perpendicular to the up-down direction (one direction). Furthermore, in the configuration shown in FIG. 44, again, the plate member 434A is in contact with the inclined surface 421jA of the first fixed terminal 420A in a stretched state.

On the other hand, when the shaft 380 is moved downward (to the other side) in the up-down direction (one direction), the tip of the plate member 434A (the first contact piece 432A on the first contact unit side) is separated from the inclined surface 421jA of the first fixed terminal 420A in a state where the rotating shaft part 434dA of the plate member 434A is in contact with the bearing recess part 421kB of the second fixed terminal main body 421B.

Thus, the same advantageous effects as those achieved with the configuration shown in FIG. 43 can also be achieved with the contact device 10 having the configuration shown in FIG. 44.

The contact device 10 may also have a configuration shown in FIG. 45.

FIG. 45 also shows a configuration in which a movable contact 430 is supported in a stretched state only on the first fixed terminal 420A side in a contact device 10 including a first fixed terminal 420A and a second fixed terminal 420B.

In FIG. 45, the movable contact 430 is formed by connecting rigid approximately rectangular parallelepiped plate members 434A and 434B elongated in the left-right direction with a leaf spring (connecting member) 439.

To be more specific, an approximately V-shaped movable contact 430 is formed by connecting one side of the leaf spring 439 to the upper surface of the plate member 434A and connecting the other side of the leaf spring 439 to the upper surface of the plate member 434B in a state where one end of the plate member 434A and one end of the plate member 434B are in contact with each other. Thus, the plate members 434A and 434B are supported so as to be relatively rotatable around the ends that come into contact with each other. Although not shown, in the configuration shown in FIG. 45, again, the movable contact 430 is moved with the movement of the shaft (moving body) and is pressed upward by a contact pressure spring. In FIG. 45, again, an inclined surface 421jA that is inclined so that the second fixed terminal 420B side is set as the upper side is formed at the lower end of the first fixed terminal 420A.

Here, in FIG. 45, a protrusion 434eB that protrudes upward is formed above the plate member 434B, and the plate member 434B comes into contact with the bottom surface 421cB of the second fixed terminal 420B on the side closer to the tip than the protrusion 434eB (opposite to the side of the plate member 434B where the plate member 434A is connected).

When the shaft (moving body) is moved upward (to one side) in the up-down direction (one direction), the upper surface of the plate member 434B comes into contact with the bottom surface 421cB of the second fixed terminal 420B, and the tip of the plate member 434A (the first contact piece 432A on the first contact unit side) comes into contact with the inclined surface 421jA of the first fixed terminal 420A. In this event, the tip of the plate member 434A (the first contact piece 432A on the first contact unit side) comes into contact with the inclined surface 421jA of the first fixed terminal 420A in a state of being biased upward by the contact pressure spring and the leaf spring (connecting member) 439.

In FIG. 45, again, the inclined surface 421jA of the first fixed terminal 420A corresponds to the first surface (the first surface of the first fixed terminal 420A) with which the first contact unit 431A comes into contact from a direction intersecting the up-down direction (one direction). Therefore, when the conductive part 430a of the movable contact 430 comes into contact with the inclined surface 421jA of the first fixed terminal 420A, electromagnetic repulsion force is generated in a direction different from the downward direction (the other side in one direction). The inclined surface 421jA (the first surface of the first fixed terminal 420A) is an intersecting surface that intersects with a plane (horizontally extending plane) perpendicular to the up-down direction (one direction). Furthermore, in the configuration shown in FIG. 45, again, the plate member 434A is in contact with the inclined surface 421jA of the first fixed terminal 420A in a stretched state.

On the other hand, when the shaft (moving body) is moved downward (to the other side) in the up-down direction (one direction), the upper surface of the plate member 434B is separated from the bottom surface 421cB of the second fixed terminal 420B, and the tip of the plate member 434A (the first contact piece 432A on the first contact unit side) is separated from the inclined surface 421jA of the first fixed terminal 420A.

Thus, the same advantageous effects as those achieved with the configuration shown in FIG. 43 can also be achieved with the contact device 10 having the configuration shown in FIG. 45.

Note that, in FIG. 45, again, the movable contact 430 may be separated only from the first fixed terminal 420A during a non-conductive state.

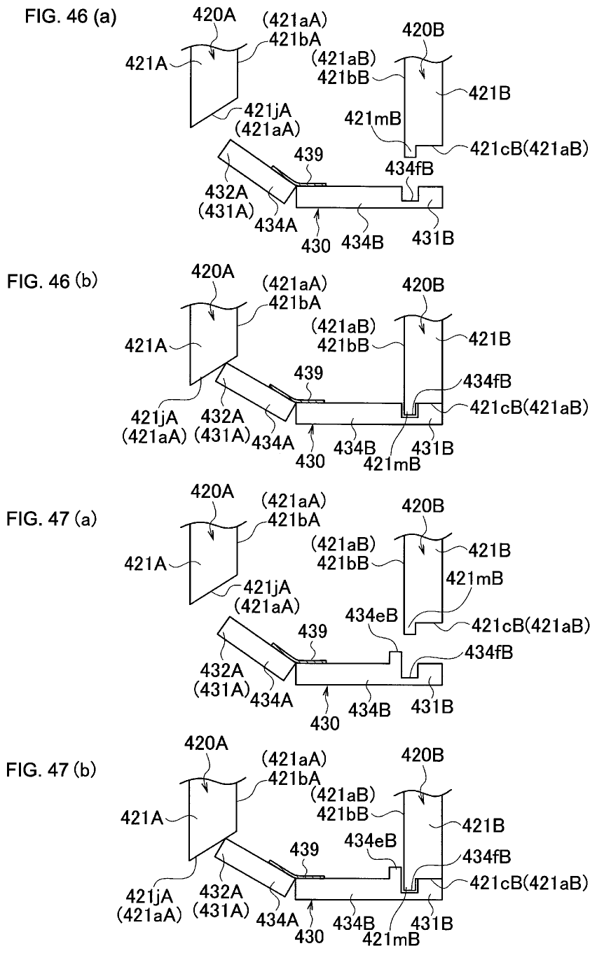

As shown in FIG. 46, a recess part 434fB that is recessed downward is formed in the upper part of the plate member 434B, and a protrusion 421mB that protrudes downward is formed in the second fixed terminal 420B. The plate member 434B may be brought into contact with the bottom surface 421cB of the second fixed terminal 420B in a state where the protrusion 421mB is inserted into the recess part 434fB.

In FIG. 46, again, the movable contact 430 can be separated only from the first fixed terminal 420A during a non-conductive state.

As shown in FIG. 47, a protrusion 434eB protruding upward and a recess part 434fB protruding downward may be formed above the plate member 434B, and a protrusion 421mB protruding downward may be formed on the second fixed terminal 420B. In this case, the plate member 434B comes into contact with the bottom surface 421cB of the second fixed terminal 420B on the side closer to the tip than the protrusion 434eB (opposite to the side of the plate member 434B where the plate member 434A is connected) in a state where the protrusion 421mB is inserted into the recess part 434fB..

In FIG. 47, again, the movable contact 430 can be separated only from the first fixed terminal 420A during a non-conductive state.

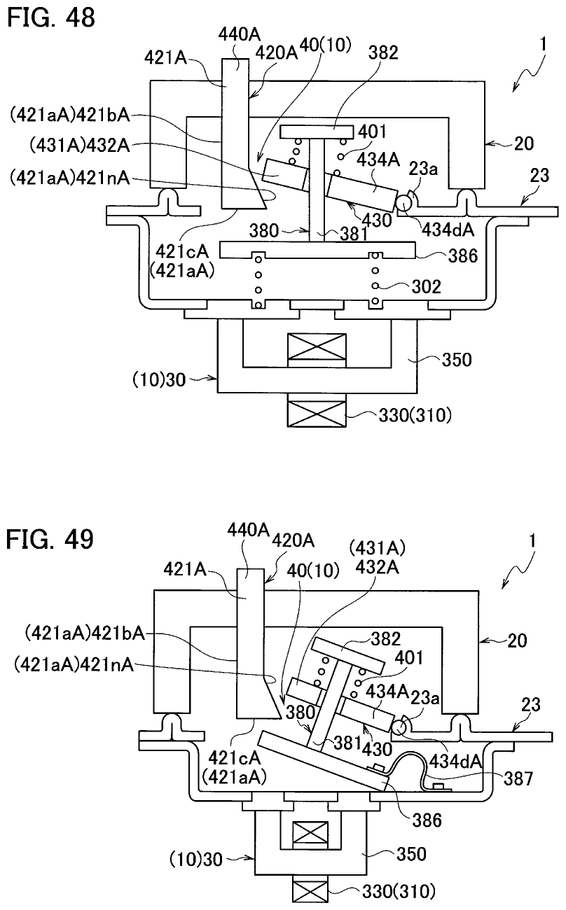

Alternatively, as shown in FIG. 48, an electromagnetic relay 1 may include only the first fixed terminal 420A of the first and second fixed terminals 420A and 420B.

The electromagnetic relay 1 shown in FIG. 48 is equipped with a contact device 10 configured by integrally combining a drive block (drive unit) 30 and a contact block (contact unit) 40. To be more specific, the electromagnetic relay 1 equipped with the contact device 10 is formed by attaching the contact device 10 to a case 20 formed in an approximately hollow box shape. In FIG. 48, the contact device 10 is attached to the case 20 in a state where the contact device 10 is partially housed in the case 20 and partially arranged outside the case 20. Note that the electromagnetic relay 1 equipped with the contact device 10 can also be formed by housing the contact device 10 in the case 20.

In FIG. 48, the drive block 30 includes a coil unit 310. The coil unit 310 includes a coil 330 that generates a magnetic flux when energized.

When the coil 330 is energized, the drive block 30 is driven, and the drive of the drive block 30 opens and closes contacts of the contact block 40. Here, as described above, the electromagnetic relay 1 shown in FIG. 48 is provided with no second fixed terminal 420B. That is, in the electromagnetic relay 1 shown in FIG. 48, the movable contact 430 is brought into contact with and away from the first fixed terminal 420A by switching on and off of the drive block (drive unit) 30, thereby switching opening and closing of the contact of the contact block 40.

The drive block 30 shown in FIG. 48 includes a yoke 350 formed in an approximately U-shape using a magnetic material, and the coil 330 is wound around a bottom wall of the yoke 350. Note that an approximately cylindrical coil bobbin 320 may be used, and the bottom wall of the yoke 350 may be inserted into the cylinder of the coil bobbin 320, and the coil 330 may be wound around the outer surface of the coil bobbin 320.

In FIG. 48, the coil unit 310 and the yoke 350 are attached to the case 20 from outside.

The drive block 30 includes an approximately plate-shaped armature 386, and the armature 386 is disposed inside the case 20. In this event, both ends of the armature 386 are opposed to the ends of the approximately U-shaped yoke 350, respectively. Furthermore, in FIG. 48, a return spring 302 formed of a coil spring is disposed between the armature 386 and the bottom wall of the case 20. During a non-conductive state, the return spring 302 causes the armature 386 to be separated from the yoke 350 (the bottom wall of the case 20).

The contact block 40 includes a first fixed terminal 420A, and the first fixed terminal 420A includes an approximately columnar first fixed terminal main body 421A.

In FIG. 48, the first fixed terminal main body 421A is fixed to the case 20 in a state where the other end side thereof penetrates the case 20 and protrudes outside the case 20. The portion protruding outside the case 20 is a first bus bar (first conductive member) 440A connected to an external load or the like.

Note that an inclined surface 421nA that is inclined so that the side where the movable contact 430 is located is set as the lower side is formed at the lower end of the first fixed terminal 420A.

Furthermore, the contact block 40 includes a movable contact 430 that comes into contact with and away from the first fixed terminal 420A by moving relative to the first fixed terminal 420A.

In FIG. 48, the movable contact 430 is formed of a rigid plate member 434A, the plate member 434A has its end always in contact with a bearing member 23 formed on the case 20. To be more specific, a rotating shaft part 434dA is provided at the end of the plate member 434A, and a bearing recess part 23a is provided at the tip of the bearing member 23 extending inward. The rotating shaft part 434dA of the plate member 434A is attached to the bearing recess part 23a of the bearing member 23. In this event, the plate member 434A can be rotated relative to the bearing member 23 in a state where the rotating shaft part 434dA of the plate member 434A is always in contact with the bearing recess part 23a of the bearing member 23.

Note that a portion of the case 20 where the first fixed terminal 420A is fixed is formed of an insulating material, and a portion thereof where the bearing member 23 is formed is formed of a conductive material. The bearing member 23 has its other end (outer end) electrically connected to an external load or the like.

In FIG. 48, a shaft (moving body) 380 is attached to the upper surface of the armature 386 so as to extend in the up-down direction. The plate member 434A (movable contact 430) is relatively movably attached to the shaft 380 by inserting the shaft 380 into an insertion hole formed at the center. Furthermore, in the configuration shown in FIG. 48, the movable contact 430 is pressed downward by the contact pressure spring 401 disposed between the head 382 of the shaft 380 and the movable contact 430. That is, the movable contact 430 is pressed downward by the contact pressure spring 401 (force rotating the tip to move downward is transmitted). This contact pressure spring 401 corresponds to the pressing body.

With such a configuration, when the coil 330 is not energized, the armature 386 is held in a separated state from the yoke 350 by the upward biasing force of the return spring 302. In this event, the movable contact 430 is lifted (to the other side) in the up-down direction (one direction) by the shaft 380, and is set in a state of being separated from the first fixed terminal 420A (off state).

When the coil 330 is energized from this off state, the armature 386 is attracted to the yoke 350 against the elastic restoring force of the return spring 302 by the electromagnetic force, and the armature 386 is moved downward (to one side) in the up-down direction (one direction) so as to approach the yoke 350. Thus, when the armature 386 is moved downward, the shaft 380 is also moved downward, and the movable contact 430 is also rotated so as to have its tip moved downward by the elastic restoring force of the contact pressure spring 401. Thus, the tip of the movable contact 430 comes into contact with the inclined surface 421nA of the first fixed terminal 420A to turn on the electromagnetic relay 1 (contact device 10).

In this event, the tip of the plate member 434A (the first contact piece 432A on the first contact unit side) comes into contact with the inclined surface 421nA of the first fixed terminal 420A while being biased downward by the contact pressure spring 401. In FIG. 48, again, the plate member 434A is in contact with the inclined surface 421nA of the first fixed terminal 420A in a stretched state.

Thus, the same advantageous effects as those achieved with the electromagnetic relay 1 and the contact device 10 described in the above embodiment can also be achieved.

Alternatively, an electromagnetic relay 1 shown in FIG. 49 may be realized.

The electromagnetic relay 1 shown in FIG. 49 also has a contact device 10 configured by integrally combining a drive block (drive unit) 30 and a contact block (contact unit) 40. To be more specific, the electromagnetic relay 1 equipped with the contact device 10 is formed by attaching the contact device 10 to a case 20 formed in an approximately hollow box shape. In FIG. 49, again, the contact device 10 is attached to the case 20 in a state where the contact device 10 is partially housed in the case 20 and partially arranged outside the case 20. Note that the electromagnetic relay 1 equipped with the contact device 10 can be formed by housing the contact device 10 in the case 20.

In FIG. 49, again, the drive block 30 includes a coil unit 310, and the coil unit 310 includes a coil 330 that generates a magnetic flux when energized.

When the coil 330 is energized, the drive block 30 is driven, and the drive of the drive block 30 opens and closes contacts of the contact block 40. Here, the electromagnetic relay 1 shown in FIG. 49 is also provided with no second fixed terminal 420B. That is, in the electromagnetic relay 1 shown in FIG. 49, again, the movable contact 430 is brought into contact with and away from the first fixed terminal 420A by switching on and off of the drive block (drive unit) 30, thereby switching opening and closing of the contact of the contact block 40.

The drive block 30 shown in FIG. 49 also includes a yoke 350 formed in an approximately U-shape using a magnetic material, and the coil 330 is wound around a bottom wall of the yoke 350. Note that an approximately cylindrical coil bobbin 320 may be used, and the bottom wall of the yoke 350 may be inserted into the cylinder of the coil bobbin 320, and the coil 330 may be wound around the outer surface of the coil bobbin 320.

In FIG. 49, again, the coil unit 310 and the yoke 350 are attached to the case 20 from outside.

Here, the drive block 30 shown in FIG. 49 includes an armature 386 having an approximately flat plate shape in a side view, and the armature 386 is disposed inside the case 20. The armature 386 is swingably supported on the bottom wall of the case 20 by a hinge spring 387. During a non-conductive state, the armature 386 is separated from the yoke 350 by the hinge spring 387.

The contact block 40 includes a first fixed terminal 420A, and the first fixed terminal 420A includes an approximately columnar first fixed terminal main body 421A. In FIG. 49 the first fixed terminal main body 421A is fixed to the case 20 in a state where the other end side thereof penetrates the case 20 and protrudes outside the case 20. The portion protruding outside the case 20 is a first bus bar (first conductive member) 440A connected to an external load or the like.

Note that an inclined surface 421nA that is inclined so that the side where the movable contact 430 is located is set as the lower side is formed at the lower end of the first fixed terminal 420A.

Furthermore, the contact block 40 includes a movable contact 430 that comes into contact with and away from the first fixed terminal 420A by moving relative to the first fixed terminal 420A.

In FIG. 49, again, the movable contact 430 is formed of a rigid plate member 434A, the plate member 434A has its end always in contact with a bearing member 23 formed on the case 20. To be more specific, a rotating shaft part 434dA is provided at the end of the plate member 434A, and a bearing recess part 23a is provided at the tip of the bearing member 23 extending inward. The rotating shaft part 434dA of the plate member 434A is attached to the bearing recess part 23a of the bearing member 23. In this event, the plate member 434A can be rotated relative to the bearing member 23 in a state where the rotating shaft part 434dA of the plate member 434A is always in contact with the bearing recess part 23a of the bearing member 23.

Note that a portion of the case 20 where the first fixed terminal 420A is fixed is formed of an insulating material, and a portion thereof where the bearing member 23 is formed is formed of a conductive material. The bearing member 23 has its other end (outer end) electrically connected to an external load or the like.

In FIG. 49, again, a shaft (moving body) 380 is attached to the upper surface of the armature 386 so as to extend in the up-down direction. The plate member 434A (movable contact 430) is relatively movably attached to the shaft 380 by inserting the shaft 380 into an insertion hole formed at the center. Furthermore, in the configuration shown in FIG. 49, the movable contact 430 is pressed downward by the contact pressure spring 401 disposed between the head 382 of the shaft 380 and the movable contact 430. That is, the movable contact 430 is pressed downward by the contact pressure spring 401 (force rotating the tip to move downward is transmitted). This contact pressure spring 401 corresponds to the pressing body.

With such a configuration, when the coil 330 is not energized, the armature 386 is held in a separated state from the yoke 350 by the upward biasing force of the hinge spring 387. In this event, the movable contact 430 is lifted (to the other side) in the up-down direction (one direction) by the shaft 380, and is set in a state of being separated from the first fixed terminal 420A (off state).

Then, when the coil 330 is energized from this off state, the armature 386 is attracted to the yoke 350 against the elastic restoring force of the hinge spring 387 by the electromagnetic force, and the tip is rotated so as to approach the yoke 350. Thus, when the tip of the armature 386 is rotated so as to approach the yoke 350, the shaft 380 is also rotated so as to move downward, and the movable contact 430 is also rotated so as to have its tip moved downward by the elastically restoring force of the contact pressure spring 401. Thus, the tip of the movable contact 430 comes into contact with the inclined surface 421nA of the first fixed terminal 420A to turn on the electromagnetic relay 1 (contact device 10).

In this event, the tip of the plate member 434A (the first contact piece 432A on the first contact unit side) comes into contact with the inclined surface 421nA of the first fixed terminal 420A while being biased downward by the contact pressure spring 401. In FIG. 49, again, the plate member 434A is in contact with the inclined surface 421nA of the first fixed terminal 420A in a stretched state. Note that, in a hinge type contact device as shown in FIG. 49, the moving direction of the moving body immediately before the first contact unit 431A (the tip of the plate member 434A in FIG. 49) comes into contact with the first fixed terminal 420A (the inclined surface 421nA in FIG. 49) is one side in one direction. The direction in which the pressing body presses at that time is the pressing direction. In FIG. 49, one side of one direction that is the moving direction of the moving body approximately coincides with the pressing direction of the pressing body. Therefore, in FIG. 49, the tip (first contact unit 431A) of the plate member 434A comes into contact with the inclined surface 421nA corresponding to the first surface from a direction intersecting with the moving direction (one direction) of the moving body and the pressing direction of the pressing body.

Thus, the same operation and effect as those of the electromagnetic relay 1 and the contact device 10 shown in FIG. 48 can be obtained.

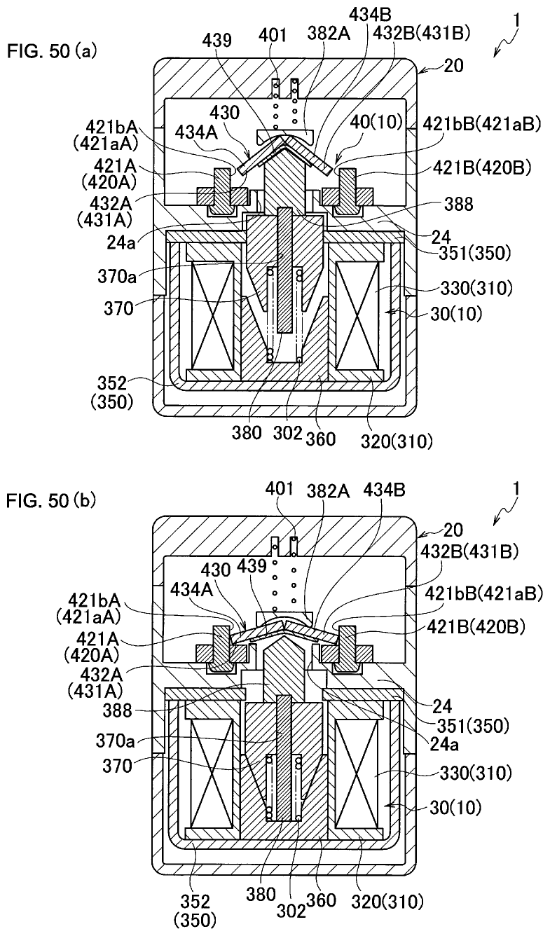

An electromagnetic relay 1 shown in FIG. 50 may also be realized.

The electromagnetic relay 1 shown in FIG. 50 is equipped with a contact device 10 configured by integrally combining a lower drive block (drive unit) 30 and an upper contact block (contact unit) 40. To be more specific, the electromagnetic relay 1 equipped with the contact device 10 is formed by housing the contact device 10 in a case 20 formed in an approximately hollow box shape using a resin material.

The drive block 30 includes a coil unit 310. The coil unit 310 includes a coil 330 that generates a magnetic flux when energized, and a hollow cylindrical coil bobbin 320 around which the coil 330 is wound.

When the coil 330 is energized, the drive block 30 is driven, and the drive of the drive block 30 opens and closes the contacts of the contact block 40. In the electromagnetic relay 1 shown in FIG. 50, again, the contact block 40 has a pair of contacts formed herein. In FIG. 50, one of the contacts of the contact block 40 is formed by the first fixed terminal 420A and a portion of the movable contact 430 that comes into contact with the first fixed terminal 420A. On the other hand, the other contact is formed by the second fixed terminal 420B and a portion of the movable contact 430 that comes into contact with the second fixed terminal 420B. Thus, in FIG. 50, again, opening and closing of the contacts of the contact block 40 can be switched by driving the drive block 30 or stopping the drive of the drive block 30. That is, conduction and non-conduction between the first fixed terminal 420A and the second fixed terminal 420B can be switched by switching on and off of the drive block 30.

The drive block 30 includes a yoke 350 disposed around the coil 330. The yoke 350 can be formed using a magnetic material, for example, and includes a rectangular yoke upper plate 351 disposed on the upper end surface side of the coil bobbin 320 and a rectangular yoke main body 352 disposed on a lower end surface side and a side surface side of the coil bobbin 320.

The drive block 30 includes a fixed iron core (fixed-side member) 360 that is inserted into the cylinder of the coil bobbin 320 and is magnetized by the energized coil 330. The drive block 30 further includes a movable iron core (movable-side member) 370 that is opposed to the fixed iron core 360 in the up-down direction (axial direction) and is disposed inside the cylinder of the coil bobbin 320.

Here, in FIG. 50, the fixed iron core 360 is arranged below and the movable iron core 370 is arranged above. To be more specific, a return spring 302 is mounted on the upper surface of the fixed iron core 360, and the movable iron core 370 is disposed above the fixed iron core 360 in a state of being biased in a direction away from the fixed iron core 360 by the return spring 302.

There is also an insertion hole 370a formed in the center of the movable iron core 370, and a shaft (moving body: drive shaft) 380 is inserted into the insertion hole 370a. A lifting member 388 that lifts the movable contact 430 up (to the other side) in the up-down direction (one direction) when the first fixed terminal 420A and the second fixed terminal 420B are in a non-conductive state is further connected to the upper end of the shaft 380 (see FIG. 50(a)).

Above the drive block 30, a contact block 40 is provided, which opens and closes the contact according to turning on and off of current supply to the coil 330.

The contact block 40 includes a first fixed terminal 420A and a second fixed terminal 420B spaced apart from the first fixed terminal 420A. The contact block 40 further includes a movable contact 430 that switches conduction and non-conduction between the first and second fixed terminals 420A and 420B by moving relative to the first and second fixed terminals 420A and 420B.

The first fixed terminal 420A is formed of a conductive material, and includes an approximately cylindrical (approximately columnar) first fixed terminal main body 421A.

In FIG. 50, the case 20 includes a partition wall 24 that vertically defines the internal space, and an insertion hole 24a through which the lifting member 388 can be inserted is formed in the center of the partition wall 24. The first fixed terminal main body 421A is arranged on the partition wall 24.

On the other hand, the second fixed terminal 420B is also formed of a conductive material, and includes an approximately cylindrical (approximately columnar) second fixed terminal main body 421B. This second fixed terminal main body 421B is also arranged on the partition wall 24.

As described above, in FIG. 50, the first fixed terminal 420A and the second fixed terminal 420B are spaced apart from each other so as to be lined up in the left-right direction.

In the space formed above partition wall 24 of case 20, the movable contact 430 is disposed so as to be movable relative to the first and second fixed terminals 420A and 420B as the shaft 380 is moved in the up-down direction.

In FIG. 50, the movable contact 430 is formed of an approximately V-shaped member formed by connecting rigid plate members 434A and 434B having an approximately rectangular parallelepiped shape elongated in the left-right direction, with a leaf spring (connecting member) 439. The plate members 434A and 434B constituting the movable contact 430 are both formed using a conductive material, and the leaf spring 439 is formed using a conductive material or an insulating material.

In FIG. 50, the movable contact 430 is arranged on the lower surface of a pressing member 382A, and the pressing member 382A is pressed downward by the contact pressure spring 401. That is, the contact pressure spring 401 ensures the contact pressure between the movable contact 430 and the first fixed terminal 420A and the contact pressure between the movable contact 430 and the second fixed terminal 420B.

To be more specific, the contact pressure spring 401 is disposed between the top wall of the case 20 and the pressing member 382A, and the movable contact 430 is pressed downward by the pressing member 382A pressed down by the contact pressure spring 401. Note that the contact pressure spring 401 is formed of a coil spring, and is arranged with the axial direction facing the up-down direction.

Accordingly, in FIG. 50, the movable contact 430 is pressed downward (to one side in one direction) by the pressing member 382A, and the pressing member 382A corresponds to a pressing body. That is, in FIG. 50, one side (downward) of one direction that is the moving direction of the moving body approximately coincides with the pressing direction (downward) of the movable contact by the pressing body.

In FIG. 50, the lifting member 388 is arranged below the movable contact 430. When at least the first and second fixed terminals 420A and 420B are in a non-conductive state, the lifting member 388 lifts the movable contact 430.

With such a configuration, when the coil 330 is not energized, the movable iron core 370 is moved in a direction away from the fixed iron core 360 by the elastic force (elastic restoring force) of the return spring 302. In this event, the movable contact 430 is lifted by the lifting member 388, and the movable contact 430 is in a state of FIG. 50(a) where the movable contact 430 is separated from the first and second fixed terminals 420A and 420B.

When the coil 330 is energized from this off state, the movable iron core 370 is attracted to the fixed iron core 360 against the elastic force (elastic restoring force) of the return spring 302 by the electromagnetic force, and is moved downward so as to approach the fixed iron core 360. Then, as the movable iron core 370 is moved downward, the shaft 380 and the lifting member 388 are also moved downward, and the movable contact 430 is also moved downward. When the movable contact 430 is moved downward, the movable contact 430 pressed downward by the pressing member 382A is moved downward to come into contact with the first and second fixed terminals 420A and 420B. Thus, the first and second fixed terminals 420A and 420B are electrically connected to turn on the electromagnetic relay 1 (contact device 10) (see FIG. 50(b)).

Note that FIG. 50(b) illustrates an example where the lifting member 388 is separated from the movable contact 430 when the movable contact 430 is in contact with the first and second fixed terminals 420A and 420B. The lifting member 388 may also be configured to come into contact with the movable contact 430 also when the movable contact 430 is in contact with the first and second fixed terminals 420A and 420B.

The contact pressure spring 401 is arranged so that force moving the movable contact 430 downward acts even when the movable contact 430 is in contact with the first and second fixed terminals 420A and 420B.

In FIG. 50, again, the movable contact 430 includes a movable contact main body 431, and the movable contact main body 431 includes the first contact unit 431A that comes into contact with the first fixed terminal 420A. The movable contact main body 431 further includes a second contact unit 431B that is electrically connected to the first contact unit 431A and comes into contact with the second fixed terminal 420B.

The first contact unit 431A includes a first contact piece 432A on the first contact unit side that comes into contact with the side surface (first surface) 421bA of the first fixed terminal 420A in a stretched manner in a state of being pressed downward (to one side) in the up-down direction (one direction) by the pressing member 382A.

On the other hand, the second contact unit 431B includes a first contact piece 432B on the second contact unit side that comes into contact with the side surface (first surface) 421bB of the second fixed terminal 420B in a stretched manner in a state of being pressed downward (to one side) in the up-down direction (one direction) by the pressing member 382A.

In FIG. 50, again, the first contact piece 432A on the first contact unit side includes a rigid plate member 434A, and the first contact piece 432B on the second contact unit side has a rigid plate member 434B.

Thus, the electromagnetic relay 1 and the contact device 10 shown in FIG. 50 include the first fixed terminal 420A and the movable contact 430 that comes into contact with and away from the first fixed terminal 420A by moving relative to the first fixed terminal 420A.

The electromagnetic relay 1 and the contact device 10 shown in FIG. 50 include a drive block (drive unit) 40 including a shaft (moving body) 380 for moving the movable contact 430, and configured to allow the movable contact 430 to come into contact with the first fixed terminal 420A by moving the shaft 380 downward (to one side) in the up-down direction (one direction) and to come away from the first fixed terminal 420A by moving the shaft 380 upward (to the other side) in the up-down direction (one direction).

The electromagnetic relay 1 and the contact device 10 shown in FIG. 50 further includes a pressing member (pressing body) 382A that presses the movable contact 430 in a state where the shaft 380 is moved downward in the up-down direction (one side in one direction). In FIG. 50, the movable contact 430 is pressed downward in the up-down direction (one side in one direction: pressing direction) by the pressing member (pressing body) 382A.

The movable contact 430 also includes a first contact unit 431A that comes into contact with the first fixed terminal 420A when the shaft 380 is moved downward in the up-down direction (to one side in one direction). The first fixed terminal 420A has a side surface (first surface) 421bA with which the first contact unit 431A comes into contact from a direction intersecting with the pressing direction of the pressing member (pressing body) 382A.

The first contact unit 431A includes a first contact piece 432A on the first contact unit side that comes into contact with the side surface (first surface) 421bA of the first fixed terminal 420A in a stretched manner is in a state of being pressed in the pressing direction by the pressing member (pressing body) 382A.

The electromagnetic relay 1 and the contact device 10 shown in FIG. 50 also include the second fixed terminal 420B arranged in a separated state from the first fixed terminal 420A. The movable contact 430 switches conduction and non-conduction between the first and second fixed terminals 420A and 420B by moving relative to the first and second fixed terminals 420A and 420B.

The first and second fixed terminals 420A and 420B are set in a conductive state by moving the shaft 380 downward in the up-down direction, and set in a non-conductive state by moving the shaft 380 upward in the up-down direction.

The movable contact 430 includes a second contact unit 431B that is electrically connected to the first contact unit 431A and comes into contact with the second fixed terminal 420B. The second fixed terminal 420B includes a side surface (first surface) 421bB with which the second contact unit 431B comes into contact from a direction intersecting with the pressing direction of the pressing member (pressing body) 382A.

Then, the second contact unit 431B includes a first contact piece 432B on the second contact unit side that comes into contact with the side surface (the first surface) 421bB of the second fixed terminal 420B in a stretched manner in a state of being pressed downward in the up-down direction (to one side in one direction: pressing direction) by the pressing member (pressing body) 382A.

The movable contact 430, the first fixed terminal 420A, and the second fixed terminal 420B shown in FIG. 50 have approximately the same configurations as those described in the above embodiment.

Thus, the same operation and effect as those of the electromagnetic relay 1 and the contact device 10 described in the above embodiment can be obtained.

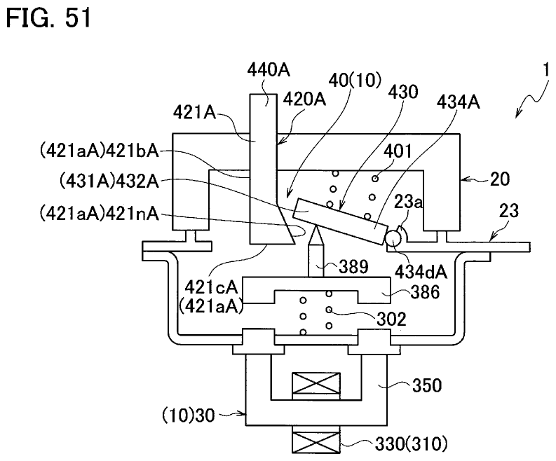

Alternatively, an electromagnetic relay 1 shown in FIG. 51 may also be realized.

As in the case of FIG. 48, the electromagnetic relay 1 shown in FIG. 51 is also equipped with a contact device 10 configured by integrally combining a drive block (drive unit) 30 and a contact block (contact unit) 40. To be more specific, the electromagnetic relay 1 equipped with the contact device 10 is formed by attaching the contact device 10 to a case 20 formed in an approximately hollow box shape. In FIG. 50, again, the contact device 10 is attached to the case 20 in a state where the contact device 10 is partially housed in the case 20 and partially arranged outside the case 20. Note that the electromagnetic relay 1 equipped with the contact device 10 can be formed by housing the contact device 10 in the case 20.

In FIG. 51, again, the drive block 30 includes a coil unit 310, and the coil unit 310 includes a coil 330 that generates a magnetic flux when energized.

When the coil 330 is energized, the drive block 30 is driven, and the drive of the drive block 30 opens and closes the contacts of the contact block 40. Here, the electromagnetic relay 1 shown in FIG. 51 is also provided with no second fixed terminal 420B. That is, in the electromagnetic relay 1 shown in FIG. 51, again, the movable contact 430 is brought into contact with and away from the first fixed terminal 420A by switching on and off of the drive block (drive unit) 30, thereby switching opening and closing of the contact of the contact block 40.

The drive block 30 shown in FIG. 51 includes a yoke 350 formed in an approximately U-shape using a magnetic material, and the coil 330 is wound around the bottom wall of the yoke 350. Note that an approximately cylindrical coil bobbin 320 may be used, and the bottom wall of the yoke 350 may be inserted into the cylinder of the coil bobbin 320, and the coil 330 may be wound around the outer surface of the coil bobbin 320.

In FIG. 51, again, the coil unit 310 and the yoke 350 are attached to the case 20 from outside.

The drive block 30 includes an approximately plate-shaped armature 386, and the armature 386 is disposed inside the case 20. In this event, both ends of the armature 386 are opposed to the ends of the approximately U-shaped yoke 350, respectively. Furthermore, in FIG. 51, a return spring 302 formed of a coil spring is disposed between the armature 386 and the bottom wall of the case 20. During a non-conductive state, the return spring 302 separates the armature 386 from the yoke 350 (the bottom wall of the case 20).

The contact block 40 includes a first fixed terminal 420A, and the first fixed terminal 420A includes an approximately columnar first fixed terminal main body 421A. In FIG. 51, the first fixed terminal main body 421A is fixed to the case 20 with the other end side penetrating the case 20 and protruding outside the case 20. The portion protruding outside the case 20 is a first bus bar (first conductive member) 440A connected to an external load or the like.

Note that an inclined surface 421nA that is inclined so that the side where the movable contact 430 is located is set as the lower side is formed at the lower end of the first fixed terminal 420A.

Furthermore, the contact block 40 includes a movable contact 430 that comes into contact with and away from the first fixed terminal 420A by moving relative to the first fixed terminal 420A.

In FIG. 51, the movable contact 430 is formed of a rigid plate member 434A, and the plate member 434A has its end always in contact with the bearing member 23 formed on the case 20. To be more specific, a rotating shaft part 434dA is provided at the end of the plate member 434A, and a bearing recess part 23a is provided at the tip of the bearing member 23 extending inward. The rotating shaft part 434dA of the plate member 434A is attached to the bearing recess part 23a of the bearing member 23. In this event, the plate member 434A can be rotated relative to the bearing member 23 in a state where the rotating shaft part 434dA of the plate member 434A is always in contact with the bearing recess part 23a of the bearing member 23.

Note that a portion of the case 20 where the first fixed terminal 420A is fixed is formed of an insulating material, and a portion thereof where the bearing member 23 is formed is formed of a conductive material. The bearing member 23 has its other end (outer end) electrically connected to an external load or the like.

In FIG. 51, a push-up projection (moving body) 389 is attached to the upper surface of the armature 386 so as to extend in the up-down direction. The plate member 434A (movable contact 430) is pushed up by the push-up projection 389. In the configuration shown in FIG. 51, the movable contact 430 is pressed downward by the contact pressure spring 401 disposed between the top wall of the case 20 and the movable contact 430. That is, the movable contact 430 is pressed downward by the contact pressure spring 401 (force rotating the tip to move downward is transmitted). This contact pressure spring 401 corresponds to the pressing body.

With such a configuration, when the coil 330 is not energized, the armature 386 is held in a separated state from the yoke 350 by the upward biasing force of the return spring 302. In this event, the movable contact 430 is pushed upward (the other side) in the up-down direction (one direction) by the push-up projection 389, and set in a state of being separated from the first fixed terminal 420A (off state).

When the coil 330 is energized from this off state, the armature 386 is attracted to the yoke 350 against the elastic restoring force of the return spring 302 by the electromagnetic force, and the armature 386 is moved downward (to one side) in the up-down direction (one direction) so as to approach the yoke 350. Thus, the armature 386 is moved downward, the push-up projection 389 is also moved downward, and the movable contact 430 is also rotated so as to have the tip moved downward by the elastic restoring force of the contact pressure spring 401. Thus, the tip of the movable contact 430 comes into contact with the inclined surface 421nA of the first fixed terminal 420A to turn on the electromagnetic relay 1 (contact device 10).

In this event, the tip of the plate member 434A (the first contact piece 432A on the first contact unit side) comes into contact with the inclined surface 421nA of the first fixed terminal 420A while being biased downward by the contact pressure spring 401. In FIG. 51, again, the plate member 434A comes into contact with the inclined surface 421nA of the first fixed terminal 420A in a stretched state.

In the contact device shown in FIG. 51, the moving direction of the first contact unit 431A immediately before the tip of the plate member 434A comes into contact with the inclined surface 421nA is the pressing direction of the pressing body. Therefore, in FIG. 51, the tip (first contact unit 431A) of the plate member 434A comes into contact with the inclined surface 421nA corresponding to the first surface from a direction intersecting with the pressing direction of the pressing body.

Thus, the same operation and effect as those of the electromagnetic relay 1 and the contact device 10 shown in FIG. 48 can be obtained.

Although the preferred embodiment of the present invention has been described above, the present invention is not limited to the above embodiment, and various modifications are possible.

For example, a contact device can be formed by appropriately combining the configurations described in the above embodiment and modified examples thereof.

Although the description is given of the case where no yoke is provided around the movable contact in the above embodiment and the modified examples, a yoke may be provided so as to surround the movable contact.

For example, the head 382 of the shaft 380 may have the functions of the yoke, or a yoke may be provided separately from the shaft 380. The yoke thus provided may have various shapes.

The present invention can also be applied to a contact device 10 (electromagnetic relay 1) in which a fixed iron core (fixed-side member) 360 is disposed below and a movable iron core (movable-side member) 370 is disposed above.

Alternatively, the present invention can also be applied to a contact device 10 (electromagnetic relay 1) including only the first fixed terminal 420A of the first and second fixed terminals 420A and 420B, and configured to move the movable contact 430 in the up-down direction by switching on and off of the drive block to move the shaft 380 in the up-down direction.

The present invention is also applicable to a contact device having three or more fixed terminals.

Also, the specifications (shape, size, layout, and the like) of each fixed terminal, movable contact, and other details can be appropriately changed.

This application claims priority based on Japanese Patent Application No. 2017-188527 filed on Sep. 28, 2017, the entire contents of which are incorporated herein by reference.

### INDUSTRIAL APPLICABILITY

The present invention can provide a contact device capable of further improving the reliability of a contact, and an electromagnetic relay equipped with the contact device.

1. A contact device comprising:
a first fixed terminal;
a movable contact that comes into contact with and away from the first fixed terminal by moving relative to the first fixed terminal; and
a drive unit provided with a moving body that moves the movable contact and configured to allow the movable contact to come into contact with the first fixed terminal by moving the moving body to one side in one direction and to allow the movable contact to come away from the first fixed terminal by moving the moving body to the other side in the one direction, wherein
the movable contact includes a first contact unit that comes into contact with the first fixed terminal when the moving body is moved to the one side in the one direction,
the first fixed terminal includes a first surface with which the first contact unit comes into contact from a direction intersecting with the one direction, and
the first contact unit includes a first contact piece on the first contact unit side, which comes into contact with the first surface of the first fixed terminal in a stretched manner in a state where the first contact unit is pressed toward the one side in the one direction by the moving body.

2. The contact device according to claim 1, wherein a conductive part of the movable contact includes a first contact piece on the first contact unit side.

3. The contact device according to claim 1, wherein the first surface of the first fixed terminal is an intersecting surface that intersects with a plane perpendicular to the one direction.

4. The contact device according to claim 1, wherein the first contact piece on the first contact unit side includes a rigid plate member.

5. The contact device according to claim 1, wherein the first contact piece on the first contact unit side includes a first leaf spring that is set in a flexed state when the movable contact is separated from the first fixed terminal, and set in a stretched state when the movable contact comes into contact with the first fixed terminal.

6. The contact device according to claim 5, wherein a plurality of the first leaf springs are stacked in the one direction.

7. The contact device according to claim 6, wherein a gap is formed between the first leaf springs adjacent to each other in the one direction.

8. The contact device according to claim 1, wherein the first contact unit includes a second contact piece on the first contact unit side that comes into contact with a second surface intersecting with the first surface of the first fixed terminal.

9. The contact device according to claim 8, wherein the first contact piece on the first contact unit side and the second contact piece on the first contact unit side are separately formed.

10. The contact device according to claim 8, wherein the first contact piece on the first contact unit side and the second contact piece on the first contact unit side are integrally formed.

11. The contact device according to claim 10, wherein
the movable contact includes a base part pressed by the moving body, and
the first contact unit, in which the first contact piece on the first contact unit side and the second contact piece on the first contact unit side are integrally formed, is connected to the base part so as to be relatively rotatable.

12. The contact device according to claim 1, further comprising:
a second fixed terminal disposed apart from the first fixed terminal, wherein
the movable contact switches between conduction and non-conduction between the first fixed terminal and the second fixed terminal by moving relative to the first fixed terminal and the second fixed terminal,
the moving body moves the moving body to the one side in the one direction to set the first fixed terminal and the second fixed terminal in a conductive state, and moves the moving body to the other side in the one direction to set the first fixed terminal and the second fixed terminal in a non-conductive state, and
the movable contact includes a second contact unit that is electrically connected to the first contact unit and comes into contact with the second fixed terminal.

13. The contact device according to claim 12, wherein
the second fixed terminal includes a first surface with which the second contact unit comes into contact from a direction intersecting with the one direction, and
the second contact unit includes a first contact piece on the second contact unit side that comes into contact with the first surface of the second fixed terminal in a stretched manner in a state of being pressed to the one side in the one direction by the moving body.

14. The contact device according to claim 12, wherein the first surface of the second fixed terminal is an intersecting surface that intersects with a plane perpendicular to the one direction.

15. The contact device according to claim 12, wherein the first contact piece on the second contact unit side includes a rigid plate member.

16. The contact device according to claim 12, wherein the first contact piece on the second contact unit side includes a second leaf spring which is set in a flexed state during the non-conductive state and set in a stretched state during the conductive state.

17. The contact device according to claim 16, wherein
the first contact piece on the first contact unit side includes a first leaf spring that is set in a flexed state when the movable contact is separated from the first fixed terminal, and set in a stretched state when the movable contact comes into contact with the first fixed terminal, and
the movable contact includes a leaf spring in which the first leaf spring and the second leaf spring are integrated.

18. The contact device according to claim 16, wherein a plurality of the leaf springs are stacked in the one direction.

19. The contact device according to claim 18, wherein a gap is formed between the leaf springs adjacent to each other in the one direction.

20. The contact device according to claim 12, wherein the second contact unit includes a second contact piece on the second contact unit side that comes into contact with a second surface intersecting with the first surface of the second fixed terminal.

21. The contact device according to claim 20, wherein the first contact piece on the second contact unit side and the second contact piece on the second contact unit side are formed separately.

22. The contact device according to claim 20, wherein the first contact piece on the second contact unit side and the second contact piece on the second contact unit side are formed integrally.

23. The contact device according to claim 22, wherein
the movable contact includes a base part pressed by the moving body, and
the second contact unit, in which the first contact piece on the second contact unit side and the second contact piece on the second contact unit side are integrally formed, is connected to the base part so as to be relatively rotatable.

24. The contact device according to claim 12, wherein
the first contact unit and the second contact unit are formed as separate parts, and
a shunt part for shunting a current flowing between the first contact unit and the second contact unit is formed in the movable contact.

25. A contact device comprising:
a first fixed terminal;
a movable contact that comes into contact with and away from the first fixed terminal by moving relative to the first fixed terminal;
a drive unit provided with a moving body that moves the movable contact and configured to allow the movable contact to come into contact with the first fixed terminal by moving the moving body to one side in one direction and to allow the movable contact to come away from the first fixed terminal by moving the moving body to the other side in the one direction; and
a pressing body that presses the movable contact in a state where the moving body is moved to the one side in the one direction, wherein
the movable contact includes a first contact unit that contacts the first fixed terminal when the moving body is moved to the one side in the one direction,
the first fixed terminal has a first surface with which the first contact unit comes into contact from a direction intersecting with a pressing direction of the pressing body, and
the first contact unit includes a first contact piece on a first contact unit side that comes into contact with the first surface of the first fixed terminal in a stretched manner in a state where the first contact unit is pressed in the pressing direction by the pressing body.

26. An electromagnetic relay comprising the contact device according to claim 1.

27. An electromagnetic relay comprising the contact device according to claim 25.
